(19) United States
(12) Patent Application Publication
(10) Pub. No.: US 2026/0131246 A1
(43) Pub. Date: May 14, 2026

(54) VIRTUAL SCENE SWITCHING

(71) Applicant: Tencent Technology (Shenzhen) Company Limited, Shenzhen (CN)

(72) Inventors: Nengjie ZHU, Shenzhen (CN); Yang CHEN, Shenzhen (CN)

(73) Assignee: Tencent Technology (Shenzhen) Company Limited, Shenzhen (CN)

(21) Appl. No.: 19/445,426

(22) Filed: Jan. 9, 2026

Related U.S. Application Data
(63) Continuation of application No. PCT/CN2024/118608, filed on Sep. 12, 2024.

(30) Foreign Application Priority Data
Dec. 1, 2023 (CN) 202311653138.7

(51) Int. Cl. A63F 13/58; A63F 13/52; A63F 13/56

(52) U.S. Cl. CPC A63F 13/58; A63F 13/52; A63F 13/56

(57) ABSTRACT

In a method, a main control virtual character is displayed in a world scene. A first battle character is subordinate to the main control virtual character. In the method, based on a scene switching condition being satisfied, one or more battle characters are displayed in a turn-based battle scene. The one or more battle characters include the first battle character or a second battle character in a region. A battle attribute of one of the one or more battle characters in the turn-based battle scene is determined based on (i) a behavior mode of the one or more battle characters or (ii) an influencing factor in the world scene. The one of the one or more battle characters is controlled to engage in the turn-based battle scene based on the battle attribute of the one of the one or more battle characters.

### RELATED APPLICATIONS

The present application is a continuation of International Application No. PCT/CN2024/118608, filed on Sep. 12, 2024, which claims priority to Chinese Patent Application No. 202311653138.7, entitled “VIRTUAL SCENE SWITCHING METHOD AND APPARATUS, DEVICE, MEDIUM, AND PRODUCT,” and filed on Dec. 1, 2023. The entire disclosures of the prior applications are hereby incorporated by reference.

### FIELD OF THE TECHNOLOGY

Embodiments of this disclosure relate to the field of human-computer interaction, including a virtual scene switching method and apparatus, a device, a medium, and a product.

### BACKGROUND OF THE DISCLOSURE

The related art provides a turn-based role playing game. In a non-battle scene of a turn-based role playing game, a main control virtual character explores in an open world. In a battle scene, the main control virtual character performs turn-based battle with an enemy unit (a monster or a battle character belonging to another character) in a battle map. The non-battle scene is also referred to as a world scene, and the battle scene is also referred to as a turn-based battle scene.

In related art, a world scene is an independent scene displayed by using a world map, and a battle character performs a daily behavior in the world scene. A turn-based battle scene is an independent scene displayed by using a battle map, and a battle character performs a turn-based battle behavior in the battle scene.

When switching is performed from the world scene to the turn-based battle scene, or switching is performed from the turn-based battle scene to the world scene, because switching is performed between two independent scenes, scene data of the two scenes is independent of each other.

### SUMMARY

This disclosure provides a virtual scene switching method and apparatus, a device, a medium, and a product. The technical solutions are as follows:

According to one aspect of this disclosure, a virtual scene switching method is provided. In the method, a main control virtual character is displayed in a world scene. The main control virtual character has a first battle character subordinate to the main control virtual character. In the method, the main control virtual character is controlled to move to a first region in the world scene. A second battle character is in the first region. In the method, based on a scene switching condition being satisfied, one or more battle characters are displayed in a turn-based battle scene. The one or more battle characters include at least one of the first battle character or the second battle character. In the method, a battle attribute of one of the one or more battle characters in the turn-based battle scene is determined, by processing circuitry, based on (i) a behavior mode of the one of the one or more battle characters in the world scene or (ii) an influencing factor in the world scene. In the method, the one of the one or more battle characters is controlled, by the processing circuitry, to engage in the turn-based battle scene based on the battle attribute of the one of the one or more battle characters.

According to one aspect of this disclosure, a terminal device is provided. The terminal device includes processing circuitry configured to display a main control virtual character in a world scene. The main control virtual character has a first battle character subordinate to the main control virtual character. The processing circuitry is configured to control the main control virtual character to move to a first region in the world scene, a second battle character being in the first region. The processing circuitry is configured to display, based on a scene switching condition being satisfied, one or more battle characters in a turn-based battle scene. The one or more battle characters include at least one of the first battle character or the second battle character. The processing circuitry is configured to determine a battle attribute of one of the one or more battle characters in the turn-based battle scene based on (i) a behavior mode of the one of the one or more battle characters in the world scene or (ii) an influencing factor in the world scene. The processing circuitry is configured to control the one of the one or more battle characters to engage in the turn-based battle scene based on the battle attribute of the one of the one or more battle characters.

An embodiment of this disclosure provides a non-transitory computer-readable storage medium. The non-transitory computer-readable storage medium stores instructions, which when executed by a processor, cause the processor to perform displaying a main control virtual character in a world scene. The main control virtual character has a first battle character subordinate to the main control virtual character. The instructions, which when executed by the processor, cause the processor to perform controlling the main control virtual character to move to a first region in the world scene, a second battle character being in the first region. The instructions, which when executed by the processor, cause the processor to perform displaying, based on a scene switching condition being satisfied, one or more battle characters in a turn-based battle scene. The one or more battle characters include at least one of the first battle character or the second battle character. The instructions, which when executed by the processor, cause the processor to perform determining a battle attribute of one of the one or more battle characters in the turn-based battle scene based on (i) a behavior mode of the one of the one or more battle characters in the world scene or (ii) an influencing factor in the world scene. The instructions, which when executed by the processor, cause the processor to perform controlling the one of the one or more battle characters to engage in the turn-based battle scene based on the battle element of the one of the one or more battle characters.

According to one aspect of this disclosure, a virtual scene switching method is provided. In the method, battle characters are displayed in a turn-based battle scene. The battle characters include a first battle character and a second battle character, and the first battle character being subordinate to a main control virtual character. In the method, the first battle character and the second battle character are controlled to battle in the turn-based battle scene. In the method, based on an end of the battle in the turn-based battle scene, at least one of the battle characters is displayed, by processing circuitry, in a world scene. In the method, a world attribute of the one of the battle characters in the world scene is determined, by the processing circuitry, based on an influencing factor in the turn-based battle scene. The one of the battle characters is displayed in the world scene based on the determined world attribute.

According to one aspect of this disclosure, a terminal device is provided. The terminal device includes processing circuitry configured to display battle characters in a turn-based battle scene. The battle characters include a first battle character and a second battle character, and the first battle character being subordinate to a main control virtual character. The processing circuitry is configured to control the first battle character and the second battle character to battle in the turn-based battle scene. The processing circuitry is configured to display, based on an end of the battle in the turn-based battle scene, at least one of the battle characters in a world scene. The processing circuitry is configured to determine a world attribute of the one of the battle characters in the world scene based on an influencing factor in the turn-based battle scene. The one of the battle characters is displayed in the world scene based on the determined world attribute.

An embodiment of this disclosure provides a non-transitory computer-readable storage medium. The non-transitory computer-readable storage medium stores instructions, which when executed by a processor, cause the processor to perform displaying battle characters in a turn-based battle scene. The battle characters include a first battle character and a second battle character, and the first battle character being subordinate to a main control virtual character. The instructions, which when executed by the processor, cause the processor to perform controlling the first battle character and the second battle character to battle in the turn-based battle scene. The instructions, which when executed by the processor, cause the processor to perform displaying, based on an end of the battle in the turn-based battle scene, at least one of the battle characters in a world scene. The instructions, which when executed by the processor, cause the processor to perform determining a world attribute of the one of the battle characters in the world scene based on an influencing factor in the turn-based battle scene. The one of the battle characters is displayed in the world scene based on the determined world attribute.

According to one aspect of this disclosure, a virtual scene switching method is provided, including: displaying that a main control virtual character is located in a world scene, the main control virtual character having at least one subordinate first battle character; controlling the main control virtual character to move to a first region in the world scene, the first region including a second battle character; displaying, in response to that a scene switching condition is satisfied, that a battle character is in a turn-based battle scene, the battle character including at least one of the first battle character and the second battle character; and determining a battle capability of the battle character during a battle in the turn-based battle scene based on a behavior mode of the battle character in the world scene.

According to one aspect of this disclosure, a virtual scene switching method is provided, including: displaying that a battle character is in a turn-based battle scene, the battle character including a first battle character and a second battle character, and the first battle character being a battle character owned by a main control virtual character; controlling the first battle character and the second battle character to battle in the turn-based battle scene; displaying, in response to that the battle in the turn-based battle scene ends, that the battle character is in a world scene; and determining a behavior of the battle character in the world scene based on a battle result in the turn-based battle scene.

According to one aspect of this disclosure, a virtual scene switching method is provided, including: displaying that a main control virtual character is located in a world scene, the main control virtual character having at least one first battle character; controlling the main control virtual character to move to a first region in the world scene, the first region including a second battle character; displaying, in response to that a scene switching condition is satisfied, that a battle character is in a turn-based battle scene, the battle character including at least one of the first battle character and the second battle character; and determining a battle element of the battle character in the turn-based battle scene based on an influencing factor in the world scene.

According to one aspect of this disclosure, a virtual scene switching method is provided, including: displaying that a battle character is in a turn-based battle scene, the battle character including a first battle character and a second battle character, and the first battle character being a battle character owned by a main control virtual character; controlling the first battle character and the second battle character to battle in the turn-based battle scene; displaying, in response to that the battle in the turn-based battle scene ends, that the battle character is in a world scene; and determining at least one world element of the battle characters in the world scene based on an influencing factor in the turn-based battle scene.

According to one aspect of this disclosure, a virtual scene switching apparatus is provided, including: a first display module, configured to display that a main control virtual character is located in a world scene, the main control virtual character having at least one first battle character; a first control module, configured to control the main control virtual character to move to a first region in the world scene, the first region including a second battle character; the first display module being further configured to display, in response to that a scene switching condition is satisfied, that a battle character is in a turn-based battle scene, the battle character including at least one of the first battle character and the second battle character; and a first determining module, configured to determine a battle element of the battle character in the turn-based battle scene based on an influencing factor in the world scene.

According to one aspect of this disclosure, a virtual scene switching apparatus is provided, including: a first display module, configured to display that a main control virtual character is located in a world scene, the main control virtual character having at least one first battle character; a first control module, configured to control the main control virtual character to move to a first region in the world scene, the first region including a second battle character; the first display module being further configured to display, in response to that a scene switching condition is satisfied, that a battle character is in a turn-based battle scene, the battle character including at least one of the first battle character and the second battle character; and a first determining submodule, configured to determine a battle capability of the battle character during a battle in the turn-based battle scene based on a behavior mode of the battle character in the world scene.

According to one aspect of this disclosure, a virtual scene switching apparatus is provided, including: a second display module, configured to display that a battle character is in a turn-based battle scene, the battle character including a first battle character and a second battle character, and the first battle character being a battle character owned by a main control virtual character; a second control module, configured to control the current virtual character and the enemy virtual character to battle in the turn-based battle scene; the second display module being further configured to display, in response to that the battle in the turn-based battle scene ends, that the battle character is in a world scene; and a second determining module, configured to determine at least one world element of the battle characters in the world scene based on an influencing factor in the turn-based battle scene.

According to one aspect of this disclosure, a virtual scene switching apparatus is provided, including: a second display module, configured to display that a battle character is in a turn-based battle scene, the battle character including a first battle character and a second battle character, and the first battle character being a battle character owned by a main control virtual character; a second control module, configured to control the first battle character and the second battle character to battle in the turn-based battle scene; the second display module being further configured to display, in response to that the battle in the turn-based battle scene ends, that the battle character is in a world scene; and a second determining submodule, configured to determine a behavior of the battle character in the world scene based on a battle result in the turn-based battle scene.

According to another aspect of this disclosure, a computer device is provided, including processing circuitry (for example a processor) and a memory (for example, a non-transitory computer-readable storage medium), the memory having a computer program stored therein, and the computer program being loaded and executed by the processor to implement the foregoing virtual scene switching method.

According to another aspect of this disclosure, a non-transitory computer-readable storage medium is provided, having executable instructions stored therein, the executable instructions being loaded and executed by the processor to implement the foregoing virtual scene switching method.

According to another aspect of this disclosure, a computer program product is provided, including computer instructions, the computer instructions being stored in a non-transitory computer-readable storage medium, and a processor reading the computer instructions from the non-transitory computer-readable storage medium and executing the computer instructions, to implement the foregoing virtual scene switching method.

The technical solutions provided in this disclosure have at least the following beneficial effects.

That a main control virtual character is located in a world scene is displayed, the main control virtual character having at least one first battle character; the main control virtual character is controlled to move to a first region in the world scene, the first region including a second battle character; that a battle character is in a turn-based battle scene is displayed in response to that a scene switching condition is satisfied; and a battle element of the battle character in the turn-based battle scene is determined based on an influencing factor in the world scene (which includes a behavior mode of the battle character in the world scene in an embodiment). In this way, scene data of the world scene can be extensively applied to the turn-based battle scene, thereby improving the utilization of the scene data of the world scene. In addition, a difference between the world scene and the turn-based battle scene can be downplayed, interplay between the world scene and the turn-based battle scene can be increased, and consistency between the world scene and the turn-based battle scene can be improved, so that a player feels less abrupt or no longer feels abrupt in a scene switching process.

That a battle character is in a turn-based battle scene is displayed, the battle character including a first battle character and a second battle character; the first battle character and the second battle character are controlled to battle in the turn-based battle scene; that the battle character is in a world scene is displayed in response to that the battle in the turn-based battle scene ends; and at least one world element of the battle characters in the world scene is determined based on an influencing factor (which includes a battle result of the turn-based battle in an embodiment) in the turn-based battle scene. In this way, scene data of the turn-based battle scene can be extensively applied to the world scene, thereby improving the utilization of the scene data of the turn-based battle scene. In addition, the turn-based battle scene can be naturally transitioned to the world scene, and an effect of the battle result is introduced to the world scene, so that a player feels less abrupt or no longer feels abrupt in a scene switching process.

### BRIEF DESCRIPTION OF THE DRAWINGS

FIG. 1 is a schematic diagram of a battle map according to an embodiment of this disclosure;

FIG. 2 is a schematic diagram of a battle map according to an embodiment of this disclosure;

FIG. 3 is a schematic diagram of a virtual scene switching method according to an embodiment of this disclosure;

FIG. 4 is a structural block diagram of a computer system according to an embodiment of this disclosure;

FIG. 5 is a flowchart of a virtual scene switching method according to an embodiment of this disclosure;

FIG. 6 is a flowchart of a virtual scene switching method according to an embodiment of this disclosure;

FIG. 7 is a schematic diagram in which a battle character enters an environmental behavior mode according to an embodiment of this disclosure;

FIG. 8 is a schematic diagram in which a battle character enters a perceptual behavior mode according to an embodiment of this disclosure;

FIG. 9 is a schematic diagram of a stress response of a battle character according to an embodiment of this disclosure;

FIG. 10 is a schematic diagram in which a battle character enters a perceptual behavior mode according to an embodiment of this disclosure;

FIG. 11 is a schematic diagram in which a battle character enters a perceptual behavior mode according to an embodiment of this disclosure;

FIG. 12 is a schematic diagram in which a battle character enters a perceptual behavior mode according to an embodiment of this disclosure;

FIG. 13 is a schematic diagram in which a battle character enters a perceptual behavior mode according to an embodiment of this disclosure;

FIG. 14 is a schematic diagram in which a battle character obtains a gain status according to an embodiment of this disclosure;

FIG. 15 is a schematic diagram of switching a behavior mode according to an embodiment of this disclosure;

FIG. 16 is a schematic diagram of a perception mechanism of a battle character according to an embodiment of this disclosure;

FIG. 17 is a flowchart of a virtual scene switching method according to an embodiment of this disclosure;

FIG. 18 is a flowchart of a virtual scene switching method according to an embodiment of this disclosure;

FIG. 19 is a schematic diagram of a visual effect of an in-battle skill of a battle character according to an embodiment of this disclosure;

FIG. 20 is a schematic diagram of a visual effect of an in-battle skill of a battle character according to an embodiment of this disclosure;

FIG. 21 is a schematic diagram of a visual effect of a skill of a battle character according to an embodiment of this disclosure;

FIG. 22 is a schematic diagram of a special emotional effect of a battle character according to an embodiment of this disclosure;

FIG. 23 is a flowchart of a virtual scene switching method according to an embodiment of this disclosure;

FIG. 24 is a schematic diagram in which a world scene is switched to a turn-based battle scene according to an embodiment of this disclosure;

FIG. 25 is a schematic diagram of a first transition animation according to an embodiment of this disclosure;

FIG. 26 is a flowchart of a virtual scene switching method according to an embodiment of this disclosure;

FIG. 27 is a flowchart of a virtual scene switching method according to an embodiment of this disclosure;

FIG. 28 is a flowchart of a virtual scene switching method according to an embodiment of this disclosure;

FIG. 29 is a schematic diagram of a halo in a turn-based battle scene according to an embodiment of this disclosure;

FIG. 30 is a schematic diagram of a halo in a world scene according to an embodiment of this disclosure;

FIG. 31 is a schematic diagram in which a turn-based battle scene is switched to a world scene according to an embodiment of this disclosure;

FIG. 32 is a flowchart of a virtual scene switching method according to an embodiment of this disclosure;

FIG. 33 is a block diagram of a virtual scene switching apparatus according to an embodiment of this disclosure;

FIG. 34 is a block diagram of a virtual scene switching apparatus according to an embodiment of this disclosure; and

FIG. 35 is a schematic structural diagram of a computer device according to an embodiment of this disclosure.

### DESCRIPTION OF EMBODIMENTS

First, several terms involved in one or more embodiments of this disclosure are briefly introduced. The descriptions of the terms are provided as examples only and are not intended to limit the scope of the disclosure.

Virtual world: a virtual world displayed (or provided) when an application program runs on a terminal. The virtual world may be a simulated environment of the real world, a semi-simulated and semi-fictional environment, or a completely fictional environment. The virtual world can be any one of a two-dimensional virtual world, a 2.5-dimensional virtual world, and a three-dimensional virtual world. This is not limited in this disclosure. In the following embodiments, for example, the virtual world is a three-dimensional virtual world.

Main control virtual character: a movable object played by a player in a virtual world. The main control virtual character can be a virtual person, a virtual animal, or an animation character, for example, a person or an animal displayed in a three-dimensional virtual world. In an embodiment, the main control virtual character is a three-dimensional model created based on an animation skeleton technology. Each main control virtual character has a shape and a volume in the three-dimensional virtual world and occupies a part of the space in the three-dimensional virtual world.

Battle character: a movable object controlled by artificial intelligence (AI) in a virtual world. A battle character may be a virtual creature, a virtual animal, a virtual monster, a virtual elf, a virtual pet, or the like, for example, a movable object in an animal form or another form displayed in a three-dimensional virtual world. A main control virtual character can perform at least one of interactive operations of capturing, raising, upgrading, and the like on a battle character. The battle character can assist the main control virtual character in at least one of interactive operations of collecting, fighting, changing land parcels, and the like.

Potential energy: an element, an attribute, or an identifier that affects fighting in a virtual world. Potential energy may include at least one of grass type, fire type, water type, stone type, ice type, electric type, poison type, light type, ghost type, demon type, normal type, martial type, cute type, fantasy type, insect type, wing type, dragon type, and mechanical type.

Halo: an abstract element that can impact at least one visible element of a land parcel, a main control virtual character, and a battle character within a particular range in a virtual world. The abstract element may be different from an element in one or more embodiments of this disclosure, and may be particularly used for describing a halo to concretize and visualize the halo. A halo is an abstract element that continuously appears, appears in various manners, appears along with a main control virtual character, appears along with a battle character, appears when triggered by a skill, or appears when triggered by a prop in a virtual world. The halo may be invisible or visible in a virtual world, for example, a flame halo, an optical halo, or a blood refill halo.

In a turn-based role-playing game in the related art, a player plays a virtual character in a real world or a virtual world. The turn-based RPG offers two types of maps: a world map and a battle map. In a non-battle scenario, a virtual character moves around in the world map, such as plays, captures a battle character, collects a treasure box, collects a virtual prop, and the like. In a battle scenario, a virtual character controls a captured battle character in the battle map, to perform turn-based battle with an enemy unit (such as a non-player character (NPC), AI-controlled monsters, or battle characters captured by other characters).

Since the world map and the battle map are two completely different maps in the related art, when switching between a world scene (or referred to as a non-battle scenario) and a turn-based battle scene, a user interface displays very different map content. Players can feel the difference between the two different maps and feel very abrupt. To make players feel less abrupt, a transition animation is often displayed during switching in the related art, but the effect is still not good. The world scene and the turn-based battle scene may also be referred to as out-of-battle and in-battle for short.

In the embodiments of this disclosure, an innovative turn-based RPG mechanism is provided, and a plurality of mechanisms are provided so that a player feels less abrupt or no longer feels abrupt during switching. The mechanisms include but are not limited to:

Mechanism 1: Determine a battle capability of a battle character during a battle in a turn-based battle scene based on a behavior mode of the battle character in a world scene.

The battle character includes a plurality of behavior modes in the world scene, for example, a daily behavior mode, a hiding behavior mode, and an alert behavior mode. In a case of switching from the world scene to the turn-based battle scene, the battle capability of the battle character during the battle in the turn-based battle scene is determined based on the behavior mode of the battle character in the world scene.

The battle capability includes, but is not limited to, at least one of a positive gain effect (buff), a negative gain effect (debuff), skill strength, a skill type that is allowed, and battle logic. All or some behaviors of the battle character are controlled by AI logic. The battle logic refers to a “condition-behavior” combination controlled by the AI logic in a battle process, and the “condition-behavior” combination refers to that the battle character executes a specific behavior in a specific condition.

Mechanism 2: Determine an in-battle environment of the battle character during the battle in the turn-based battle scene based on an out-of-battle environment of the battle character in the world scene.

The out-of-battle environment of the battle character in the world scene may be different types of environments. For example, an initial environment of the battle character in the world scene is a water environment, and after the battle character releases a freezing skill, the water environment may be transformed into an ice environment. If the battle character is switched from the world scene to the turn-based battle scene, the battle character is also in the ice environment in the turn-based battle scene.

Mechanism 3: Determine in-battle skill strength of the battle character during the battle in the turn-based battle scene based on the out-of-battle environment of the battle character in the world scene.

The out-of-battle environment of the battle character in the world environment may be different types of environments. If the battle character is switched from the world scene to the turn-based battle scene, the battle character is also in this environment in the turn-based battle scene. The same skill of the battle character may have different skill strength (at least one of form, attribute, and power) in different environments. For example, an impact skill is ice cube impact in the ice environment, is light impact in the water environment, and is fire impact in a fire environment.

Mechanism 4: Determine a battle map of the battle character during the battle in the turn-based battle scene based on an out-of-battle environment of the battle character in the world scene.

The traditional world map and the battle map are combined into one map. The battle map is a sub-map dynamically determined from the world map during each battle. In this way, when switching between the world scene (or referred to as a non-battle scene) and the battle scene, map content displayed in the user interface is not hugely different, to avoid the related-art problem that a player feels abrupt.

Mechanism 5: When switching between a world scene and a turn-based scene, add a transition animation for naturally connecting the two scenes.

When switching between a world scene and a turn-based scene, a transition animation for naturally connecting the two scenes is added. The transition animation is used to naturally connect the two scenes, so that a switching process naturally transitions from one scene to the other scene, and a player feels less abrupt when switching from the world scene to the turn-based battle scene.

In conclusion, in the embodiments of this disclosure, when switching from a world scene to a turn-based battle scene, at least one influencing factor in the world scene before switching affects a behavior and/or an environment in the turn-based battle scene after switching. Similarly, when switching from a turn-based battle scene to a world scene, at least one influencing factor in the turn-based battle scene before switching affects a behavior and/or an environment in the world scene.

In some embodiments, a game process of the turn-based RPG includes: a capture process and a battle process.

### Capture Process:

1. A main control virtual character explores in a world scene, and discovers a battle character in the wild. When the main control virtual character approaches the battle character within a specific range, a virtual scene screen displays a face-to-face capture scene of the battle character. In this case, the battle character may be still, move around, or threaten or attack the main control virtual character.
2. The main control virtual character prepares a container prop, for example, selects a container prop.
3. The main control virtual character aims at the battle character with the container prop. The body of the battle character displays capture-related information, such as capture difficulty (indicated by color, for example, difficulty represented by green<difficulty represented by orange<difficulty represented by red). The virtual scene screen displays an attribute of the battle character (including a name, a gender, a level, and a comprehensive attribute value). The virtual scene screen also displays an aiming circle. The aiming circle cyclically shrinks and enlarges over time. If the container prop is thrown towards the battle character when the aiming circle shrinks, chance of successfully catching is higher.
4. The main control virtual character throws the container prop to the battle character to capture the battle character. The throwing effect can be achieved through a touch control on the touch screen.

If a throwing location and/or a throwing time is incorrect, the capture fails and a capture failure prompt is displayed. If the throwing location and the throwing time are both correct, but the level or strength of the main control virtual character is insufficient, the capture fails and a capture failure prompt is displayed. If the throwing location and the throwing time are both correct and the level or strength of the main control virtual character is sufficient, the capture succeeds and a capture success prompt, rewards for successful capture (such as experience points and newly obtained skills), and an attribute of the captured battle character (such as a name, a gender, a height, a weight, a serial number, a skill, rarity, and a personality trait) are displayed.

In another possible capturing manner, the main control virtual character captures the battle character by using a capturing skill. When a capturing skill is not in a cooling state, the main control virtual character releases the capturing skill towards the battle character. In an embodiment, the virtual scene screen also displays an aiming circle. The aiming circle cyclically shrinks and enlarges over time. If the capturing skill is released towards the battle character when the aiming circle shrinks, chance of successfully catching is higher. In an embodiment, the capturing skill has a plurality of skill levels, and it is easier to successfully capture a battle character with a capturing skill having a higher level. In an embodiment, different types of capturing skills have different capturing success probabilities. Compared with a common capturing skill, it is easier to successfully capture a battle character with a dedicated capturing skill of the battle character.

In a possible implementation, the display of the capture success rate indicator is related to the capture threshold corresponding to the battle character. When the capture threshold corresponding to the battle character is larger, it is easier to capture the battle character.

A battle character that is successfully captured may be referred to as a first battle character, and a battle character that is not successfully captured may be referred to as a second battle character. The battle character may also be referred to as a pet character or other names.

A battle process may involve a single battle, a double battle, or a team battle.
1. A main control virtual character selects a first battle character for a battle.
2. A battle scene is displayed, and the main control virtual character selects a skill to be used by the first battle character.
3. A player controls a touch control on the touch screen to control the first battle character to release a skill.
4. A skill animation effect is displayed.
5. The second battle character releases a skill once, completes one round of battle, and operations 2 to 5 are repeated until the battle ends.

In the embodiments of this disclosure, the turn-based RPG involves two types of maps:

### World Map

The world map includes a plurality of land parcels. Each land parcel is polygonal. The polygonal land parcel can be any one of square, rectangle, and hexagon. For example, each land parcel is a 50 cm×50 cm square. Each land parcel has a surface attribute. The surface attribute includes grass, stone, water, or the like. In addition, the plurality of land parcels included in the world map can be of the same type, or a combination of a plurality of different types. In a different embodiment, the land parcel may alternatively be an irregular geographical area. This is not limited.

### Battle Map

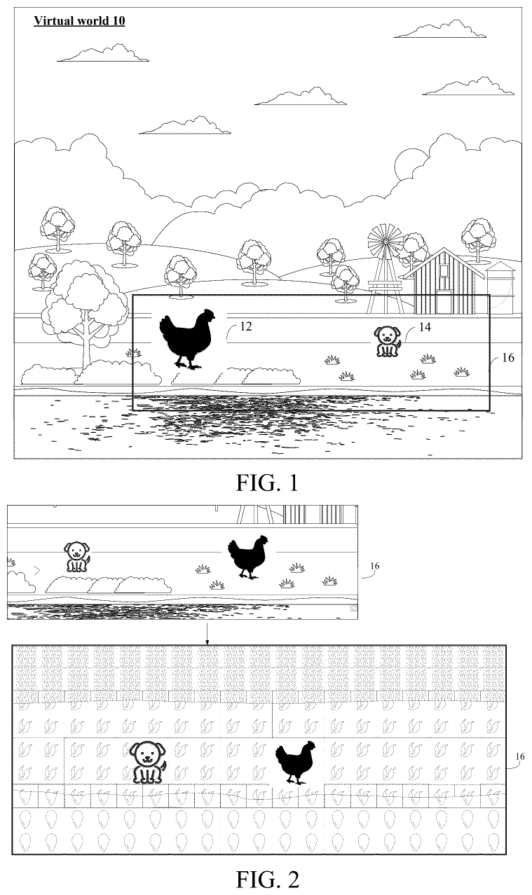

In FIG. 1 and FIG. 2, in a virtual environment 10, when a first battle character 12 encounters a second battle character 14 in a location of the world map and enters a battle, one or more land parcels within a specific range using a reference location of the first battle character 12 as the center in the world map are determined as a battle map 16. The reference location is a location where the first battle character 12 is located, or a suitable battle location closest to the first battle character 12. In some embodiments, the battle map 16 includes all land parcels in a circular range with the reference location as the center and a predetermined length as a radius. In some embodiments, the battle map 16 includes all land parcels in a rectangular range of a preset length and width with the reference location as the center.

### World Scene and Turn-Based Battle Scene

The world scene refers to a scene corresponding to the world map. When a user interface displays the world scene, the user interface can display one or more land parcels in the world map. For example, the user interface displays one or more land parcels where the main control virtual character or the first battle character is currently located in the world map, as well as some interface elements related to the displayed land parcels, the main control virtual character, the first battle character, the second battle character, and the like.

The turn-based battle scene is a scene corresponding to the battle map. When the user interface displays the turn-based battle scene, the user interface can display the battle map, for example, display all or some of land parcels included in the battle map. For example, the user interface displays one or more land parcels where the main control virtual character or the battle character is currently located in the battle map, as well as some interface elements related to the displayed land parcels, the main control virtual character, the battle character, and the like.

Switching between the world scene and the turn-based battle scene can be implemented, for example, from the world scene to the turn-based battle scene, or from the turn-based battle scene to the world scene.

A virtual camera can adopt different shooting perspectives when displaying the world scene and the turn-based battle scene. For example, during display of a world scene, the virtual camera shoots the world scene from the perspective of the main control virtual character (for example, a first-person perspective or a third-person perspective of the main control virtual character), to obtain a display image of the world scene; and during display of a turn-based battle scene, the virtual camera shoots the turn-based battle scene from the God perspective or the middle perspective (for example, the virtual camera is located above in the middle of two parties of the battle), to obtain a display image of the turn-based battle scene. In an embodiment, in the world scene and the turn-based battle scene, in addition to the shooting perspective being different, allowed user operations can also be different. For example, when a world scene is displayed, a user is allowed to manually adjust a viewing angle, or a user is allowed to control a movement of a main control virtual character or a battle character. When a turn-based battle scene is displayed, a user is not allowed to manually adjust a viewing angle, or a user is not allowed to manually control a movement of a main control virtual character or a battle character. In the above method, the user can make a perceptual distinction between the world scene and the turn-based battle scene. The world scene and the turn-based battle scene share the same world map, and the battle map used in the turn-based battle scene is one or more land parcels in the world map. Therefore, the switching between the world scene and the turn-based battle scene does not make a player feel abrupt, and instead is very smooth and natural switching.

### Capture of a Battle Character

The main control virtual character owns at least one container prop, and the container prop is configured to capture, store, raise or release the battle character. The main control virtual character captures the battle character by throwing an empty container prop, or releases the battle character by throwing a container prop storing the battle character. A specific name and shape of the container prop are not limited, and a prop having the functions of capturing, storing, raising, or releasing a subordinate character may be referred to as a container prop.

For capturing a battle character, when a capture threshold is greater than an energy value of the battle character, the battle character is in a “capturable state”. The user interface displays prompt information that the battle character is in the “capturable state”, to assist players in capturing. The capture threshold is affected by factors such as the player operation, the weather, the environment, and the number of times of previous capture. For example, a player can perform operations such as feeding fruits, using interaction skills (for example, displaying fireworks or having water fight), and attacking, and the capture threshold can be changed through the weather, the time, and other conditions in the game. Besides, the prompt information is used to assist players to capture in a friendly manner as much as possible, for example, by feeding food and changing the environment, instead of capturing through battle, to reflect the design purpose that the battle character is a good friend of the main control virtual character.

The released battle character can stay in the virtual scene and interact with the main control virtual character, can perform collection behaviors, and can battle with other battle characters. In addition, the released battle character interacts with the environment in the virtual world, for example, activates a potential energy mechanism to change potential energy of the surrounding environment, obtains a virtual item with an attribute lock in a treasure box, and affects an attribute of a land parcel in the virtual environment, such as, burns grass and freezes a lake.

The container prop also simulates a physical attribute of a real object, and can bounce back when encountering an obstacle and can also float on the water.

In an embodiment, a battle character corresponds to an initial value of the capture threshold. In an embodiment, the initial value of the capture threshold is related to a first factor, and the first factor includes at least one of the following factors:
a type and/or a level of a battle character;
a prop type and/or a prop level of a container prop used in a capture operation;
a number of times the main control virtual character captures a battle character in history;
a number of times the main control virtual character captures the same type of battle character in history;
whether a battle character has discovered the main control virtual character;
a distance between the main control virtual character and a battle character;
a degree of personality matching between the main control virtual character and a battle character; and
a degree of gender matching between the main control virtual character and a battle character.

In an embodiment, the type of the battle character includes but is not limited to bird, insect, large animal, small animal, and the like. The level includes but is not limited to elementary, intermediate, advanced, and the like. The initial value of the capture threshold of the battle character is related to the type and/or the level of the battle character. When the type of the battle character is rarer and/or the level of the battle character is higher, it is more difficult to capture the battle character, and the corresponding initial value of the capture threshold is smaller.

In an embodiment, the prop type of the container prop includes but is not limited to ordinary prop, intermediate prop, advanced prop, and the like. The prop level includes but is not limited to elementary, intermediate, advanced, and the like. When the container prop used in the capture operation has a more advanced prop type and/or higher prop level, it is easier to capture the battle character, and the corresponding initial value of the capture threshold is larger.

In an embodiment, the initial value of the capture threshold is related to the number of times the main control virtual character captures the battle character in history. The number of times the main control virtual character captures the battle character in history may be positively correlated with the initial value of the capture threshold. For example, when the number of times of history capture is larger, it indicates that it is easier for the main control virtual character to capture the battle character, and the corresponding initial value of the capture threshold is larger.

In an embodiment, the initial value of the capture threshold is related to the number of times the main control virtual character captures the same type of battle character in history. The number of times the main control virtual character captures the same type of battle character in history may be positively correlated with the initial value of the capture threshold. For example, when the number of times the same type of battle character is captured in history is larger, it indicates that the main control virtual character is better at capturing this type of battle character, that is, the initial value of the capture threshold corresponding to this type of battle character is larger.

In an embodiment, the initial value of the capture threshold is also related to whether the battle character has discovered the main control virtual character. When the battle character has not discovered the main control virtual character, the main control virtual character may go to the blind spot of the battle character and capture the battle character directly. In this case, the main control virtual character may only need to adopt a capture strategy, and the capture success rate can be relatively high without a battle. That is, when the battle character has not discovered the main control virtual character, the corresponding initial value of the capture threshold is larger.

In an embodiment, the distance between the main control virtual character and the battle character can affect the capture threshold, and the distance can be negatively correlated with the initial value of the capture threshold. For example, when the distance between the main control virtual character and the battle character is shorter, the skill release of the main control virtual character is more targeted. In this case, the capture success rate of the battle character is higher, that is, the corresponding initial value of the capture threshold is larger.

In an embodiment, the initial value of the capture threshold is also related to the degree of personality matching between the main control virtual character and the battle character. The degree of personality matching can be positively correlated with the initial value of the capture threshold. Based on the personality attribute of the battle character, each battle character has a personality of the main control virtual character that the battle character likes or hates. For example, a battle character with a bellicose personality may prefer a main control virtual character with a belligerent personality, and the degree of personality matching between the two characters is relatively high. When the degree of personality matching between the main control virtual character and the battle character is higher, it is easier to capture the battle character, that is, the initial value of the capture threshold is larger.

In an embodiment, the initial value of the capture threshold is also related to the degree of gender matching between the main control virtual character and the battle character. The degree of gender matching can be positively correlated with the initial value of the capture threshold. Based on the gender attribute of the battle character, each battle character has a gender of the main control virtual character that the battle character likes or hates. When the degree of gender matching between the main control virtual character and the battle character is higher, it is easier to capture the battle character, that is, the initial value of the capture threshold is larger.

The above values are relative values, and the specific value may be determined for individual implementations. The initial value of the capture threshold of the battle character is related to the first factor. However, for a determined first factor, whether the initial value of the capture threshold of the battle character is increased or decreased by the first factor further may be set according to the specific battle character.

### A Battle Process Changes a World Element

During a turn-based battle between different battle characters, a skill released by a battle character affects an environment of a virtual world, and this is synchronized from the turn-based battle scene to the world scene. For example, if a battle character battles in a turn-based battle scene and the battle character releases a fire skill, a grass patch in the turn-based battle scene is ignited, and the ignited grass patch is synchronized to the world scene. Further, after an environment of a land parcel is changed, the battle character is affected, for example, skill strength of the battle character is affected.

### A World Environment Changes a Battle Element

During a turn-based battle between different battle characters, an environment element in a world scene affects a battle character, for example, affects skill damage of the battle character, or affects a skill display effect of the battle character. In some examples, an environment element in a virtual world includes the environment element of a land parcel and the environment element of a weather. These two aspects comprehensively affect the extent to which the battle character hates or likes the environment element. In some examples, the extent to which the battle character hates or likes the environment element includes the following different levels: strong affinity, weak affinity, neutral, weak resistance, and strong resistance.

If the battle character likes both environment elements (the land parcel plus the weather), a strong affinity effect is obtained. If the battle character likes only one environment element and does not hate the other environment element, a relatively weak affinity effect is obtained. If a battle character likes one environment element and hates another environment element, no effect is obtained. If a battle character hates only one environment element and dislikes another environment element, a relatively weak resistance effect is obtained. If the battle character hates both environment elements, a strong resistance effect is obtained.

During the turn-based battle, a server or a client may obtain the environment element regularly (such as every turn) and determine the impact of the environment element on the battle character.

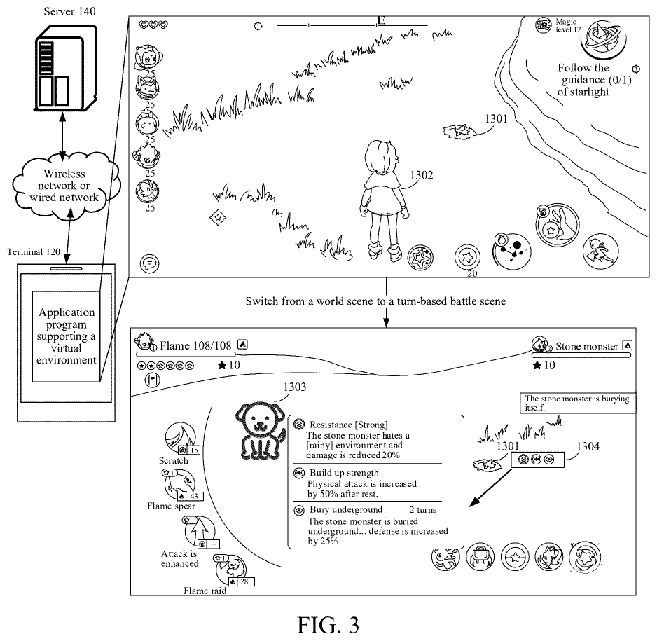

FIG. 3 is a schematic diagram of switching between different scenes according to an embodiment of this disclosure. In this embodiment of this disclosure, a behavior mode of a battle character in one scene affects a behavior mode in another scene. An example of switching from a world scene to a turn-based battle scene is used. A second battle character 1301 and a main control virtual character 1302 are displayed in the world scene, and a behavior mode of the second battle character 1301 in the world scene is a hiding behavior mode. The hiding behavior mode is a behavior mode of hiding in the ground. In response to that a scene switching condition is satisfied, the world scene is switched to a turn-based battle scene, and the main control virtual character 1302 releases a first battle character 1303 to battle against the second battle character 1301. In the turn-based battle scene, the second battle character 1301 is still in the hiding behavior mode, and prompt information “a stone monster is burying itself” is displayed on a screen. Meanwhile, some buff effects 1304 in the hiding behavior mode are displayed beside the second battle character 1301. If a player taps/clicks on the buff effect 1304, three buff effects: “strong resistance”, “build up strength”, and “buried” are displayed. “Strong resistance” represents that the second battle character 1301 does not like a rainy environment and damage is reduced by 20%. “Build up strength” represents that the second battle character 1301 improves physical attack force by 50% after rest. “Buried” represents that the second battle character 1301 is in a buried hiding state, and defense is increased by 25%.

Obviously, a behavior mode of the second battle character 1301 in the world scene affects a battle capability in a turn-based battle scene. The battle capability includes, but is not limited to, at least one of a gain increase/gain decrease effect, battle logic, skill strength, a skill type that is allowed, and the like.

Similarly, in switching from a turn-based battle scene to a world scene, a battle result of a battle character in the turn-based battle scene also affects at least one world element in the world scene.

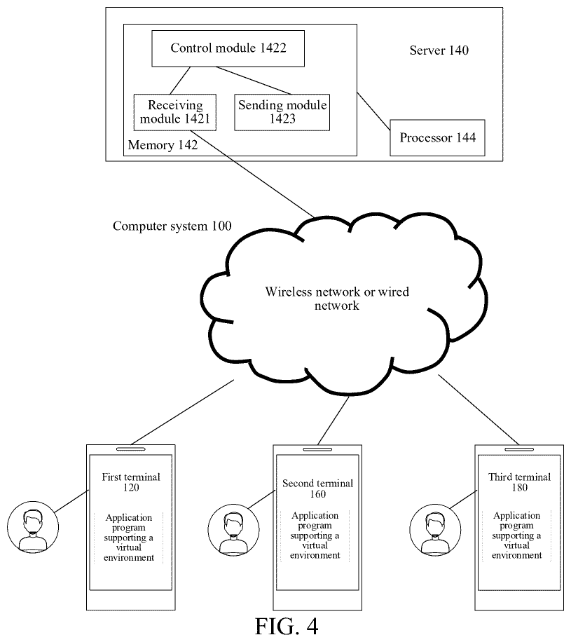

FIG. 4 is a structural block diagram of a computer system according to an embodiment of this disclosure. A computer system 100 includes: a first terminal 120, a server 140, a second terminal 160, and a third terminal 180.

An application program supporting a virtual world is installed and run in the first terminal 120. The application program can be any one of a three-dimensional map program, a virtual reality (VR) application program, an augmented reality (AR) program, an RPG program, a turn-based game program, and a turn-based RPG program. The first terminal 120 is a terminal used by a first user. The first user uses the first terminal 120 to control a first virtual character in the virtual world to perform activities. The first virtual character serves as a main control virtual character. The activities include but are not limited to: at least one of adjusting a body posture, walking, running, jumping, riding, driving, aiming, picking up, capturing a battle character, controlling a battle character, raising a battle character, using a battle character to pick, using a battle character to fight, using a throwing prop, and attacking other virtual characters. In some examples, the first virtual character is a first virtual person, such as a simulated person object or an animation person object. In some examples, the first user controls the first virtual character through a UI control on a virtual world screen to perform activities, and the first user controls the first virtual character to throw a battle character through the UI control on the virtual world screen.

The first terminal 120 is connected to the server 140 over a wireless network or a wired network.

The server 140 includes at least one of one server, a plurality of servers, a cloud computing platform, and a virtualization center. In some examples, the server 140 includes processing circuitry (for example, a processor 144) and a memory 142. The memory 142 further includes a receiving module 1421, a control module 1422, and a sending module 1423. The receiving module 1421 is configured to receive a request sent by a client, such as a request for querying a location of an energy virtual character. The control module 1422 is configured to control rendering of a virtual world screen. The sending module 1423 is configured to send a response to the client, for example, send a location of a third virtual character to the client. The server 140 is configured to provide background services for application programs that support the three-dimensional virtual world. In an embodiment, the server 140 undertakes main computing work, and the first terminal 120, the second terminal 160, and the third terminal 180 undertake secondary computing work. Alternatively, the server 140 undertakes secondary computing work, and the first terminal 120, the second terminal 160, and the third terminal 180 undertake main computing work. Alternatively, the server 140, the first terminal 120, the second terminal 160, and the third terminal 180 perform collaborative computing by using a distributed computing architecture.

An application program supporting a virtual world is installed and run in the second terminal 160. The second terminal 160 is a terminal used by a second user. The second user uses the second terminal 160 to control a second virtual character in the virtual world to perform activities. The second virtual character also serves as a main control virtual character. The activities include but are not limited to: at least one of adjusting a body posture, walking, running, jumping, riding, driving, aiming, picking up, capturing a battle character, controlling a battle character, raising a battle character, using a battle character to pick, using a battle character to fight, using a throwing prop, and attacking other virtual characters. An application program supporting a virtual world is installed and run in the third terminal 180. The third terminal 180 is a terminal used by a third user. The third user uses the third terminal 180 to control a third virtual character in the virtual world to perform activities.

In an embodiment, the first virtual character, the second virtual character, and the third virtual character are in the same virtual world. The first virtual character and the second virtual character belong to different camps, and the second virtual character and the third virtual character belong to the same camp.

In an embodiment, the application programs installed on the first terminal 120, the second terminal 160, and the third terminal 180 are the same, or the application programs installed on the three terminals are the same type of application program on different operating system platforms (Android or IOS). The first terminal 120 may refer to one of a plurality of terminals, the second terminal 160 may refer to one of a plurality of terminals, and the third terminal 180 may refer to one of a plurality of terminals. This embodiment only uses the first terminal 120, the second terminal 160, and the third terminal 180 for illustration. Device types of the first terminal 120, the second terminal 160, and the third terminal 180 are the same or different. The device type includes at least one of a smartphone, a smart watch, a smart TV, a tablet computer, an e-book reader, an MP3 player, an MP4 player, a laptop computer, and a desktop computer. An example in which the terminal includes a smart phone is used for description in the following embodiments.

A person skilled in the art knows that the number of the above terminals may be more or less. For example, there may be only one terminal, or there may be dozens of or hundreds of terminals or more. A number of terminals and a device type are not limited in this embodiment of this disclosure.

This embodiment of this disclosure involves two switching sequences between virtual scenes: switching sequence 1: switching from a “world scene” to a “turn-based battle scene”; and switching sequence 2: switching from a “turn-based battle scene” to a “world scene”.

Switching Sequence 1: Switching from a “World Scene” to a “Turn-Based Battle Scene”:

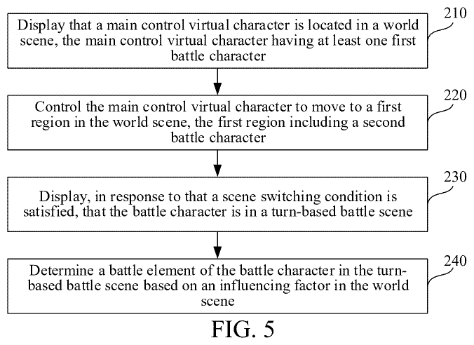

FIG. 5 is a flowchart of a virtual scene switching method according to an embodiment of this disclosure. The method may be performed by a terminal device and includes:

Operation 210: Display that a main control virtual character is located in a world scene. In one example, a main control virtual character is displayed in a world scene. The main control virtual character has a first battle character subordinate to the main control virtual character.

The world scene is obtained through rendering based on a world map. The world map is usually a large map of an open virtual world. The world map includes a plurality of land parcels. Each land parcel is polygonal.

In some embodiments, the main control virtual character has at least one first battle character. The first battle character is a battle character successfully captured by the main control virtual character. For example, the first battle character is a pet virtual character successfully captured by the main control virtual character. The main control virtual character is a virtual character controlled by a current player. The first battle character successfully captured may be controlled by the current player, or may be controlled by AI, or the current player may specify a battle strategy and then the first battle character is controlled by AI based on the battle strategy. This is not limited in this disclosure.

In this embodiment, it is assumed that in an initial case, at least one of the main control virtual character, the first battle character, and the second battle character is located in the world scene.

Operation 220: Control the main control virtual character to move to a first region in the world scene. In one example, the main control virtual character is controlled to move to a first region in the world scene. In one example, a second battle character is in the first region.

The first region is a location or a region to which the main control virtual character moves in the world scene. The first region may be any location in the world scene. The first region includes the second battle character, and the main control virtual character moves to a location or a region in which the second battle character is located. When the main control virtual character moves in the world scene, a game system detects a region in which the main control virtual character is located. In this disclosure, it is assumed that the main control virtual character moves, in the world scene, to a region in which the second battle character is located, that is, the first region.

In an embodiment, the first region may be a designated location, and the main control virtual character can battle with the second battle character only after moving to the designated location. Alternatively, the first region may be a region range within which the second battle character is located, and the main control virtual character can trigger a battle after entering the region range.

In some embodiments, the second battle character includes at least one of an NPC, a monster controlled by AI, a battle character that is not successfully captured, and a battle character captured by a virtual character controlled by another player.

Operation 230: Display, in response to that a scene switching condition is satisfied, that the battle character is in a turn-based battle scene. In one example, based on a scene switching condition being satisfied, one or more battle characters are displayed in a turn-based battle scene, the one or more battle characters including at least one of the first battle character or the second battle character.

The scene switching condition is a condition used to trigger switching between the world scene and the turn-based battle scene. In some embodiments, the scene switching condition is manually triggered by a current player. For example, the current player controls the main control virtual character to aim at a non-captured battle character with a container prop and throw the container prop towards the battle character, to trigger the scene switching condition. In some embodiments, the scene switching condition is manually triggered by another player. For example, another player initiates a battle with the current player. In some embodiments, the scene switching condition is triggered by a terminal device or a server. For example, after the main control virtual character approaches a wild monster, a distance between the main control virtual character and a second battle character is less than a threshold. In this case, the terminal device or the server automatically triggers the scene switching condition based on AI control logic. A manner of triggering the scene switching condition is not limited in this disclosure.

In some embodiments, the scene switching condition includes but is not limited to at least one of the following:
the main control virtual character throws a container prop towards the second battle character;
the main control virtual character uses magic against the second battle character;
the main control virtual character performs an interaction operation on the second battle character, for example, initiates a battle, feeds, or caresses;
a distance between the main control virtual character and the second battle character is less than a first threshold;
a distance between the main control virtual character and the second battle character is less than a first threshold, and an alert value of the second battle character is greater than a second threshold;
a distance between the main control virtual character and the second battle character is less than a first threshold, and the second battle character is in a negative emotion state; and
a first main control virtual character encounters a second main control virtual character in the world map, and the first main control virtual character and the second main control virtual character have a chat and agree to perform a turn-based battle at the end of the chat.

The first main control virtual character is a main control virtual character controlled by a first player, and the second main control virtual character may be a main control virtual character controlled by a second player, or may be a non-player character (NPC) set in a game. In another example, the first main control virtual character encounters the second main control virtual character in the world map, the second main control virtual character raids the first main control virtual character, and the first main control virtual character is forced to enter a turn-based battle.

The world scene is switched to the turn-based battle scene in response to that the scene switching condition is satisfied, and that the virtual character is in the turn-based battle scene is displayed. In some embodiments, the world scene is directly switched to the turn-based battle scene. In some embodiments, in a switching process of switching from the world scene to the turn-based battle scene, a transition animation is inserted, to make the player feel less abrupt in switching from the world scene to the turn-based battle scene.

The turn-based battle scene is obtained through rendering based on a battle map. In various examples, a map area of the battle map is smaller than a map area of the world map. In some embodiments, the battle map is a map independent of the world map and different from the world map. In some embodiments, the battle map is a sub-map based on the world map. For example, based on a location of the virtual character before switching, a small sub-map is selected from the world map to dynamically generate the battle map, such that a world scene displayed before switching is the same as a turn-based battle scene displayed after switching, or a similarity degree is higher than a preset condition.

Operation 240: Determine a battle element of the battle character in the turn-based battle scene based on an influencing factor in the world scene. In one example, a battle attribute of one of the one or more battle characters in the turn-based battle scene is determined, by processing circuitry, based on (i) a behavior mode of the one of the one or more battle characters in the world scene or (ii) an influencing factor in the world scene. In one example, the battle attribute of one of the one or more battle characters corresponds to a battle capability of the one of the one or more battle characters. In one example, the one of the one or more battle characters are controlled, by the processing circuitry, to engage i in the turn-based battle scene based on the battle element of the one of the one or more battle characters.

After switching to the turn-based battle scene, the battle element of the battle character in the turn-based battle scene is determined based on at least one influencing factor in the world scene.

In some examples, the influencing factor is a factor other than a skill, battle strength, a battle attribute, a life value attribute, and a magic value attribute of the virtual character.

In some embodiments, to keep the world scene and the turn-based battle scene consistent, at least the following five improvement mechanisms are provided. In different embodiments, at least one of the five improvements may be implemented as a separate embodiment. In this embodiment of this disclosure, the five improvement mechanisms are divided into five branches, and the five branches are respectively described below:

### First Branch:

determining a battle capability of the battle character during a battle in the turn-based battle scene based on a behavior mode of the battle character in the world scene.

### Second Branch:

determining an in-battle environment of the battle character during the battle in the turn-based battle scene based on an out-of-battle environment of the battle character in the world scene.

### Third Branch:

determining in-battle skill strength of the battle character during the battle in the turn-based battle scene based on the out-of-battle environment of the battle character in the world scene.

### Fourth Branch:

determining a battle map of the battle character during the battle in the turn-based battle scene based on the out-of-battle environment of the battle character in the world scene.

### Fifth Branch:

during switching from the world scene to the turn-based battle scene, adding a transition animation for naturally connecting the two scenes, so that a player feels less abrupt when switching from the world scene to the turn-based battle scene.

In conclusion, in the method of this embodiment, the battle element of the battle character in the turn-based battle scene is determined based on the influencing factor in the world scene. Therefore, a difference between the world scene and the turn-based battle scene can be downplayed, interplay between the world scene and the turn-based battle scene can be increased, and consistency between the world scene and the turn-based battle scene can be improved, so that a player feels less abrupt or no longer feels abrupt in a scene switching process.

The five branches are respectively described below.

### First Branch:

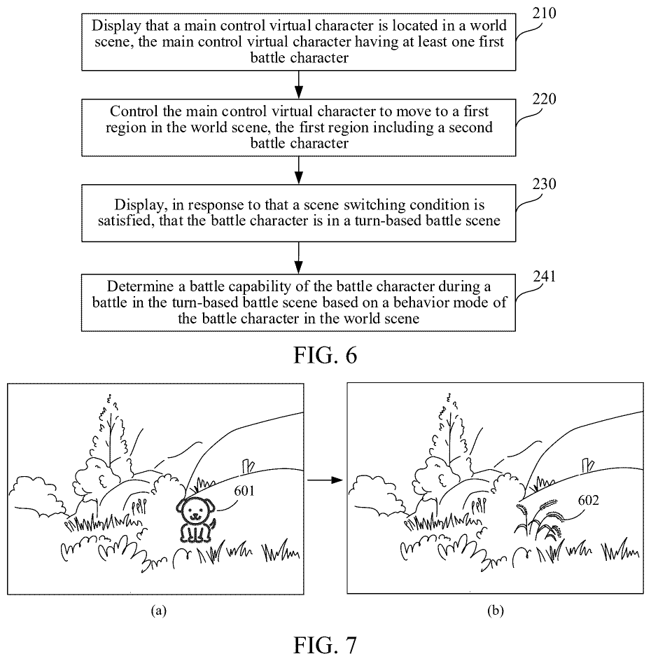

In FIG. 6, the operation 240 includes the following sub-operation 241:
Operation 241: Determine a battle capability of a battle character during a battle in a turn-based battle scene based on a behavior mode of the battle character in a world scene.

The behavior mode is a mode in which the battle character performs a behavior based on an AI control strategy. The AI control strategy is an automatic control strategy not actively controlled by a player based on, for example, an AI model, a behavior tree, or a behavior group. Different behavior modes are controlled by using different AI control strategies. In different embodiments, the AI control strategy may be equivalently understood as any one of meanings such as an AI model, a behavior tree, a behavior group, and a control strategy. In some embodiments, the behavior mode may be understood as a set of at least one group of “condition+behavior”. A group of “condition+behavior” is a control strategy in which a condition triggers a battle character to execute one or more behaviors or one type of behavior.

A non-captured battle character is used as an example to simulate a life habit of a wild battle character. A plurality of behavior modes are preset for the same battle character.

The behavior mode includes at least one of the following: a daily behavior mode; an environmental behavior mode; a perceptual behavior mode; a group behavior mode; and a sneak attack behavior mode. In some examples the daily behavior mode is a behavior mode executed when the battle character perceives no perception event in the world scene; the environmental behavior mode is a behavior mode executed when the battle character perceives, in the world scene, a perception event triggered by an environment element; the perceptual behavior mode is a behavior mode executed after the battle character perceives, in the world scene, a perception event triggered by an enemy virtual character; the group behavior mode is a behavior mode in which the plurality of battle characters execute behaviors according to a team strategy or a tribe strategy; and the sneak attack behavior mode is a behavior mode for ambush.

The battle character may be the second battle character, or may be the first battle character. That is, the battle character in this embodiment includes at least one of the first battle character and the second battle character.

In an embodiment, in response to that the scene switching condition is satisfied, a terminal device obtains an ID of a behavior mode of the battle character in the world scene, and then selects, based on the ID of the behavior mode, a battle capability matching the ID of the behavior mode from a preconfigured battle capability table as the battle capability of the battle character during the battle in the turn-based battle scene.

In some examples, this is shown in Table 1.

TABLE 1

| | |
|---|---|
| ID: 001 (daily behavior mode) | Basic battle capability |
| ID: 002 (environmental behavior mode) | Battle capability 1 |
| ID: 003 (perceptual behavior mode) | Battle capability 2 |
| ID: 004 (group behavior mode) | Battle capability 3 |
| ID: 005 (sneak attack behavior mode) | Battle capability 4 |

The table is a battle capability table preconfigured for the battle character, and the battle character may be the first battle character or the second battle character. In the table, if the terminal device obtains that the battle character is in the daily behavior mode, the basic battle capability (basic battle capabilities of different types of battle characters are the same or different) is determined from the battle capability table. If the terminal device determines that the battle character is in the environmental behavior mode, the battle capability 1 (battle capabilities 1 of different types of battle characters are the same or different) is determined from the battle capability table. If the terminal device determines that the battle character is in the perceptual behavior mode, the battle capability 2 (battle capabilities 2 of different types of battle characters are the same or different) is determined from the battle capability table. If the terminal device determines that the battle character is in the group behavior mode, the battle capability 3 (battle capabilities 3 of different types of battle characters are the same or different) is determined from the battle capability table. If the terminal device determines that the battle character is in the sneak attack behavior mode, the battle capability 4 (battle capabilities 4 of different types of battle characters are the same or different) is determined from the battle capability table.

The five behavior modes are respectively described below.

### Daily Behavior Mode:

The daily behavior of the second battle character is described herein.

The daily behavior mode is a behavior mode executed when the second battle character perceives no perception event in the world scene. In some embodiments, a plurality of AI control strategies are set for the second battle character, where one AI control strategy is used for controlling a behavior of the second battle character when the second battle character perceives no perception event in the world scene.

The daily behavior mode is used to simulate daily living behaviors of the second battle character, such as walking, patrolling, foraging, sleeping, and drinking water.

Environmental Behavior Mode (a Behavior Mode Triggered when a Specific Environment Element is Perceived):

That the second battle character perceives a preset or particular environment element is described herein.

The environmental behavior mode is a behavior mode executed after the second battle character perceives, in the world scene, a perception event triggered by the environment element. The perception event triggered by an environment element is a perception event triggered by a factor other than the main control virtual character and the first battle character. In some examples, a perception event may be triggered by an environment element such as a preset or particular environment element.

In some embodiments, a plurality of AI control strategies are set for the second battle character, where one AI control strategy is used for controlling a behavior of the second battle character when the second battle character perceives, in the world scene, a perception event triggered by the environment element.

The environmental behavior mode is a behavior mode triggered by a preset or particular environment element. In some embodiments, the environmental behavior mode is a hiding behavior mode triggered by a preset or particular environment element, that is, under the preset or particular environment element, the second battle character performs an activity according to a behavior mode of hiding the second battle character.

The environmental behavior mode includes at least one of a hiding behavior mode, a disguise behavior mode, a sleep behavior mode, an escape behavior mode, a fierce battle mode, an alert behavior mode, and the like.
Hiding behavior mode: the second battle character adopts a behavior mode of hiding itself, to avoid being perceived or attacked by the main control virtual character. This may include hiding in a shadow, hiding behind an object, using an invisible skill, or the like.
Disguise behavior mode: the second battle character adopts a behavior mode of disguising itself, to confuse the main control virtual character. This may include changing a shape of the second battle character to that of another virtual character according to a surrounding environment, or the like.

In some embodiments, the disguise behavior mode may also be considered as one of hiding behavior modes.
Sleep behavior mode: the second battle character enters a sleep state, to reduce activities and restore life values or energy. This behavior mode may be triggered when the second battle character is seriously injured or resources are starved, for example, a hibernation mode.
Escape behavior mode: the second battle character selects to escape from the turn-based battle scene, to avoid being defeated. This behavior mode may be triggered when a life value of the second battle character is less than a threshold or faces an adverse situation.
Fierce battle mode: the second battle character presents an extreme attack behavior mode, and attacks the main control virtual character at all costs. This behavior mode may be triggered when the second battle character is angered or in an extremely dangerous state.
Alert behavior mode: the second battle character is highly vigilant and cautious, to respond to a potential threat. This behavior mode may be automatically activated when the second battle character perceives existence of an enemy battle character or another threat.

The preset or particular environment element includes: at least one of a time period, a weather type, and a terrain attribute. Environmental behavior modes corresponding to different environment elements may be the same or may be different.

In an embodiment, the environmental behavior mode may be further subdivided into a hiding behavior mode, a disguise behavior mode, a sleep behavior mode, an escape behavior mode, a fierce battle mode, and an alert behavior mode. The terminal device determines, from a preconfigured battle capability table according to an obtained ID of a sub-divided behavior mode, a battle capability corresponding to the behavior mode, as the battle capability of the battle character during the battle in the turn-based battle scene.

In one example, in a case that the environmental behavior mode is a first type environmental behavior mode triggered by a time period, the battle capability of the second battle character during the battle in the turn-based battle scene is determined according to the first type environmental behavior mode.

The time period is a subset of all time in the world scene. The time period is represented in a form such as year, season, day and night, or hour in the world scene. In a case that the environmental behavior mode is a first type environmental behavior mode triggered by a time period, the battle capability of the second battle character during the battle in the turn-based battle scene is determined according to the first type environmental behavior mode.

For example, the time period is nighttime, and the second battle character is a battle character of a dark attribute. In the nighttime, according to a behavior mode of a night lurking activity, the battle character of the dark attribute has an enhanced visual field at night. In switching from the world scene to the turn-based battle scene, the battle character of the dark attribute obtains a positive gain state of “visual field enhanced”. Therefore, the behavior mode of the night lurking activity reduces a probability that the battle character of the dark attribute is discovered by the first battle character. For another example, the first time period is nighttime, and the second battle character is a battle character of a ghost type. The battle character of the ghost type enters a transparent hiding behavior mode in the nighttime. In this case, if the main control virtual character approaches, throws a container prop, releases a skill, or the like, the battle character of the ghost type is directly passed through. In switching from the world scene to the turn-based battle scene, a hiding capability of the battle character of the ghost type is enhanced. Because the battle character of the ghost type enters the hiding behavior mode in the nighttime, a probability that the battle character is caught by the main control virtual character is reduced.

In one example, in a case that the first type environmental behavior mode is a hiding behavior mode triggered by a first time period and a battle time belongs to the first time period, the battle capability of the battle character during the battle in the turn-based battle scene is determined according to the hiding behavior mode.

The first time period is a subset of all time in the world scene. The first time period is represented in a form such as year, season, day and night, or hour in the world scene. The battle time changes along with a system time in the world scene.

For example, the first time period is nighttime, and the second battle character is a battle character of the ghost type. In switching from the world scene to the turn-based battle scene, the second battle character enters the hiding behavior mode during the nighttime. When the second battle character battles with the first battle character during the nighttime, a hiding capability of the second battle character is enhanced.

In some embodiments, in a case that the first type environmental behavior mode is the hiding behavior mode triggered by the first time period and the battle time does not belong to the first time period, the battle capability of the battle character during the battle in the turn-based battle scene is determined according to the daily behavior mode or an applicable type environmental behavior mode corresponding to the battle time. In some embodiments, the battle character is in the hiding behavior mode when entering a battle, and in an entire battle process, the battle capability of the battle character may be determined according to the hiding mode.

For example, the first time period is nighttime, and the second battle character is a battle character of the ghost type. In switching from the world scene to the turn-based battle scene, the second battle character enters the hiding behavior mode during the nighttime. When the battle time transitions from the nighttime to the morning time, the second battle character is switched from the hiding behavior mode to the daily behavior mode. When the second battle character battles against the first battle character and the current battle time continues to the morning time, the battle character of the ghost type cannot be hidden, that is, the battle capability of the second battle character restores to a normal battle capability during the battle with the first battle character.

In one example, in a case that the environmental behavior mode is a second type environmental behavior mode triggered by a weather type, the battle capability of the second battle character during the battle in the turn-based battle scene is determined according to the second environmental behavior mode.

The weather type is a subset of all weather types in the world scene. The weather type includes at least one of: sun, cloud, overcast, rain, snow, thunder, hail, floating dust, sand, sandstorm, wind, and haze. In the case that the environmental behavior mode is a second type environmental behavior mode triggered by a weather type, the battle capability of the second battle character during the battle in the turn-based battle scene is determined according to the second environmental behavior mode.

For example, the weather type is rain, and the second battle character is a battle character of a water type. In a non-rainy day, the battle character of the water type is hidden in water for an activity. In a rainy day, the battle character of the water type leaves water for an activity. In a rainy day, the battle capability of the battle character of the water type is greatly enhanced. When the main control virtual character attempts to capture the battle character of the water type, the world scene is switched to the turn-based battle scene, and the battle character of the water type enters a fierce battle mode. The battle capability of the battle character of the water type may be enhanced, for example, an attack capability and a hit rate are improved. For another example, the weather type is snow, and the second battle character is a battle character of an ice type. The battle character of the ice type appears only on a snowy day. On the snowy day, the battle character of the ice type enters a disguise behavior mode. In switching from the world scene to the turn-based battle scene, the battle character of the ice type disguises a location by using ice or snow, and performs sneak attack against the first battle character in a disguised state.

In one example, in a case that the second type environmental behavior mode is a hiding behavior mode triggered by a first weather type and a current weather type belongs to the first weather type, the battle capability of the battle character during the battle in the turn-based battle scene is determined according to the hiding behavior mode.

The first weather type is a subset of all weather types in the world scene. The first weather type includes at least one of: sun, cloud, overcast, rain, snow, thunder, hail, floating dust, sand, sandstorm, wind, and haze. The current weather type changes along with a system time in the world scene, or the current weather type is triggered by a skill of the battle character to change.

For example, the first weather type is rain, and the second battle character is a battle character of a rain type. When the first weather type is rain, in switching from the world scene to the turn-based battle scene, the second battle character enters a hiding behavior mode, and the second battle character battles with the first battle character in the rainy day. The battle character of the rain type can apply an invisible skill, and a hiding capability of the second battle character is enhanced.

In some embodiments, in a case that the second type environmental behavior mode is the hiding behavior mode triggered by the first weather type and the current weather type does not belong to the first weather type, the battle capability of the battle character during the battle in the turn-based battle scene is determined according to the daily behavior mode or an applicable type environmental behavior mode corresponding to the current weather type. In some embodiments, the battle character is in the hiding behavior mode when entering a battle, and in an entire battle process, the battle capability of the battle character may be determined according to the hiding mode.

For example, the first weather type is rainy, and the second battle character is a battle character of a rain type. When the world scene is switched to the turn-based battle scene, the second battle character battles with the first battle character, and the second battle character enters a hiding behavior mode. During the battle, when the current weather type changes from rainy to sunny, the second battle character is switched from the hiding behavior mode to a daily behavior mode. When the current weather type is sunny, the battle character of the rain type cannot apply an invisible skill, and a battle capability of the second battle character restores to a normal battle capability during the battle with the first battle character.

In one example, in a case that the environmental behavior mode is a third type environmental behavior mode triggered by a terrain attribute, the battle capability of the second battle character during the battle in the turn-based battle scene is determined according to the third environmental behavior mode.

The terrain attribute is a subset of all terrain attributes in the world scene, and the terrain attribute includes at least one of the following types: lake, river, mountain, grassland, soil, flame, ice, desert, forest, and sandstone. In the case that the environmental behavior mode is the third type environmental behavior mode triggered by the terrain attribute, the battle capability of the second battle character during the battle in the turn-based battle scene is determined according to the third environmental behavior mode.

For example, the terrain attribute is grassland, and the second battle character is a battle character of a plant type. When the second battle character is located in a grassland, the battle character of the plant type is transformed to a plant such as a grass or a flower. In this case, the second battle character enters a disguise behavior mode. When the world scene is switched to the turn-based battle scene, the battle character of the plant type obtains a stronger defense capability and a stronger restoration capability in the disguise mode. For another example, the terrain attribute is flame, and the second battle character is a battle character of a fire type. When the second battle character is located in a flame land, the battle character of the fire type enters a fierce battle mode. When the world scene is switched to the turn-based battle scene, the battle character of the fire type may obtain a positive gain state corresponding to the flame land, for example, an improved attack force or speed. In an embodiment, the battle character of the fire type may obtain an exclusive skill corresponding to the flame land, for example, master a control capability of the flame land, so that it is easier to fire a terrain or the main control virtual character. These skills make the battle character of the fire type more damaging and deterrent.

In one example, in a case that the third type environmental behavior mode is a hiding behavior mode triggered by a first terrain attribute and a location of the battle character belongs to the first terrain attribute, the battle capability of the battle character during the battle in the turn-based battle scene is determined according to the hiding behavior mode.

The first terrain attribute is a subset of all terrain attributes in the world scene, and the first terrain attribute includes at least one of the following types: lake, river, mountain, grassland, soil, flame, ice, desert, forest, and sandstone. The location of the battle character dynamically changes during the battle in the turn-based battle scene.

For example, the first terrain attribute is soil, and the second battle character is a battle character of a soil type. When the world scene is switched to the turn-based battle scene, the second battle character battles with the first battle character on soil. The battle character of the soil type enters a hiding behavior mode, the battle character of the soil type can apply a skill of walking through the ground, and the battle capability of the second battle character is enhanced during the battle in the turn-based battle scene.

In some embodiments, in a case that the third type environmental behavior mode is the hiding behavior mode triggered by the first terrain attribute and the location of the battle character does not belong to the first terrain attribute, the battle capability of the battle character during the battle in the turn-based battle scene is determined according to the daily behavior mode or an applicable type environmental behavior mode corresponding to a terrain attribute of the location of the battle character. In some embodiments, the battle character is in the hiding behavior mode when entering a battle, and in an entire battle process, the battle capability of the battle character may be determined according to the hiding mode.

For example, the first terrain attribute is river, and the second battle character is a battle character of a water type. When the world scene is switched to the turn-based battle scene, the second battle character battles with the first battle character in a river, and the second battle character enters a hiding behavior mode. During the battle, locations of the first battle character and the second battle character change. When the location of the second battle character changes from river to soil, the terrain attribute is changed, and the second battle character is switched from the hiding behavior mode to the daily behavior mode. Alternatively, the first battle character releases a freezing skill against the second battle character, the location of the second battle character changes from river to ice, and the terrain attribute is changed, and the second battle character is also switched from the hiding behavior mode to the daily behavior mode. The battle character of the water type cannot apply the hidden skill, and the battle capability of the second battle character restores to a normal battle capability during the battle with the first battle character.

In some examples, as shown in (a) of FIG. 7, a second battle character 601 is a battle character of a plant type. When a first land type is grassland, as shown in (b) of FIG. 7, the second battle character 601 is transformed to a plant 602. In this case, the second battle character 601 enters a disguise behavior mode, and can obtain a higher hiding capability in the disguise behavior mode, reducing a probability of being discovered by the main control virtual character. Even if the second battle character 601 is discovered by the main control virtual character, when the world scene is switched to the turn-based battle scene, the second battle character can obtain at least one of an extra defense capability, an extra restoration capability, extra battle logic, and an extra exclusive skill.

### Perceptual Behavior Mode (a Behavior Mode Triggered by the Main Control Virtual Character):

Herein, an example in which the second battle character is triggered by the main control virtual character is used for description.

The perceptual behavior mode is a behavior mode executed after the battle character perceives, in the world scene, a perception event triggered by an enemy virtual character. Using the second battle character as an example, the perceptual behavior mode is a behavior mode executed after the second battle character perceives, in the world scene, the perception event triggered by the main control virtual character and/or the first battle character.

The perceptual behavior mode includes at least one of a hiding behavior mode, a disguise behavior mode, a sleep behavior mode, an escape behavior mode, a fierce battle mode, an alert behavior mode, and the like.

In an embodiment, the perceptual behavior mode may be further subdivided into a hiding behavior mode, a disguise behavior mode, a sleep behavior mode, an escape behavior mode, a fierce battle mode, and an alert behavior mode. The terminal device determines, from a preconfigured battle capability table according to an obtained ID of a sub-divided behavior mode, a battle capability corresponding to the behavior mode, as the battle capability of the battle character during the battle in the turn-based battle scene.

In one example, in a case that the perceptual behavior mode is a first type perceptual behavior mode triggered by a restraining relationship between battle characters of different attributes, the battle capability of the second battle character during the battle in the turn-based battle scene is determined according to the first type perceptual behavior mode.

A restraining relationship between virtual characters means that there is a restraining relationship between different virtual characters. In some embodiments, different virtual characters have different attributes. The attribute includes at least one of a gold type, a wood type, a water type, a fire type, a soil type, a light type, a dark type, a lightning type, a snow type, an ice type, and the like. There is a restraining relationship between different attributes, for example, the fire type restrains the wood type, and the water type restrains the fire type. When the perceptual behavior mode is associated with the restraining relationship between virtual characters, the behavior of the second battle character in the turn-based battle scene is changed according to a behavior mode corresponding to the restraining relationship.

In some embodiments, when the first battle character restrains the second battle character, the perceptual behavior mode corresponding to the second battle character is at least one of a hiding behavior mode, a disguise behavior mode, an escape behavior mode, and an alert behavior mode, and the perceptual behavior mode corresponding to the first battle character is a fierce battle mode.

In some embodiments, when the second battle character restrains the first battle character, the perceptual behavior mode corresponding to the first battle character is at least one of a hiding behavior mode, a disguise behavior mode, an escape behavior mode, and an alert behavior mode, and the perceptual behavior mode corresponding to the second battle character is a fierce battle mode.

For example, the second battle character is a battle character of a wood type. When the battle character of the wood type perceives that a battle character of a fire type exists within 100 meters nearby, the battle character of the wood type enters an escape behavior mode. When the world scene is switched to the turn-based battle scene, the battle character of the wood type may preferentially select skills such as escaping, walking through the ground, or dodging, to avoid direct battle with the virtual character of the fire type as much as possible. Alternatively, the battle character of the wood type increases a moving speed, to escape from an attack range of the virtual character of the fire type more quickly. For another example, the second battle character is a battle character of a fire type. When the battle character of the fire type encounters a battle character of a water type, the battle character of the fire type enters an escape behavior mode. When the world scene is switched to the turn-based battle scene, a special skill or magic of the battle character of the fire type weakens, for example, an attack capability and a hit rate are reduced. The battle character of the fire type may enhance defense to reduce damage caused by the virtual character of the water type, and increase a moving speed.

In one example, in a case that the first type perceptual behavior mode is a hiding behavior mode triggered by the restraining relationship between the battle characters of the different attributes, the battle capability of the battle character during the battle in the turn-based battle scene is determined according to the hiding behavior mode.

The hiding behavior mode belongs to a perceptual behavior mode. A restraining relationship between battle characters means that there is a restraining relationship between battle characters of different attributes. For example, there is a restraining relationship between different attributes, for example, the fire type restrains the wood type, the water type restrains the fire type, and the wind type restrains the water type.

For example, the second battle character is a battle character of a water type, the first battle character is a battle character of a wind type, and the battle character of the wind type restrains the battle character of the water type, that is, the first battle character restrains the second battle character. After the second battle character perceives the first battle character, the second battle character enters a hiding behavior mode. In this case, the second battle character increases a moving speed and applies a dodging skill, to quickly escape in the turn-based battle scene.

In some embodiments, in a case that the enemy battle character is switched, the battle capability of the battle character during the battle in the turn-based battle scene is determined according to the daily behavior mode or a perceptual behavior mode corresponding to the enemy battle character. In some embodiments, the battle character is in the hiding behavior mode when entering a battle, and in an entire battle process, the battle capability of the battle character may be determined according to the hiding mode.

For example, the second battle character is a battle character of the water type, and the first battle character is a battle character of the wind type. In this case, the second battle character enters a hiding behavior mode after perceiving the first battle character. After the first battle character is switched to a battle character of the fire type, the second battle character is switched from the hiding behavior mode to the fierce battle mode after perceiving the first battle character, and an attack capability of the second battle character is enhanced in the turn-based battle scene.

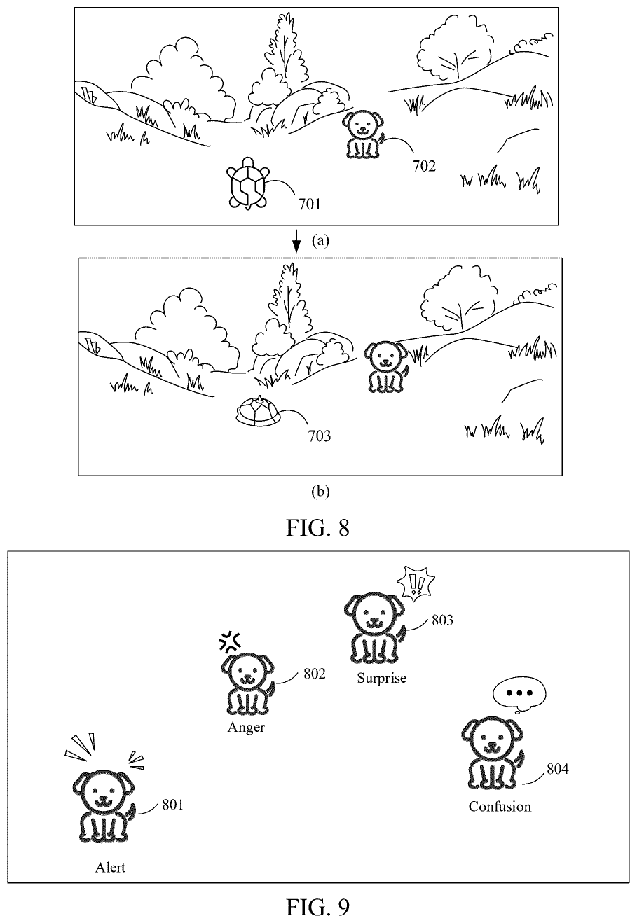

In some examples, as shown in (a) of FIG. 8, a second battle character 701 and a first battle character 702 have a restraining relationship. When the second battle character 701 perceives the first battle character 702, as shown in (b) of FIG. 8, the second battle character 701 enters a hiding behavior mode and enters a state 703 of curling up underground. The second battle character 701 selects to take a defensive measure to reduce a possibility of being hurt. Hiding in a shell can provide additional defense and protection and increase difficulty of being attacked by the first battle character 702.

In one example, in a case that the perceptual behavior mode is a second type perceptual behavior mode triggered by a stress response, the battle capability of the battle character during the battle in the turn-based battle scene is determined according to the second type perceptual behavior mode.

The stress response is a behavior response of the battle character after the battle character perceives an enemy battle character. For example, the battle character is the second battle character. The stress response is a behavior response of the second battle character after perceiving the main control virtual character and/or the first battle character. In some embodiments, the stress response includes at least one of hiding, alert, escape, surprise, confusion, anger, and the like.

In one example, in a case that the second type perceptual behavior mode is a hiding behavior mode triggered by the stress response, the battle capability of the battle character during the battle in the turn-based battle scene is determined according to the hiding behavior mode.

In an embodiment, when the second type perceptual behavior mode is the hiding behavior mode and the second battle character perceives the first battle character or the main control virtual character, the second battle character enters the hiding behavior mode, and performs an activity according to a behavior mode of hiding the second battle character.

For example, the second battle character is a battle character of the soil type. When the second battle character perceives that the first battle character is nearby or the main control virtual character is approaching, after the turn-based battle scene is entered, the second battle character generates a stress response of walking through the ground, and enters the hiding behavior mode, the second battle character is on high alert, and a hiding capability of the battle character of the soil type is improved. In this case, the battle character of the soil type selects an appropriate time to appear again or attacks when the first battle character does not pay attention.

In some embodiments, in a case that a duration of the stress response reaches a first duration for switching, the battle capability of the battle character during the battle in the turn-based battle scene is determined according to the daily behavior mode. In some embodiments, the battle character is in the hiding behavior mode when entering a battle, and in an entire battle process, the battle capability of the battle character may be determined according to the hiding mode. The first duration is a preset duration threshold. In an embodiment, different battle characters correspond to different values of the first duration. In an embodiment, different battle characters correspond to the same value of the first duration. This is not limited in this disclosure.

For example, when perceiving that the first battle character is nearby or the main control virtual character is approaching, the second battle character generates the stress response and enters the hiding behavior mode. When the hidden behavior of the second battle character reaches a preset duration, or the second battle character perceives that the danger disappears, the hiding behavior mode is switched to the daily behavior mode. In this case, the battle capability of the second battle character is changed during the battle with the first battle character.

In some embodiments, the stress response of the second battle character is transmitted to the player in manners such as a special effect and an action, so that the player realizes that the second battle character has received the impact and generated the stress response. According to personality settings of different second battle characters, stress responses of the different second battle characters are different, and may be presented to the main control virtual character in manners such as expressions, actions, and chat boxes of the second battle characters.

In some examples, as shown in FIG. 9, FIG. 9 shows presentation of a second battle character under different stress responses. A second battle character 801 generates a stress response of warning other surrounding battle characters. Alternatively, the second battle character 802 generates an angry stress response. Alternatively, the second battle character 803 generates a surprising stress response. Alternatively, the second battle character 804 generates a confusing stress response. Alternatively, the stress response of the second battle character is presented to a player in a manner such as an expression, an action, or a chat box.

For example, when the stress response is a hiding response and the second battle character perceives the main control virtual character, the second battle character enters the hiding behavior mode. When the world scene is switched to the turn-based battle scene, the second battle character may search for a cover object or use an invisible skill, to increase a hiding capability and reduce a probability of being discovered by the main control virtual character. In the hiding behavior mode, the second battle character may wait for an occasion, and select a more favorable occasion to attack or escape.

In some embodiments, when the perceptual behavior mode is the hiding behavior mode, the second battle character performs an activity according to a behavior mode of hiding the second battle character. The second battle character has two modes, that is, hiding based on an environment and hiding based on a capability of the second battle character.

### Hide Based on an Environment

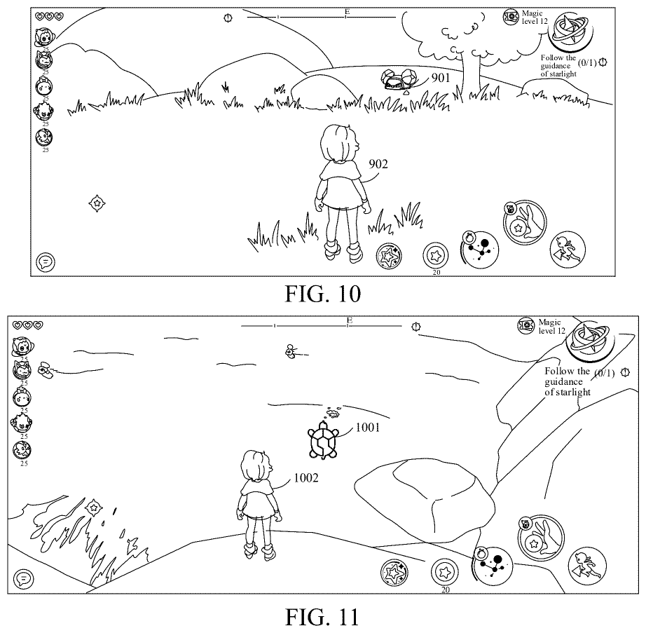

In some examples, as shown in FIG. 10, a second battle character 901 is a battle character of the soil type. After perceiving that a main control virtual character 902 is approaching, the second battle character 901 generates a hiding stress response and enters the hiding behavior mode. The second battle character 901 observes the surrounding situation more vigilantly. The second battle character 901 in the hiding behavior mode may select to wait for an occasion, to search for an appropriate occasion to appear again or perform sneak attack, and attack when the first battle character of the main control virtual character shows vulnerability or is distracted.

In some examples, as shown in FIG. 11, a second battle character 1001 is a battle character of the water type. After perceiving that a main control virtual character 1002 is approaching, the second battle character 1001 generates a hiding stress response and enters the hiding behavior mode. The second battle character 1001 in the hiding behavior mode may have high mobility and flexibility. In the hiding behavior mode, the second battle character 1001 may be better at using a terrain advantage, and select to traverse water, jump, or dodge pursing by using other terrain features, or use accelerated movement, invisibility, transformation, or the like, to increase a hiding capability of the second battle character.

### Hide Based on a Capability

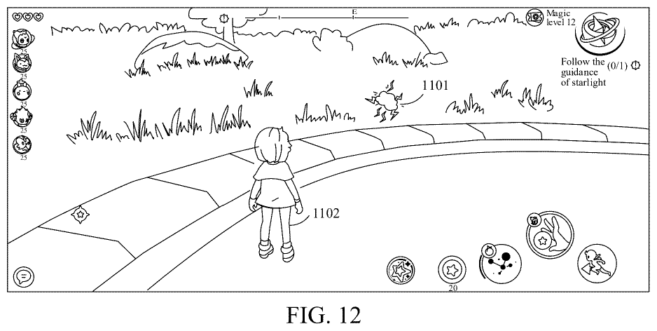

In some examples, as shown in FIG. 12, a second battle character 1101 is a battle character of an electric type. After perceiving that a main control virtual character 1102 approaches, the second battle character 1101 generates a hiding stress response and enters the hiding behavior mode. After the second battle character 1101 in the hiding behavior mode is transformed to lightning, a moving speed of the second battle character may greatly increase. The second battle character 1101 quickly escapes from a battle region by using lightning. In the turn-based battle scene, the second battle character 1101 may use a skill related to electric energy, to release an attack skill such as an electric arc, a lightning storm, or electric energy fluctuation, to disturb the visual field of the main control virtual character 1102 or cause damage.

For example, when the stress response is an alert response and the second battle character perceives the main control virtual character, the second battle character enters the fierce battle mode, and the second battle character sends an alert signal to attract help of another second battle character. When the world scene is switched to the turn-based battle scene, the second battle character in the fierce battle mode may increase a defense capability or call for assisting force, to increase the battle strength of the second battle character.

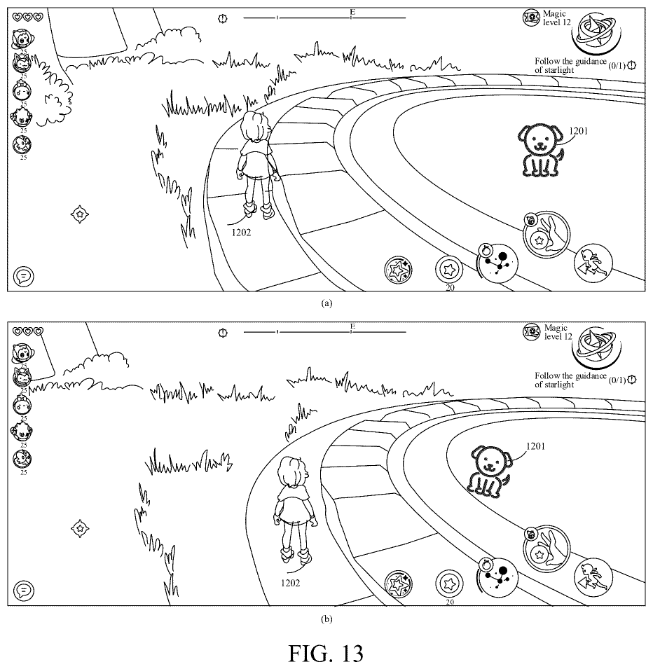

In some examples, as shown in (a) of FIG. 13, a second battle character 1201 is performing a normal patrolling behavior. After perceiving that a main control virtual character 1202 approaches, as shown in (b) of FIG. 13, the second battle character 1201 enters a fierce battle mode and confronts with the main control virtual character 1202. When the world scene is switched to the turn-based battle scene, the second battle character 1201 actively launches an attack more aggressively, and the second battle character 1201 uses a more powerful skill or attack manner to quickly win.

For example, when the stress response is an escape response and the second battle character perceives the main control virtual character, the second battle character enters the escape behavior mode. When the world scene is switched to the turn-based battle scene, the second battle character selects a safer path to escape, or uses an escape skill to increase an escape capability. The second battle character in an escape state may search for a cover object or use an environment to disguise to increase an escape success rate.

Group Behavior Mode (a Behavior Mode of being in a Team or a Tribe):

For example, the second battle character is in a group.

The group behavior mode is a behavior mode in which a second battle character executes a behavior according to a group strategy of an entire team when the second battle character is in the team. The same team may include different types of virtual characters. When a second battle character is in a tribe, the second battle character executes a behavior mode according to a tribe strategy of the entire tribe, and the same tribe includes the same type of virtual character.

For example, when the second battle character is alone, the second battle character enters the escape behavior mode. When the second battle character is in a group, the second battle character battles according to the group battle mode. When the world scene is switched to the turn-based battle scene, second battle characters belonging to the same group may battle in collaboration, and display more powerful skills.

The first battle character is used as an example below.

### Daily Behavior Mode:

The daily behavior of the first battle character is described herein.

The daily behavior mode is a behavior mode executed when the first battle character perceives no perception event in the world scene. In some embodiments, a plurality of AI control strategies are set for the first battle character, where one AI control strategy is used for controlling a behavior of the first battle character when the first battle character perceives no perception event in the world scene.

The daily behavior mode is used to simulate daily living behaviors of the first battle character, such as walking, patrolling, foraging, sleeping, and drinking water.

Environmental Behavior Mode (a Behavior Mode Triggered when a Preset or Specific Environment Element is Perceived):

Herein, perception of an environment element by the first battle character is described.

The environmental behavior mode is a behavior mode executed after the first battle character perceives, in the world scene, a perception event triggered by the environment element. In some examples, the perception event triggered by an environment element is a perception event triggered by a preset or specific environment element.

In some embodiments, a plurality of AI control strategies are set for the first battle character, where one AI control strategy is used for controlling a behavior of the first battle character when the first battle character perceives, in the world scene, a perception event triggered by the environment element.

The environmental behavior mode is a behavior mode triggered by a preset or particular environment element. In some embodiments, the environmental behavior mode is a hiding behavior mode triggered by a preset or particular environment element, that is, under the particular environment element, the first battle character performs an activity according to a behavior mode of hiding the first battle character.

The environmental behavior mode includes at least one of a hiding behavior mode, a disguise behavior mode, a sleep behavior mode, an escape behavior mode, a fierce battle mode, an alert behavior mode, and the like.
Hiding behavior mode: the first battle character adopts a behavior mode of hiding itself, to avoid being perceived or attacked by the second battle character. This may include hiding in a shadow, hiding behind an object, using an invisible skill, or the like.
Disguise behavior mode: the first battle character adopts a behavior mode of disguising itself, to confuse the second battle character. This may include changing a shape of the second battle character to that of another virtual character according to a surrounding environment, or the like.

In some embodiments, the disguise behavior mode may also be considered as one of hiding behavior modes.
Sleep behavior mode: the first battle character enters a sleep state, to reduce activities and restore life values or energy. This behavior mode may be triggered when the first battle character is seriously injured or resources are starved, for example, a hibernation mode.
Escape behavior mode: the first battle character selects to escape from the battle scene, to avoid being defeated. This behavior mode may be triggered when a life value of the first battle character is less than a threshold or faces an adverse situation.
Fierce battle mode: the first battle character presents an extreme attack behavior mode, and attacks the second battle character at all costs. This behavior mode may be triggered when the first battle character is angered or in an extremely dangerous state.
Alert behavior mode: the first battle character is highly vigilant and cautious, to respond to a potential threat. This behavior mode may be automatically activated when the first battle character perceives existence of an enemy battle character or another threat.

The preset or particular environment element includes: at least one of a time period, a weather type, and a terrain attribute. Environmental behavior modes corresponding to different environment elements may be the same or may be different.

In an embodiment, the environmental behavior mode may be further subdivided into a hiding behavior mode, a disguise behavior mode, a sleep behavior mode, an escape behavior mode, a fierce battle mode, and an alert behavior mode. The terminal device determines, from a preconfigured battle capability table according to an obtained ID of a sub-divided behavior mode, a battle capability corresponding to the behavior mode, as the battle capability of the first battle character during the battle in the turn-based battle scene.

In one example, in a case that the environmental behavior mode is a first type environmental behavior mode triggered by a time period, the battle capability of the first battle character during the battle in the turn-based battle scene is determined according to the first environmental behavior mode.

The time period is a subset of all time in the world scene. The time period is represented in a form such as year, season, day and night, or hour in the world scene. In a case that the environmental behavior mode is a first type environmental behavior mode triggered by a time period, the battle capability of the first battle character during the battle in the turn-based battle scene is determined according to the first environmental behavior mode.

For example, the time period is nighttime, and the first battle character is a battle character of a dark attribute. In the nighttime, according to a behavior mode of a night lurking activity, the battle character of the dark attribute has an enhanced visual field at night. In switching from the world scene to the turn-based battle scene, the battle character of the dark attribute obtains a positive gain state of “visual field enhanced”. Therefore, the behavior mode of the night lurking activity reduces a probability that the battle character of the dark attribute is discovered by the second battle character.

In one example, in a case that the first type environmental behavior mode is a hiding behavior mode triggered by a first time period and a battle time belongs to the first time period, the battle capability of the battle character during the battle in the turn-based battle scene is determined according to the hiding behavior mode.

The first time period is a subset of all time in the world scene. The first time period is represented in a form such as year, season, day and night, or hour in the world scene. The battle time changes along with a system time in the world scene.

For example, the first time period is nighttime, and the first battle character is a battle character of the ghost type. In switching from the world scene to the turn-based battle scene, the first battle character enters the hiding behavior mode during the nighttime. When the first battle character battles with the second battle character during the nighttime, a hiding capability of the first battle character is enhanced.

In some embodiments, in a case that the first type environmental behavior mode is the hiding behavior mode triggered by the first time period and the battle time does not belong to the first time period, the battle capability of the battle character during the battle in the turn-based battle scene is determined according to the daily behavior mode or an applicable type environmental behavior mode corresponding to the battle time. In some embodiments, the battle character is in the hiding behavior mode when entering a battle, and in an entire battle process, the battle capability of the battle character may be determined according to the hiding mode.

For example, the first time period is nighttime, and the first battle character is a battle character of the ghost type. In switching from the world scene to the turn-based battle scene, the first battle character enters the hiding behavior mode during the nighttime. When the battle time transitions from the nighttime to the morning time, the first battle character is switched from the hiding behavior mode to the daily behavior mode. When the first battle character battles against the second battle character and the first battle time is the morning time, the battle character of the ghost type cannot be hidden, that is, the battle capability of the first battle character restores to a normal battle capability during the battle with the second battle character.

In one example, in a case that the environmental behavior mode is a second type environmental behavior mode triggered by a weather type, the battle capability of the first battle character during the battle in the turn-based battle scene is determined according to the second environmental behavior mode.

The weather type is a subset of all weather types in the world scene. The weather type includes at least one of: sun, cloud, overcast, rain, snow, thunder, hail, floating dust, sand, sandstorm, wind, and haze. In the case that the environmental behavior mode is the second type environmental behavior mode triggered by the weather type, the battle capability of the first battle character during the battle in the turn-based battle scene is determined according to the second environmental behavior mode.

For example, the weather type is rain, and the first battle character is a battle character of a water type. In a non-rainy day, the battle character of the water type is hidden in water for an activity. In a rainy day, the battle character of the water type leaves water for an activity. In a rainy day, the battle capability of the battle character of the water type is greatly enhanced. When the battle character of the water type battles with the second battle character, and the world scene is switched to the turn-based battle scene, the battle character of the water type enters a fierce battle mode. The battle capability of the battle character of the water type may be enhanced, for example, an attack capability and a hit rate are improved.

In one example, in a case that the second type environmental behavior mode is a hiding behavior mode triggered by a first weather type and a current weather type belongs to the first weather type, the battle capability of the battle character during the battle in the turn-based battle scene is determined according to the hiding behavior mode.

The first weather type is a subset of all weather types in the world scene. The first weather type includes at least one of: sun, cloud, overcast, rain, snow, thunder, hail, floating dust, sand, sandstorm, wind, and haze. The current weather type changes along with a system time in the world scene, or the current weather type is triggered by a skill of the battle character to change.

For example, the first weather type is rain, and the first battle character is a battle character of a rain type. When the first weather type is rain, in switching from the world scene to the turn-based battle scene, the first battle character enters a hiding behavior mode, and the first battle character battles with the second battle character in the rainy day. The battle character of the rain type can apply an invisible skill, and a hiding capability of the first battle character is enhanced.

In some embodiments, in a case that the second type environmental behavior mode is the hiding behavior mode triggered by the first weather type and the current weather type does not belong to the first weather type, the battle capability of the battle character during the battle in the turn-based battle scene is determined according to the daily behavior mode or an applicable type environmental behavior mode corresponding to the current weather type. In some embodiments, the battle character is in the hiding behavior mode when entering a battle, and in an entire battle process, the battle capability of the battle character may be determined according to the hiding mode.

For example, the first weather type is rainy, and the first battle character is a battle character of a rain type. When the world scene is switched to the turn-based battle scene, the first battle character battles with the second battle character, and the first battle character enters a hiding behavior mode in rain. During the battle, when the current weather type changes from rainy to sunny, the first battle character is switched from the hiding behavior mode to a daily behavior mode. When the first weather type is sunny, the battle character of the rain type cannot apply an invisible skill, and a battle capability of the first battle character restores to a normal battle capability during the battle with the second battle character.

In one example, in a case that the environmental behavior mode is a third type environmental behavior mode triggered by a terrain attribute, the battle capability of the first battle character during the battle in the turn-based battle scene is determined according to the third environmental behavior mode.

The terrain attribute is a subset of all terrain attributes in the world scene, and the terrain attribute includes at least one of the following types: lake, river, mountain, grassland, soil, flame, ice, desert, forest, and sandstone. In the case that the environmental behavior mode is the third type environmental behavior mode triggered by the terrain attribute, the battle capability of the first battle character during the battle in the turn-based battle scene is determined according to the third environmental behavior mode.

For example, the terrain attribute is grassland, and the first battle character is a battle character of a plant type. When the first battle character is located in a grassland, the battle character of the plant type is transformed to a plant such as a grass or a flower. In this case, the first battle character enters a disguise behavior mode. When the world scene is switched to the turn-based battle scene, the battle character of the plant type may obtain a stronger hiding capability in the disguise behavior mode, making it more difficult to be detected or attacked by the second combat character.

In one example, in a case that the third type environmental behavior mode is a hiding behavior mode triggered by a first terrain attribute and a location of the battle character belongs to the first terrain attribute, the battle capability of the battle character during the battle in the turn-based battle scene is determined according to the hiding behavior mode.

The first terrain attribute is a subset of all terrain attributes in the world scene, and the first terrain attribute includes at least one of the following types: lake, river, mountain, grassland, soil, flame, ice, desert, forest, and sandstone. The location of the battle character dynamically changes during the battle in the turn-based battle scene.

For example, the first terrain attribute is soil, and the first battle character is a battle character of a soil type. When the world scene is switched to the turn-based battle scene, the first battle character battles with the second battle character on soil. The battle character of the soil type enters a hiding behavior mode, the battle character of the soil type can apply a skill of walking through the ground, and the battle capability of the first battle character is enhanced during the battle in the turn-based battle scene.

In some embodiments, in a case that the third type environmental behavior mode is the hiding behavior mode triggered by the first terrain attribute and the location of the battle character does not belong to the first terrain attribute, the battle capability of the battle character during the battle in the turn-based battle scene is determined according to the daily behavior mode or an applicable type environmental behavior mode corresponding to a terrain attribute of the location of the battle character. In some embodiments, the battle character is in the hiding behavior mode when entering a battle, and in an entire battle process, the battle capability of the battle character may be determined according to the hiding mode.

For example, the first terrain attribute is river, and the first battle character is a battle character of a water type. When the world scene is switched to the turn-based battle scene, the first battle character battles with the second battle character in a river, and the first battle character enters a hiding behavior mode. During the battle, locations of the first battle character and the second battle character change. When the first terrain attribute changes from river to soil, the first battle character is switched from the hiding behavior mode to the daily behavior mode. Alternatively, the second battle character releases a freezing skill against the first battle character, the location of the first battle character changes from river to ice, and the first battle character is also switched from the hiding behavior mode to the daily behavior mode. The battle character of the water type cannot apply the hidden skill, and the battle capability of the first battle character restores to a normal battle capability during the battle with the second battle character.

### Sneak Attack Behavior Mode:

Herein, that the first battle character ambushes the second battle character is described.

The sneak attack behavior mode is a behavior mode for ambush. In some embodiments, the sneak attack behavior mode is a behavior mode in which the main control virtual character controls the first battle character to ambush the second battle character.

The sneak attack behavior mode is a battle strategy, and aims to obtain an advantage by ambushing the second battle character. In the sneak attack behavior mode, the first battle character approaches the second battle character in a secret and concealing manner, and attacks before the second battle character perceives this.

In a possible implementation, the first battle character may select to take a concealing action before a battle starts, to avoid as much as possible being perceived by the second battle character. This may include hiding in a shadow, using an invisible skill, selecting an appropriate tactical location, or the like. Once the second battle character enters an attack range of the first battle character, the first battle character may select to raid the second battle character rapidly with high damage, including attacking by using powerful skills, storm assault, or vulnerabilities of the second battle character.

In an embodiment, in the sneak attack behavior mode, it is inappropriate for the first battle character to battle with the second battle character head-on for a long time. Once a sneak attack action is completed or an accident occurs, the first battle character may select to quickly exit the battle scene, to avoid being counter-attacked by the second battle character or being discovered by another second battle character. In some embodiments, the first battle character may use an environment element in the battle scene to intensify sneak attack, for example, use a bunker to ambush, or use a trap or an environmental object to damage the second battle character.

In an embodiment, when the first battle character enters the sneak attack behavior mode and successfully defeats the second battle character, the main control virtual character may aim at the second battle character by using a container prop, and throw the container prop towards the second battle character to attempt to capture the second battle character, so that the second battle character becomes a first battle character.

In the various behavior modes of the battle character in the foregoing embodiments, the determining a battle capability of the battle character during a battle in a turn-based battle scene includes at least one of the following:
Add, to the battle character, a positive gain state (also referred to as buff) or a negative gain state (also referred to as debuff) corresponding to the behavior mode.

In an embodiment, the positive gain state or the negative gain state is added to the battle character according to the behavior mode of the battle character. The gain state may increase or decrease an attribute, a skill effect, or a battle capability of the battle character.

The positive gain state refers to an advantageous effect exerted on the battle character, and may improve the battle capability of the battle character, at least including enhancing attributes of the battle character such as an attack capability, a defense capability, and a speed, or providing an additional skill effect such as restoring a life value or increasing a damage output, or enhancing the battle capability of the battle character. The positive gain state may make the battle character more advantageous in battle, and the positive gain state improves the battle capability of the battle character.

For example, the battle character is the second battle character. In a time period of night, the second battle character is a battle character of a dark attribute. In the time period of night, the second battle character enters the hiding behavior mode. When the world scene is switched to the turn-based battle scene, because the second battle character enters the hiding behavior mode in the world scene, the second battle character obtains a positive gain state of a hidden behavior in the turn-based battle, that is, the battle capability of the second battle character in the turn-based battle is improved. For example, the second battle character obtains an additional dodging capability in the turn-based battle.

The negative gain state refers to an adverse effect exerted on the battle character, and may weaken the battle capability of the battle character, at least including weakening attributes of the battle character such as an attack capability, a defense capability, and a speed, or limiting a movement capability of the battle character. The negative gain state may cause the battle character to be disadvantageous in a battle, and the negative gain state reduces the battle capability of the battle character.

For example, the second battle character is a battle character of the fire type and the first battle character is a battle character of the water type. When the second battle character encounters the first battle character, the second battle character enters the escape behavior mode. When the world scene is switched to the turn-based battle scene, the second battle character obtains the negative gain state, and an attack capability of the second battle character is reduced.

In an embodiment, positive gain state information and negative gain state information are transmitted, through an explicit special effect and action when the turn-based battle starts, to the player corresponding to the main control virtual character, and a corresponding icon is newly added to a gain state region, so that the player corresponding to the main control virtual character can view detailed prompt information after click. The player corresponding to the main control virtual character may learn, through a special effect and an action, an effect of the positive gain state or the negative gain state caused by a behavior mode of the battle character in the large world before entering the turn-based battle. In an embodiment, corresponding icons are newly added to a positive gain state region of the user interface, and the player corresponding to the main control virtual character may tap/click on these icons to view detailed prompt information, to understand information such as a specific effect and a duration.

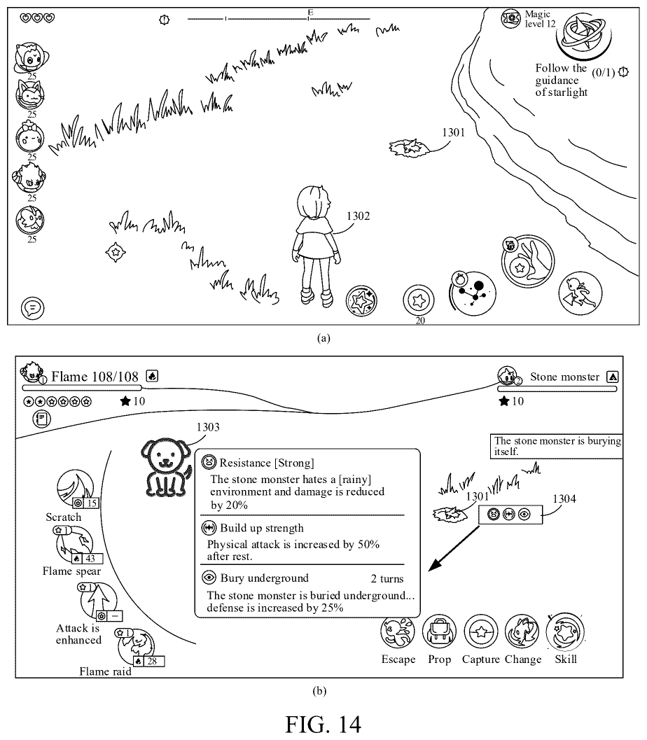

In some examples, as shown in (a) of FIG. 14, the terrain attribute is soil, and a second battle character 1301 is a battle character of a soil type. When perceiving that a main control virtual character 1302 appears, the second battle character 1301 triggers the hiding behavior mode to hide underground. When the turn-based battle scene is entered, as shown in (b) of FIG. 14, the main control virtual character 1302 releases a first battle character 1303 to battle with the second battle character 1301, a “buried” positive gain state is added to the second battle character 1301, and the second battle character 1301 may accumulate strength underground, to obtain an additional attack bonus in a next attack. The positive gain state of the second battle character 1301 may be presented by using an icon 1304. A player may tap/click on the icon 1304 to view detailed prompt information, and learn that the second battle character 1301 is in the hiding behavior mode of hiding underground and obtains a corresponding enhanced capability. The player may select a skill and tactic for the first battle character 1303 by viewing the prompt information of the second battle character 1301, to overcome the enhanced capability obtained by the second battle character 1301 due to the terrain attribute.
Change battle logic of the battle character to battle logic corresponding to the behavior mode.

The battle logic is control logic that controls a battle character to take action in a battle of a game. The battle logic is logic used by AI to control a battle character during a battle. AI may refer to an automatic algorithm having an artificial intelligence capability, such as an AI model, a behavior tree, and a decision tree.

In an embodiment, the battle character has different battle logic, such as an offensive type, a defensive type, an escape type, and a sneak attack type. Each battle logic has different features and strategies. By changing the battle logic, the battle character better presents features and strategies of a corresponding behavior mode in a turn-based battle.

For example, the battle logic of the second battle character is the attack type, and the second battle character is more inclined to use an attack skill in a turn-based battle to cause more damage to the first battle character, which includes selecting a skill with a high attack capability, preferentially attacking a vulnerability of the first battle character, or using a continuous attack skill. For another example, the battle logic of the second battle character is the defensive type, and the second battle character is more inclined to use a defense skill in a turn-based battle to improve a defense capability of the second battle character, which includes selecting a skill with a high defense capability, preferentially protecting a teammate, or using a counter-attack skill. For another example, the battle logic of the second battle character is the escape type. In a turn-based battle, the second battle character is more inclined to preferentially use an escape skill to escape when the battle status worsens.

In some embodiments, the main control virtual character controls only some behaviors of the first battle character, and other behaviors are controlled by AI control logic. Therefore, the AI control logic may change the battle logic of the first battle character according to the behavior mode of the first battle character, so that the first battle character can better utilize respective features and strategies in the battle. The first battle character may adjust battle logic of the first battle character according to a current status and an influencing factor. In some embodiments, the second battle character is completely controlled by the AI control logic. Therefore, the AI control logic may change the battle logic of the second battle character according to the behavior mode of the second battle character.

For example, if the second battle character perceives that the first battle character has a high attack capability, the second battle character may preferentially select a defense or recovery skill to protect the second battle character. Alternatively, if the second battle character perceives that the second battle character is in a disadvantage status, the second battle character may select to escape or seek help.
Control the battle character to use, during the battle, an exclusive skill corresponding to the behavior mode.

The exclusive skill is a set of skills corresponding to a current behavior mode of the battle character. Alternatively, the exclusive skill is a skill allowed only in a current behavior mode. The exclusive skill can better utilize a feature and an advantage of the battle character. In an embodiment, different behavior modes may correspond to different exclusive skills.

For example, the second battle character is a battle character of a dark attribute. At night, the second battle character may use an invisible skill so that it is difficult for the first battle character to perceive in a turn-based battle, thereby improving a dodging rate of the second battle character or reducing a hit rate of the first battle character. For another example, the second battle character is a battle character of a water type attribute. In a river, the second battle character can quickly disappear from a turn-based battle by using a stealth escape skill, thereby improving a success rate of escape.

### Mechanism for Switching Between Different Behavior Modes

In some embodiments, the method further includes the following operations:
controlling the battle character to switch between at least two behavior modes.

The at least two behavior modes include at least one of a daily behavior mode, an environmental behavior mode, a perceptual behavior mode, a group behavior mode, and a sneak attack behavior mode.

In some embodiments, the controlling a battle character to switch between at least two behavior modes includes at least one of the following:
switching from the daily behavior mode to the environmental behavior mode in a case that the battle character perceives, in the world scene, the perception event triggered by the environment element.

A perception event triggered by an environment element is a perception event triggered by factors other than the main control virtual character. The environment element includes: at least one of a time period, a weather type, and a terrain attribute.

The daily behavior mode is a behavior mode executed when the battle character perceives no perception event in the world scene. The environmental behavior mode is a behavior mode triggered by an environment element.

In some embodiments, when the battle character perceives, in the world scene, a perception event triggered by an environment element, that is, the battle character perceives some environment changes, the battle character is switched from the daily behavior mode to the environmental behavior mode, and the battle character correspondingly adjusts a behavior according to triggering of the environment element.

For example, the battle character is a battle character of a meteor type. The battle character of the meteor type falls together with a meteor only in dusk time, and does not appear in other time. In a non-dusk time, the battle character is in a sleep state or an inactive state, and does not perform any activity. When a time is a dusk time, the battle character falls together with the meteor, flies in the air, or the like. The battle character is switched from the daily behavior mode into the environmental behavior mode.
switching from the environmental behavior mode to the daily behavior mode in a case that the environment element disappears or a duration after the disappearing reaches a first duration.

The first duration refers to a period of time calculated since the environment element disappears. The first duration may be a fixed time interval, or may be determined according to a specific case.

In an embodiment, when the environment element no longer exists or disappears after a period of time, the battle character is switched from the environmental behavior mode back to the daily behavior mode. When triggered by a particular environment element, the battle character presents a behavior related to the environment element, but once the environment element no longer exists or after a period of time, the battle character restores to a common daily behavior.

For example, the battle character is a battle character of a meteor type. When a time period is a dusk time, the battle character falls together with a meteor, and is switched from the daily behavior mode to the environmental behavior mode. After the dusk time passes or a time since the dusk time passes reaches a time interval, the battle character is switched from the environmental behavior mode to the daily behavior mode, that is, the battle character is in a sleep state or an inactive state again and performs no activity.
switching from the environmental behavior mode to the daily behavior mode in a case that a duration of the environmental behavior mode reaches a second duration.

The second duration is a duration in which the battle character is in the environmental behavior mode. The second duration may be a fixed time interval, or may be determined according to a specific case.

In some embodiments, when a duration of the environmental behavior mode reaches the second duration, the battle character is switched from the environmental behavior mode back to the daily behavior mode.
switching from the daily behavior mode to the perceptual behavior mode in a case that the battle character perceives an enemy virtual character in the world scene;

The perceptual behavior mode is a behavior mode executed after the battle character perceives, in the world scene, a perception event triggered by an enemy virtual character.

The enemy battle character is used as an example. The perceptual behavior mode is a behavior mode executed after the second battle character perceives, in the world scene, a perception event triggered by the main control virtual character.

For example, the second battle character is a battle character of a fire type, and the first battle character is a battle character of a water type. In the daily behavior mode, the second battle character performs a normal activity, such as walks and explores an environment. After the second battle character perceives the first battle character, the second battle character enters the escape behavior mode, and increases a moving speed to leave an attack range of the first battle character as soon as possible, to reduce a risk of being damaged.
switching from the perceptual behavior mode to the daily behavior mode in a case that the perception event disappears or a duration after the disappearing reaches a third duration.

The third duration refers to a period of time calculated since the perception event disappears. The third duration may be a fixed time interval, or may be determined according to a specific case.

In an embodiment, when the perception event no longer exists or disappears after a period of time, the battle character is switched from the perceptual behavior mode back to the daily behavior mode. When triggered by a perception event, the battle character performs a behavior related to the perception event, but once the perception event no longer exists or after a period of time, the battle character restores to a common daily behavior.

For example, the second battle character is a battle character of a fire type, and the first battle character is a battle character of a water type. After the second battle character perceives the first battle character, the second battle character triggers the escape behavior mode, that is, is switched from the daily behavior mode to the perceptual behavior mode. After the second battle character escapes from a perception range of the first battle character, or after a time interval since escaping from the perception range, the second battle character is switched from the perceptual behavior mode to the daily behavior mode, that is, the second battle character performs a normal activity such as walks or explores an environment.
switching from the perceptual behavior mode to the daily behavior mode in a case that a duration of the perceptual behavior mode reaches a fourth duration.

The fourth duration is a duration in which the battle character is in the perceptual behavior mode. The fourth duration may be a fixed time interval, or may be determined according to a specific case.

In some embodiments, when a duration of the perceptual behavior mode reaches the fourth duration, the battle character is switched from the perceptual behavior mode back to the daily behavior mode.

For example, the second battle character is a battle character of a fire type, and the first battle character is a battle character of a water type. After entering the escape behavior mode, the second battle character accelerates movement to leave the attack range of the first battle character as soon as possible. After the escape behavior mode lasts for a period of time, the second battle character leaves the escape behavior mode and enters the daily behavior mode again.
switching from the daily behavior mode to the group behavior mode in a case that the battle character is in a team or a tribe.

The group behavior mode is a behavior mode in which a battle character executes a behavior according to a group strategy of an entire team when the battle character is in the team. The same team may include different types of virtual characters. When a battle character is in a tribe, the battle character executes a behavior mode according to a tribe strategy of the entire tribe, and the same tribe includes the same type of virtual character.

For example, the battle character is the second battle character. The second battle character is a battle character of an animal type. In the daily behavior mode, the second battle character independently forages and patrols territories. When the second battle character is in a tribe, the second battle character is switched from the daily behavior mode to the group behavior mode. The second battle character forages and protects territories in cooperation with other virtual characters in the tribe. During foraging, the tribe captures a prey cooperatively and each character acts as a different role, to further foraging success.
switching from the group behavior mode to the daily behavior mode in a case that the battle character leaves the team or the tribe.

In some embodiments, when a battle character is in a team or a tribe, the battle character performs an activity according to a behavior rule and a strategy of the entire team or tribe, and the battle character cooperates with other virtual characters in the team or the tribe, to perform group activities. Once a battle character leaves an original team or tribe, the battle character is switched from the group behavior mode back to the daily behavior mode. In this case, the battle character presents personal features again, for example, independently performs an activity or forages.
switching from the daily behavior mode to the sneak attack behavior mode in a case that the battle character receives a lurking command or a lurking triggering event.

The sneak attack behavior mode is a behavior mode for ambush. In some embodiments, the sneak attack behavior mode is a behavior mode in which the main control virtual character controls the first battle character to ambush the second battle character.

Lurking commands or lurking triggering events are instructions or events received by the battle character, and an objective of the commands or events is to enable the battle character to enter a lurking state and prepare to ambush, to perform sneak attack on an enemy virtual character.

For example, the battle character is the first battle character, and the first battle character performs sneak attack on the second battle character when receiving a lurking command from the main control virtual character. The first battle character is a battle character of an animal type, and the second battle character is a battle character of a plant type. After the main control virtual character delivers a lurking command to the first battle character, the first battle character is switched from the daily behavior mode to the sneak attack behavior mode. In the sneak attack behavior mode, the first battle character starts to move quietly, hides a figure, and waits for a suitable occasion to attack the second battle character to achieve sneak attack.
switching from the sneak attack behavior mode to the daily behavior mode in a case that a duration of the sneak attack behavior mode reaches a fifth duration.

The fifth duration is a duration in which the battle character is in the sneak attack behavior mode. The fifth duration may be a fixed time interval, or may be determined according to a specific case.

In some embodiments, when a duration of the sneak attack behavior mode reaches the fifth duration, the battle character is switched from the sneak attack behavior mode back to the daily behavior mode.

For example, the first battle character performs sneak attack on the second battle character. In the sneak attack behavior mode, the first battle character quietly approaches the second battle character, and waits for a suitable occasion to attack the second battle character. When a duration of the sneak attack behavior mode reaches a time interval, the first battle character ends the sneak attack behavior mode and returns to the daily behavior mode.
switching from the sneak attack behavior mode to the daily behavior mode in a case that the battle character is discovered during lurking and sneak attack.

For example, the first battle character performs sneak attack on the second battle character. In the sneak attack behavior mode, the first battle character quietly approaches the second battle character, and waits for a suitable occasion to attack the second battle character. In a process in which the first battle character approaches the second battle character, the second battle character discovers the first battle character and performs a corresponding defense behavior, and the first battle character abandons the attack and is switched from the sneak attack behavior mode to the daily behavior mode.

In an embodiment, the battle character may be switched between any two behavior modes. In some embodiments, switching between at least two behavior modes is performed based on a state machine.

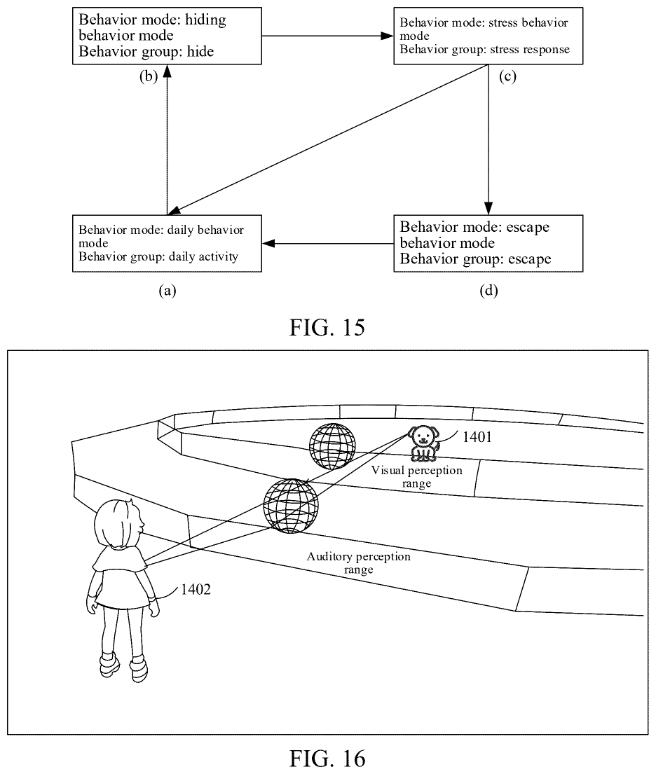

In some examples, as shown in (a) of FIG. 15, a battle character is initially in the daily behavior mode and performs a normal daily activity in the daily behavior mode. When the battle character perceives a perception event triggered by an environment element, as shown in (b) of FIG. 15, the battle character is switched to the hiding behavior mode (an environmental behavior mode). For example, a battle character of a ghost type enters the hiding behavior mode at night, and the battle character performs a hiding behavior in the hiding behavior mode. After the battle character perceives a perception event triggered by an enemy virtual character, as shown in (c) in FIG. 15, the battle character is switched to a stress behavior mode (a perceptual behavior mode). For example, after perceiving a battle character of a fire type, a battle character of a water type generates a stress response, to enter the stress behavior mode. When the battle character perceives a danger, as shown in (d) in FIG. 15, the battle character enters the escape behavior mode. For example, when perceiving that there is a battle character of a fire type nearby, a battle character of a wood type enters the escape behavior mode to select to escape, and when the escape behavior mode of the battle character reaches a preset duration, restores to the daily behavior mode.

The state machine shown in FIG. 15 is merely an example for description. In different embodiments, due to various behavior modes and various state switching conditions, the state machine may be changed as appropriate.

### Perception Mechanism

A perception mechanism of the second battle character is used as an example herein. Perception mechanisms of the first battle character are the same or similar. In some embodiments, the method further includes the following operation:
controlling, in a case that a perception event occurs within a perception range with the battle character as the center, the battle character to perceive the perception event according to a perception probability.

The perception range includes at least one of an auditory perception range and a visual perception range, and the perception probability is related to an angle and/or a distance of the perception event relative to the battle character. The perception probability is a probability indicating whether the battle character can perceive a perception event within a perception range. Further, the perception probability is a probability that the second battle character perceives the first battle character when the first battle character is within a perception range of the second battle character. Alternatively, the perception probability is a probability that the first battle character perceives the second battle character when the second battle character is within a perception range of the first battle character.

For example, the battle character is the second battle character. The perception event is an event triggered by the main control virtual character and/or the first battle character.

In some embodiments, a range is obtained by using the second battle character as the center and a preset length as a radius. The range is a perception range of the second battle character. When a perception event occurs in the perception range with the second battle character as the center, a degree of perceiving the perception event by the second battle character may be controlled by using the perception probability.

The auditory perception range is a range in which the second battle character perceives a surrounding environment through hearing. In a game, the auditory perception range is usually implemented by simulating an auditory range of the second battle character. The auditory perception range may be a circular region, an elliptic region, or a sectoral region. With the second battle character as the center, a sound hearing distance of the second battle character depends on the radius (of a circular shape) or the long axis (of an ellipse shape).

The visual perception range is a range in which the second battle character perceives a surrounding environment visually. In a game, the visual perception range is usually implemented by simulating a visual field range of the second battle character. The visual perception range may be a circular region, an elliptic region, or a sectoral region. With the second battle character as the center, a visual range of the second battle character depends on an angle. In addition, the visual field of the second battle character may be limited by a visual field radius.

In an embodiment, the auditory perception range and the visual perception range may be the same perception range, or may be different perception ranges. For example, the auditory perception range is greater than the visual perception range, or the visual perception range is greater than the auditory perception range, or the auditory perception range is equal to the visual perception range. This is not limited in this disclosure.

In a possible implementation, for example, the perception probability is related to both an angle and a distance of the perception event relative to the second battle character.

When the perception event occurs, the second battle character calculates a perception probability according to an angle and a distance between a detection object and the second battle character within the perception range. The detection object may be the main control virtual character or the first battle character.

Angle: A detection object is located right in front of the second battle character and the second battle character perceives this detection object at a first perception probability. A detection object is located at another angle of the second battle character and the second battle character perceives this detection object at a second perception probability. The probability that the second battle character perceives the detection object located right in front is greater than the probability that the second battle character perceives the detection object located at the another angle, that is, the first perception probability is greater than the second perception probability.

Distance: As a detection object is closer to the second battle character, there is a higher perception probability that the second battle character perceives this detection object.

For example, when the main control virtual character enters the perception range of the second battle character and the main control virtual character is located in front of the second battle character, the second battle character is more likely to perceive the main control virtual character. Similarly, if the main control virtual character is closer to the second battle character, the probability that the second battle character perceives the main control virtual character may also be increased.

In some embodiments, when the main control virtual character or the first battle character enters the perception range of the second battle character, a distance between the main control virtual character or the first battle character and the second battle character and an angle of the main control virtual character or the first battle character relative to the second battle character are detected, and a probability that the second battle character perceives the main control virtual character or the first battle character is calculated according to the distance and the angle.

In a possible implementation, when the second battle character perceives the perception event according to the perception probability, the second battle character switches the behavior mode. For example, the second battle character may switch from the daily behavior mode to the perceptual behavior mode. For example, the second battle character triggers a stress behavior mode, a hiding behavior mode, an escape behavior mode, a fierce battle behavior mode, and the like. The second battle character performs a corresponding behavior, for example, prepares for attack, escapes, or enhances a defense capability.

In some examples, as shown in FIG. 16, a visual perception range and an auditory perception range are created with a second battle character 1401 as the center. When a main control virtual character 1402 approaches the second battle character, a perception probability is calculated according to a distance and an angle between the main control virtual character 1402 and the second battle character. The perception probability is a probability that the second battle character 1401 perceives the main control virtual character 1402. When perceiving the main control virtual character or the first battle character according to the perception probability, the second battle character 1401 switches the behavior mode.

In some examples, assuming that the perception probability is 80%, 1 random number ranging from 0 to 100 is generated by using a pseudo-random algorithm. When the value of the random number is less than 80, it is considered that the main control virtual character 1402 is perceived. When the value of the random number is equal to or greater than 80, it is considered that the main control virtual character 1402 is not perceived.

### Second Branch:

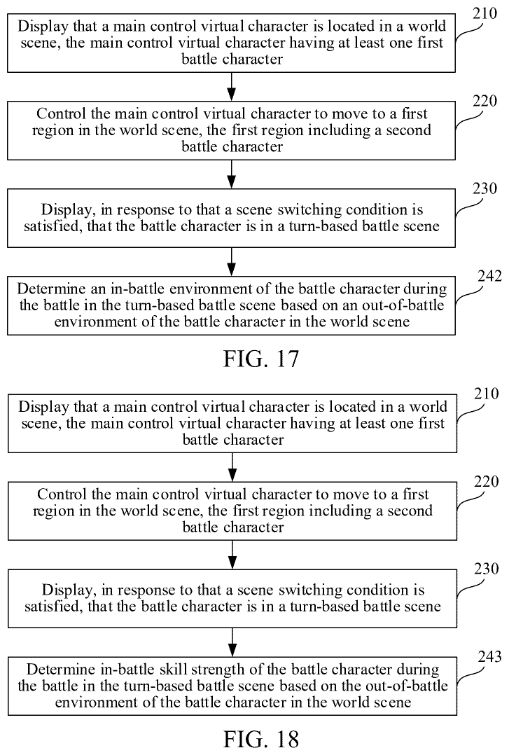

In FIG. 17, the operation 240 may include the following sub-operation 242:

Operation 242: Determine an in-battle environment of the battle character during the battle in the turn-based battle scene based on an out-of-battle environment of the battle character in the world scene.

In some embodiments, in response to that the scene switching condition is satisfied, a user interface is switched from displaying the world map to displaying the battle map, that is, switched from an out-of-battle environment in the world scene to an in-battle environment in the turn-based battle scene. The scene switching condition is used to trigger switching from the world scene to the turn-based battle scene.
Before switching to the turn-based battle scene, an in-battle environment of the battle character during the battle in the turn-based battle scene is determined based on an out-of-battle environment of the battle character in the world scene.

The out-of-battle environment includes at least one of weather, time, and terrain. The out-of-battle environment may be changed due to at least one of the main control virtual character, the first battle character, and the second battle character.

For example, the out-of-battle environment is a land parcel of a water attribute, but after the main control virtual character releases a skill or triggers a mechanism, the land parcel of the water attribute may be changed into the land parcel of an ice attribute. In this case, the turn-based battle scene is switched to, and the in-battle environment in which the battle character battles in the turn-based battle scene also has the ice attribute.
During a turn-based battle, when the out-of-battle environment changes due to a reason other than the turn-based battle, an environment element of the in-battle environment is synchronously changed.

That is, the environment element of the in-battle environment changes as the environment element of the out-of-battle environment changes. In an embodiment, the reason other than the turn-based battle is a reason not related to the turn-based battle, that is, an event that changes an environment element in the out-of-battle environment.

In an embodiment, when an i^{th} environment element of the out-of-battle environment changes, a j^{th} environment element of the in-battle environment changes. The i^{th} environment element is any one of a weather case, a day or night case, and a terrain. The j^{th} environment element is any one of a weather case, a day or night case, and a terrain, where i and j are both positive integers.

In some examples, the first battle character and the second battle character are performing a turn-based battle. During the battle, the out-of-battle environment changes from originally sunny to rainy, and the weather case of the in-battle environment also changes from sunny to rainy. In some examples, when the out-of-battle environment changes from originally sunny to rainy, a land parcel in the in-battle environment is originally in a burning state, and then flames in the in-battle environment are extinguished and an original terrain of “flaming” is changed to grassland.

In some examples, the first battle character and the second battle character are performing a turn-based battle. During the battle, the out-of-battle environment changes from original day to night, and a time of the in-battle environment also changes to night.

During the turn-based battle, environment elements of the out-of-battle environment and the in-battle environment keep synchronized, thereby further eliminating a difference between the world scene and the turn-based battle scene.

In an embodiment, the terminal device detects weather data, time data, and terrain data in the world scene in real time, synchronously updates weather data in the turn-based battle scene to the weather data in the world scene, synchronously updates time data in the turn-based battle scene to the time data in the world scene, and synchronously updates terrain data in the turn-based battle scene to the terrain data in the world scene.

### Third Branch:

In FIG. 18, the operation 240 may include the following sub-operation 243:
Operation 243: Determine in-battle skill strength of the battle character during the battle in the turn-based battle scene based on the out-of-battle environment of the battle character in the world scene.

In an embodiment, a skill control is displayed in the turn-based battle scene. In response to that the skill control receives a trigger operation, the battle character is controlled to release an in-battle skill in the turn-based battle scene.

In some embodiments, basic skill strength of the battle character in the turn-based battle scene is determined according to an attribute of the battle character. Final skill strength, that is, in-battle skill strength, of the battle character in the turn-based battle scene is determined according to impact of the out-of-battle environment on the battle character. The in-battle skill strength is equal to a sum of the basic skill strength and an adjustment value, and the adjustment value is associated with at least one environment element in the out-of-battle environment.

In some embodiments, a visual effect of the in-battle skill of the battle character is obtained by integrating an environment element of the out-of-battle environment and a skill attribute of the battle character.

For example, the out-of-battle environment is a fire environment (a terrain is fire) and the battle character has a wind skill. In this case, in the fire environment, the battle character releases a skill “flaming tornado” integrating the wind attribute and the fire attribute. For example, the out-of-battle environment is a water environment (the terrain is water stream) and the battle character has a light skill. In this case, in the water environment, the battle character releases a skill integrating the light attribute and the water attribute, and the integrated skill has a visual effect of “glistening water”.

In an embodiment, a visual effect of the in-battle skill is obtained by integrating an environment element of a land parcel of the battle character and a skill attribute of the battle character.

For example, the first battle character releases a skill against the second battle character.

For example, a land parcel of the second battle character is a fire land parcel (a terrain is fire) and the first battle character has a wind skill. In this case, an in-battle skill released by the first battle character is represented as “flaming tornado”.

For another example, it rains in the land parcel of the second battle character (the weather condition is rainy) and the first battle character has a wind skill. In this case, an in-battle skill released by the first battle character is represented as “water tornado”.

For another example, a land parcel of the second battle character is a water land parcel (a terrain is water stream) and the first battle character has a light skill. An in-battle skill released by the first battle character is represented as a visual effect of “glistening water”.

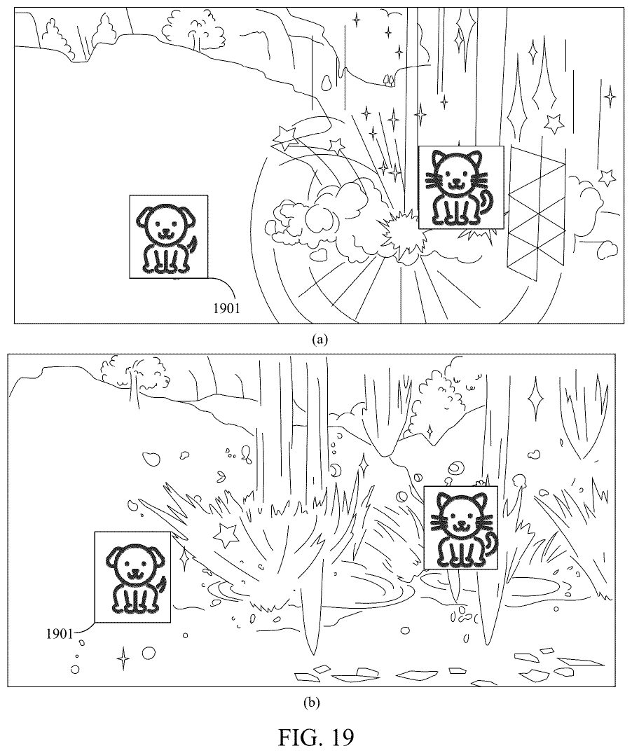

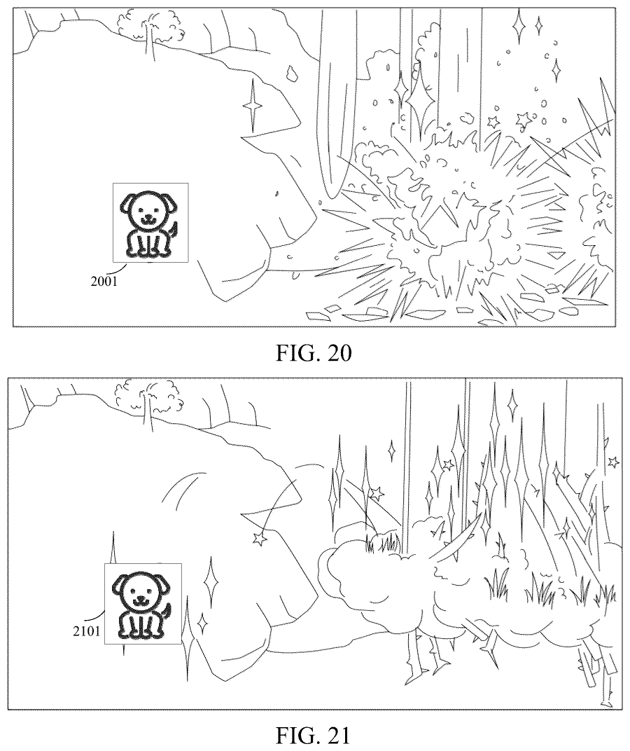

In some examples, (a) in FIG. 19 shows a basic skill (the light skill) of a battle character 1901, and (b) in FIG. 19 shows an in-battle skill of the battle character 1901. A land parcel of an enemy battle character is a water land parcel, and a user interface displays a visual effect of “glistening water”. FIG. 20 shows an in-battle skill of a battle character 2001, a land parcel of an enemy battle character is a fire land parcel, and a user interface displays a visual effect of “radiant flame”. FIG. 21 shows an in-battle skill of a battle character 2101, a land parcel of an enemy battle character is a grassland (a terrain is grass), and a user interface displays a visual effect of “growing grass”.

In an embodiment, skill strength of the integrated in-battle skill is greater than skill strength of the basic skill, and/or a skill effect of the integrated in-battle skill is better than a skill effect of the basic skill.

For example, skill strength of the in-battle skill of “flaming tornado” is greater than skill strength of the wind skill of the battle character. Compared with the wind skill of the battle character, the “flaming tornado” additionally has burning impact. For another example, skill strength of the in-battle skill of “glistening water” is greater than skill strength of the light skill of the battle character. Compared with the light skill of the battle character, the “glistening water” additionally has obstructing impact.

In some embodiments, at least one of skill strength, a skill effect, and a visual effect of the in-battle skill of the battle character is associated with at least two environment elements of the out-of-battle environment.

The out-of-battle environment corresponds to at least two environment elements. The environment elements include a weather status, a day or night condition (or time), a terrain, a temperature status, and the like.

For example, the in-battle skill is a fire skill and the world scene is a forest environment (a terrain is forest). In this case, skill strength (power), a skill effect (a fume effect), and a visual effect (a flame size) of the in-battle skill, that is, the fire skill in the forest environment are obviously enhanced.

In some embodiments, skill strength and/or a skill effect of an in-battle skill of a battle character is associated with an emotional state of the battle character for the out-of-battle environment. The emotional state is determined based on at least two environment elements.

For example, the out-of-battle environment is a grass environment, and the battle character likes grassland. In this case, in the grass environment, strength of an in-battle skill released by the battle character is enhanced, and the skill has an additional binding effect. For example, it is raining in the out-of-battle environment, and the battle character hates rain. In this case, in the rainy environment, strength of the in-battle skill released by the battle character is reduced.

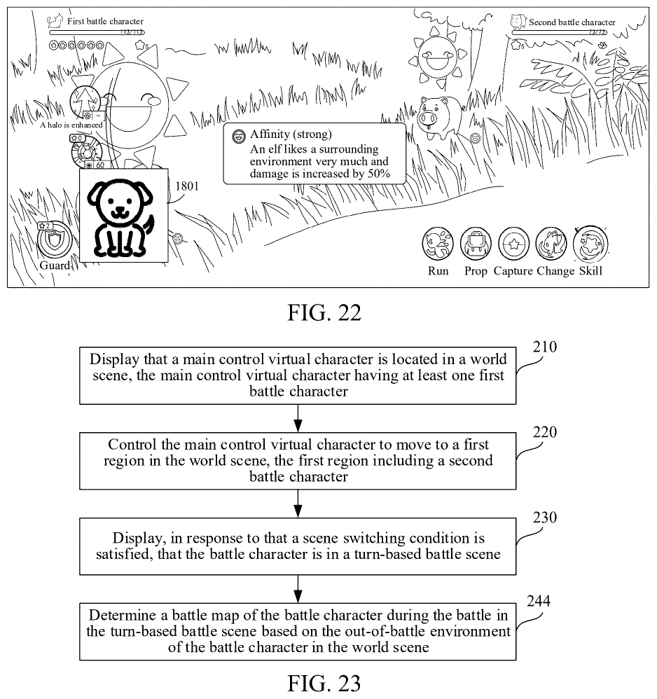

In an embodiment, the user interface further displays a special emotional effect based on the emotional state of the battle character for the out-of-battle environment. In an embodiment, in response to that the special emotional effect receives a trigger operation, the user interface further displays impact of the emotional state of the battle character on the in-battle skill. In some examples, a smiling face in FIG. 22 indicates that a battle character 1801 likes an out-of-battle environment. In response to that the special effect “smiling face” receives a trigger operation, “affinity [strong], where a battle character likes a surrounding environment very much, and damage is increased by 50%” is displayed, that is, “affinity status” is displayed to improve skill strength by 50%.

In an embodiment, the out-of-battle environment corresponds to at least two environment elements. The environment elements include a weather status, a day or night condition, a terrain, a temperature status, and the like.
S1: When a number of environment elements that the battle character likes is larger than a number of environment elements that the battle character hates among the at least two environment elements, a special affinity effect for representing that the battle character is in an affinity state is correspondingly displayed in the turn-based battle scene.
S2: When a number of environment elements that the battle character likes is smaller than a number of environment elements that the battle character hates among the at least two environment elements, a special resistance effect for representing that the battle character is in a resistance state is correspondingly displayed in the turn-based battle scene.

The in-battle skill strength corresponding to the affinity status is higher than the in-battle skill strength corresponding to the resistance status, and a skill effect corresponding to the affinity status is better than a skill effect corresponding to the resistance status.

### For S1:

In some examples, the weather of the out-of-battle environment is sunny, and the terrain of the out-of-battle environment is tile. If the battle character loves a sunny day and the battle character does not like and does not hate tile, it is determined that a number of environment elements (1) that the battle character likes is larger than a number of environment elements (0) that the battle character hates among the two environment elements.

Emotional states of the battle character are classified into a strong affinity state, a weak affinity state, a neutral state, a weak resistance state, and a strong resistance state. In the following, a first affinity state is the strong affinity state, a second affinity state is the weak affinity state, a first resistance state is the strong resistance state, and a second resistance state is the weak resistance state.

In an embodiment, the out-of-battle environment corresponds to a first environment element and a second environment element. S1 may be further subdivided into the following S1-1 and S1-2.
S1-1: When the battle character likes both the first environment element and the second environment element, a first special affinity effect for representing that the battle character is in the first affinity state is further correspondingly displayed in the turn-based battle scene.

In some examples, the weather of the out-of-battle environment is sunny, the terrain of the out-of-battle environment is grassland, and the battle character likes both sunny day and grassland. In this case, the battle character is in the first affinity state, and the user interface displays the first special affinity effect.

In an embodiment, the first environment element is a weather status or a day or night status, and the second environment element is a terrain. Alternatively, the first environment element is a terrain, and the second environment element is a weather status or a day or night status.

In an embodiment, when the battle character likes a weather status, the first environment element is a day or night status, and the second environment element is a terrain. When the battle character hates the weather status, the first environment element is the weather status, and the second environment element is the terrain.

In some examples, environment elements of the out-of-battle environment are sunny, daytime, and grassland. If the battle character likes sunny, it is determined that the battle character likes daytime and the battle character likes grassland, and it is determined that the battle character likes both the first environment element and the second environment element.

That is, in determining the “weather status+day or night status”, the “weather status” is first determined, and if the battle character likes the “weather status”, whether the battle character likes or hates the “day or night status” may be determined. If the battle character hates the “weather status”, whether the battle character likes or hates the “day or night status” may not need to be determined. Based on this, determining of whether the battle character likes or hates the first environment element is completed.
S1-2: When the battle character likes the first environment element and does not hate the second environment element, a second special affinity effect for representing that the battle character is in a second affinity state is further correspondingly displayed in the turn-based battle scene.

In some examples, the weather of the out-of-battle environment is sunny, the terrain of the out-of-battle environment is tile, and the battle character likes sunny day but does not hate tile. In this case, the battle character is in the second affinity state, and the user interface displays the second special affinity effect.

In an embodiment, the first environment element is a weather status or a day or night status, and the second environment element is a terrain. Alternatively, the first environment element is a terrain, and the second environment element is a weather status or a day or night status.

In an embodiment, when the battle character likes a weather status, the first environment element is a day or night status, and the second environment element is a terrain. When the battle character hates the weather status, the first environment element is the weather status, and the second environment element is the terrain.

In some examples, environment elements of the out-of-battle environment are sunny, nighttime, and grassland. If the battle character likes sunny, it is then determined that the battle character does not hate nighttime and the battle character likes grassland. In this case, it is determined that the battle character does not hate the first environment element and likes the second environment element.

### For S2:

In some examples, the weather of the out-of-battle environment is rainy, and the terrain of the out-of-battle environment is tile. If the battle character hates a rainy day and the battle character does not like and does not hate tile, it is determined that a number of environment elements (0) that the battle character likes is smaller than a number of environment elements (1) that the battle character hates among the two environment elements.

In an embodiment, the out-of-battle environment corresponds to a first environment element and a second environment element. S2 may be further subdivided into the following S2-1 and S2-2.
S2-1: When the battle character hates both the first environment element and the second environment element, a first special resistance effect for representing that the battle character is in the first resistance state is further correspondingly displayed in the turn-based battle scene.

In some examples, the weather of the out-of-battle environment is rainy, the terrain of the out-of-battle environment is sand, and the battle character hates both rainy day and sand. In this case, the battle character is in the first resistance state, and the user interface displays the first special resistance effect.

In an embodiment, the first environment element is a weather status or a day or night status, and the second environment element is a terrain. Alternatively, the first environment element is a terrain, and the second environment element is a weather status or a day or night status.

In an embodiment, when the battle character likes a weather status, the first environment element is a day or night status, and the second environment element is a terrain. When the battle character hates the weather status, the first environment element is the weather status, and the second environment element is the terrain.

In some examples, environment elements of the out-of-battle environment are rainy, daytime, and sand. If the battle character hates rainy, it is then determined that the battle character hates sand. In this case, it is determined that the battle character hates both the first environment element and the second environment element.
S2-2: When the battle character hates the first environment element and does not love the second environment element, a second special resistance effect for representing that the battle character is in a second resistance state is further correspondingly displayed in the turn-based battle scene.

In some examples, the weather of the out-of-battle environment is rainy, the terrain of the out-of-battle environment is tile, and the battle character hates rainy and the battle character does not like tile. In this case, the battle character is in the second resistance state, and the user interface displays the second special resistance effect.

In an embodiment, the first environment element is a weather status or a day or night status, and the second environment element is a terrain. Alternatively, the first environment element is a terrain, and the second environment element is a weather status or a day or night status.

In an embodiment, when the battle character likes a weather status, the first environment element is a day or night status, and the second environment element is a terrain. When the battle character hates the weather status, the first environment element is the weather status, and the second environment element is the terrain.

In some examples, environment elements of the out-of-battle environment are sunny, nighttime, and sand. If the battle character likes sunny, it is then determined that the battle character does not like nighttime and the battle character hates sand. In this case, it is determined that the battle character does not like the first environment element and hates the second environment element.

In an embodiment, the terminal device detects weather data, time data, and terrain data in the world scene in real time. In-battle skill strength of the battle character is obtained through mapping from a skill strength configuration table based on the weather data, the time data, and the terrain data in the world scene. Different battle characters correspond to different skill strength configuration tables. Different skills correspond to different skill strength configuration tables.

In some examples, for a first skill, the terminal device detects that the current world scene is “sunny, daytime, and grassland”, and first strength is obtained through mapping from a skill strength configuration table of the first skill.

The terminal device detects that the current world scene is “cloudy, daytime, and grassland”, and second strength is obtained through mapping from a skill strength configuration table of the first skill, where the first strength is greater than the second strength.

The terminal device detects that the current world scene is “cloudy, daytime, and sand”, and third strength is obtained through mapping from a skill strength configuration table of the first skill, where the second strength is greater than the third strength.

In conclusion, it is set that the skill strength and/or the skill effect of the in-battle skill is associated with the emotional state of the battle character for the out-of-battle environment, so that the emotional state of the battle character for the out-of-battle environment is considered. When the battle character has affinity with the battle map, the released skill has greater power.

Land parcels with different environment elements in the out-of-battle environment have different impact on the in-battle skill of the battle character during the battle in the turn-based battle scene.

In an embodiment, the special emotional effect is used for affecting the skill strength and/or the skill effect of the in-battle skill. If the special emotional effect is affinity, the skill strength of the in-battle skill is enhanced and the skill effect is optimized. If the special emotional effect is resistance, the skill strength of the in-battle skill is weakened and the skill effect is reduced.

Each time before the battle character releases a skill, an environment element of a land parcel of the battle character is re-obtained, and a special emotional effect is displayed based on the environment element. Therefore, during the turn-based battle, a skill released by the battle character in each turn is closely related to a land parcel of the battle character. The out-of-battle environment is divided into a plurality of land parcels, and land parcels with different environment elements have different impact on strength of the in-battle skill. In this way, an environment element of a land parcel impacts the power of skill strength of the in-battle skill.

### Fourth Branch:

In FIG. 23, the operation 240 may include the following sub-operation 244:
Operation 244: Determine a battle map of the battle character during the battle in the turn-based battle scene based on an out-of-battle environment of the battle character in the world scene.

The world scene is represented by a world map, and the turn-based battle scene is represented by a battle map.

In some embodiments, that the battle character is in a battle map of the battle in the turn-based battle scene is displayed in response to that a scene switching condition is satisfied.

In response to that the turn-based battle scene is switched to, the user interface is switched from display of the world scene of the world map to display of the turn-based battle scene of the battle map.

A turn-based battle map is a scene in which the battle character performs turn-based battle, and the turn-based battle map is selected from the world map.

In response to an activation operation on a turn-based battle, a first location of the battle character in the world map is determined, a target location matching the first location is determined, and a map within a selection range in the world map is used as a turn-based battle map, where the selection range is a range including the target location.

A turn-based battle map is selected from the world map, and a turn-based battle scene is displayed based on the world map. Based on that the world scene has been displayed, loading of the world map has been completed, so that the turn-based battle map can be directly selected from the world map, and then the turn-based battle scene can be directly displayed based on the world map. The turn-based battle map may not need to be additionally loaded. Therefore, efficiency of displaying the turn-based battle scene is relatively high, and an image of the scene can be smoothly displayed, thereby helping increase a human-computer interaction rate. That is, the turn-based battle map is selected from the world map, and may not need to be loaded.

In some examples, an implementation process of selecting a turn-based battle map from the world map includes: in response to an activation operation on a turn-based battle, determining a first location of the battle character in the world map, determining a target location matching the first location, and using a map within a selection range in the world map as a turn-based battle map, where the selection range is a range including the target location.

The first location is a location in which the battle character is located in the world map when the activation operation on the turn-based battle is obtained. After the first location is determined, the target location matching the first location is determined, and a map in a reference range including the target location in the world map is used as the turn-based battle map.

The target location is a location that matches the first location and that can be used for helping select the turn-based battle map. A type and a size of the reference range are set based on experience or flexibly adjusted according to an application scenario. This is not limited in this embodiment of this disclosure, as long as the reference range includes the target location. In some examples, the reference range is a circular range that uses the target location as the center and a reference value as a radius. In some examples, the reference range is a rectangular range that uses the target location as the center and a first target value and a second target value as side lengths. In some examples, the reference range is a sectoral range that uses the target location as a start point, faces a specified direction, and has a specified angle. The reference value, the first target value, the second target value, the specified direction, and the specified angle are set based on experience or flexibly adjusted according to an application scenario. This is not limited in this embodiment of this disclosure.

It can be known from above that after the target location is determined, the turn-based battle map may be selected from the world map. Next, an implementation of determining the target location matching the first location is described.

In a possible implementation, matching locations of locations in the world map are recorded in the terminal, and a matching location of the first location may be used as the target location matching the first location.

In a possible implementation, an implementation of determining the target location matching the first location includes: if a first location satisfies a reliable condition, using the first location as the target location; and if the first location does not satisfy the reliable condition, using, as the target location, a location that is closest to the first location and that is of locations that satisfy the reliable condition. In some examples, a manner of calculating a distance between two locations is not limited in this embodiment of this disclosure. In some examples, a Euclidean distance between the two locations may be calculated.

The reliable condition is used for measuring reliability of a location in the world map. If a location in the world map satisfies the reliable condition, it indicates that the reliability of the location is relatively high, that is, it indicates that the location is a suitable location based on which the turn-based battle map is selected. A manner of determining whether a location on the world map meets the reliable condition is set based on experience or flexibly adjusted according to an application scenario. This is not limited in this embodiment of this disclosure.

In some examples, the world map is formed by at least one polygon face, and the polygon face may be a triangular face, a four-sided face, or the like. In some examples, a manner of determining whether the first location satisfies the reliable condition may include: if a slope of a polygon face on which the first location is located is not greater than a slope threshold, determining that the first location satisfies the reliable condition; and if the slope of the polygon face on which the first location is located is greater than the slope threshold, determining that the first location does not satisfy the reliable condition. In some examples, a manner of calculating the slope of the polygon face includes: using an angle between a normal line of the polygon face and a normal line of the horizontal plane as the slope of the polygon face. The slope threshold is set according to experience, or is flexibly adjusted according to an application scenario. This is not limited in this embodiment of this disclosure.

In some examples, a manner of determining whether the first location satisfies the reliable condition further may include: if a type of a polygon face on which the first location is located is a target type, determining that the first location satisfies the reliable condition; and if the type of the polygon face on which the first location is located is not the target type, determining that the first location does not satisfy the reliable condition. The target type is a type of a polygon face that supports the battle character to perform turn-based battle. In some examples, the target type includes but is not limited to a flat ground, a grassland, and the like.

In some examples, a manner of determining whether the first location satisfies the reliable condition may further include: if a slope of a polygon face on which the first location is located is not greater than a slope threshold and a type of the polygon face is a target type, determining that the first location satisfies the reliable condition; and if the slope of the polygon face on which the first location is located is greater than the slope threshold or the type of the polygon face is not the target type, determining that the first location does not satisfy the reliable condition.

If the first location satisfies the reliable condition, it indicates that the reliability of the first location is relatively high, and the first location is directly used as the target location based on which the turn-based battle map is selected. If the first location does not satisfy the reliable condition, it indicates that the reliability of the first location is relatively low. In this case, a location that is closest to the first location and that is of locations that satisfy the reliable condition is used as the target location based on which the turn-based battle map is selected.

In a possible implementation, a process of determining the target location matching the first location includes the following operation 1 to operation 3.
Operation 1: Map the first location to a query image, to obtain a mapping location of the first location in the query image.

The query image is an image obtained after at least one query sub-region is displayed in a display style corresponding to the at least one query sub-region, and different query sub-regions correspond to different locations in the world map.

A mapping rule for mapping a location in the world map to the query image is recorded in the terminal. The first location can be mapped to the query image according to the mapping rule, to obtain the mapping location of the first location in the query image. In some examples, the mapping rule is used to indicate how to map a location in the world map to the query image. The mapping rule is set according to experience, or is flexibly adjusted according to a manner of obtaining the query image. This is not limited in this embodiment of this disclosure.

The query image is an image obtained after at least one query sub-region is displayed in a display style corresponding to the at least one query sub-region. A process of obtaining the query image is described in detail below. A display style corresponding to any query sub-region is a first style or a style other than the first style. The first style is a style used for displaying a query sub-region meeting a selection condition. If a display style corresponding to a query sub-region is the first style, it indicates that the query sub-region satisfies the selection condition. Through the query image, whether each query sub-region satisfies the selection condition can be intuitively visualized, thereby improving efficiency of selecting a turn-based battle map.

The first style is set according to experience, or is flexibly adjusted according to an application scenario. This is not limited in this embodiment of this disclosure. In some examples, the first style is that a display color is black. Alternatively, the first style is that the display color is brown or the like. A style other than the first style is a color different from the first style. The style other than the first style is not limited in this embodiment of this disclosure. There may be one or more styles other than the first style, provided that the styles are all different from the first style.

A size of the query sub-region is not limited in this embodiment of this disclosure. In some examples, different query sub-regions have the same size, or different query sub-regions have different sizes. In some examples, the query sub-region is a region obtained after performing pixilation processing on an image whose size is the same as that of the world map. That is, each query sub-region may be considered as a pixilation region.

Each query sub-region corresponds to a location in the world map, and different query sub-regions correspond to different locations in the world map. A correspondence between a query sub-region and a location in the world map is preset. A size of a location in the world map corresponding to a query sub-region is not limited in this embodiment of this disclosure. In some examples, if the size of the query image is the same as the size of the world map, the size of the location in the world map corresponding to the query sub-region is the same as the size of the query sub-region.

After the mapping location is determined, a query sub-region in which the mapping location is located may be determined, and a query region in which the mapping location is located becomes a first query sub-region. After the first query sub-region is determined, it is determined whether a display style corresponding to the first query sub-region is the first style. If the display style corresponding to the first query sub-region is the first style, the target location is determined based on operation 2. If the display style corresponding to the first query sub-region is not the first style, the target location is determined based on operation 3.
Operation 2: In response to that a display style corresponding to the first query sub-region in which the mapping location is located is the first style, use, as the target location, a location in the world map that corresponds to the first query sub-region, where the first style is a style used for displaying a query sub-region meeting a selection condition.

When the display style corresponding to the first query sub-region is the first style, it indicates that the first query sub-region satisfies the selection condition. In this case, the location in the world map that correspond to the first query sub-region is directly used as the target location.

The target location determined in this manner may be considered as a location having no deviation relative to the first location. A turn-based battle map selected according to the target location is a scene corresponding to a location of a battle character. A process of switching from the world map to the turn-based battle map is an integrated process, and scene switching is relatively smooth.
Operation 3: In response to that the display style corresponding to the first query sub-region in which the mapping location is located is not the first style, use, as the target location, a location in the world map that corresponds to a second query sub-region.

The first style is a style used for displaying a query sub-region meeting a selection condition. The second query sub-region is a query sub-region of reference query sub-regions that is closest to the first query sub-region, and each reference query sub-region is a query sub-region whose display style is the first style in the query image.

When the display style corresponding to the first query sub-region is not the first style, it indicates that the first query sub-region does not satisfy the selection condition. In this case, the second query sub-region is determined. The second query sub-region is a query sub-region that is of the reference query sub-regions whose display styles are the first style and that is closest to the first query sub-region. A manner of calculating a distance between two sub-regions is not limited in this embodiment of this disclosure. In some examples, a Euclidean distance between centers of the two sub-regions is calculated, or a Euclidean distance between two points in the same locations (for example, upper left corners and lower right corners) of the two sub-regions is calculated.

After the second query sub-region is determined, a location in the world map that corresponds to the second query sub-region is used as the target location, to determine the target location.

The target location determined in this manner is a location having deviation relative to the first location. The turn-based battle map selected according to the target location refers to a scene corresponding to a location nearby a location of a battle character. However, because a distance between the query sub-region corresponding to the target location and the query sub-region corresponding to the first location is relatively small, deviation of the target location relative to the first location is also relatively small, thereby ensuring relatively weak visual abruptness caused by scene switching. The relatively weak visual abruptness may be further reduced by presenting an animation, thereby ensuring interaction experience of interaction objects and improving a human-computer interaction rate.

After the target location is determined, a reference range is determined by using the target location as the center, and a map within the reference range in the world map is used as a turn-based battle map, thereby completing a process of selecting the turn-based battle map from the world map.

A process of selecting the turn-based battle map is implemented according to the first location of the battle character in the world map and the query image. If the display style of the first query sub-region in which the mapping location of the first location is located is the first style (for example, the display color is black), the location in the world map that corresponds to the first query sub-region may be directly used as the target location, and the turn-based battle map is constructed for the battle character to perform turn-based battle. If the display style of the first query sub-region in which the mapping location of the first location is located is not the first style (for example, the display color is not black), the second query sub-region that is closest to the first query sub-region and whose display style is the first style is searched for, then the location in the world map that corresponds to the second query sub-region is used as the target location, and the turn-based battle map is constructed for the battle character to perform turn-based battle.

That is, each query sub-region that is in the query image and whose display style is the first style is a valid central point for constructing a turn-based battle map. When the turn-based battle map may be selected, a query sub-region whose display style is the first style and that is closest to a mapping location of a location of a battle character is searched for, and the turn-based battle map is constructed by using, as the center, a location in the world map that corresponds to the query sub-region.

As can be known from the foregoing implementation of selecting a turn-based battle map from the world map, in this embodiment of this disclosure, the turn-based battle map is selected from the world map according to the target location. Before it is determined that the turn-based battle map is selected, it is first determined whether the first location of the battle character in the world map is a suitable location based on which the turn-based battle map is selected. If the first location is a suitable location based on which the turn-based battle map is selected, a location having no deviation relative to the first location is used as the target location. If the first location is not a suitable location based on which the turn-based battle map is selected, a location that is a suitable location based on which the turn-based battle map is selected and that has a relatively small deviation relative to the first location is used as the target location.

In this manner, when the world map may be switched to the turn-based battle map, the turn-based battle map can be directly selected from the world map according to the target location, and the turn-based battle map may not need to be additionally loaded. The scene switching efficiency is relatively high, and the efficiency of displaying the turn-based battle map is also relatively high. In addition, in a process of selecting a turn-based battle map, it is determined whether the first location is a suitable location based on which the turn-based battle map is selected. Therefore, regardless of a configuration status of the world map, a turn-based battle map suitable for a battle character to perform turn-based battle can be selected according to the manner provided in this embodiment of this disclosure, thereby helping improve flexibility in configuration of the world map.

In addition, when the target location is a location having a relatively small deviation relative to the first location, although switching of the virtual scene causes visual abruptness to some extent, the visual abruptness caused by scene switching can be further reduced by presenting an animation in a scene switching process, thereby improving interaction experience of interaction objects.

In a related technology, the world map in which a battle character performs a first activity and the turn-based battle map in which the battle character performs turn-based battle are two completely independent scenes. When it is determined that the turn-based battle may be performed, the turn-based battle map may be loaded first, and a black-screen image or a white-screen image is displayed before loading of the turn-based battle map is completed.

In this manner, it takes a relatively long time to load the turn-based battle map and consequently it takes a relatively long time to switch a virtual scene. In addition, the black-screen image or the white-screen image interrupts a display process of a scene image, which downgrades immersive experience of interaction objects and brings poor interaction experience to interaction objects, and reduces a human-computer interaction rate. However, in this embodiment of this disclosure, the turn-based battle map is a scene selected from the world map. When it is determined that turn-based battle may be performed, only the target location may be determined, and the turn-based battle map is selected from the world map according to the target location. The turn-based battle map may not need to be loaded, and a black-screen image or a white-screen image may not need to be displayed. This helps improve smoothness of display of scene images, thereby improving immersive experience of interaction objects, improving interaction experience of the interaction objects, and improving a human-computer interaction rate.

In another related technology, scenes in which a battle character performs a first activity and turn-based battle are both the world map. When it is determined that the turn-based battle may be performed, a current location of the battle character is directly used as a location for performing the turn-based battle.

In this manner, the world map may be preconfigured such that all locations are suitable for scenes in which the battle character performs turn-based battle, such that the battle character can smoothly perform turn-based battle. This has a relatively high requirement on configuration of the world map, and the landscape of the configured world map may be relatively monotonous. For example, the landscape of the configured world map may all be planes having a relatively small slopes, grasslands, or the like. The world map with relatively monotonous landscape may downgrade interaction experience of interactive objects, thereby reducing a human-computer interaction rate.

However, in this embodiment of this disclosure, it is first determined whether the first location in which the battle character is located when the turn-based battle may be performed is a suitable location based on which a turn-based battle map is selected. If the first location is a suitable location based on which a turn-based battle map is selected, a location having no deviation relative to the first location is used as the target location. If the first location is not a suitable location based on which the turn-based battle map is selected, a location that is a suitable location based on which the turn-based battle map is selected and that has a relatively small deviation relative to the first location is used as the target location. In this manner, regardless of configuration of the world map, a turn-based battle map suitable for the battle character to perform turn-based battle can be selected, such that the battle character smoothly performs turn-based battle. The requirement on configuration of the world map is relatively low, and the world map may not need to be preconfigured such that all locations are suitable for scenes in which the battle character performs turn-based battle. This helps improve configuration flexibility of the world map and enrich the landscape of the world map, thereby improving interaction experience of interaction objects and improving a human-computer interaction rate.

### Fifth Branch:

During switching from the world scene to the turn-based battle scene, a transition animation is added for naturally connecting the two scenes, so that a player feels less abrupt when switching from the world scene to the turn-based battle scene.

In an embodiment, smooth transition between images is performed by playing a transition animation.

A first transition animation is displayed in a process of switching from the world scene to the turn-based battle scene, so that the attention of a player can be attracted to the animation, and attention of the player to a virtual scene switching process is reduced, thereby helping reduce visual abruptness of the player caused by virtual scene switching, improving interaction experience of the player, and improving a human-computer interaction rate.

In some examples, when the main control virtual character performs an exploration activity in the world scene, the world scene is displayed. When the main control virtual character encounters the second battle character in the world scene, it is determined whether to activate turn-based battle. In response to that turn-based battle is not activated, the world scene continues to be displayed. In response to that turn-based battle is activated, a first transition animation of the second battle character and a first transition animation of the main control virtual character are sequentially presented. The first transition animation of the second battle character is presented before the world scene is switched to the turn-based battle scene, and the first transition animation of the main control virtual character is presented after the world scene is switched to the turn-based battle scene.

In response to that presentation of the first transition animation of the main control virtual character is completed, the turn-based battle scene is displayed based on the world scene, to indicate that the main control virtual character performs turn-based battle in the turn-based battle scene. It is determined whether the turn-based battle ends, and the turn-based battle scene continues to be displayed in response to that the turn-based battle does not end.

The first transition animation is used for reducing abruptness in switching from the world scene to the turn-based battle scene. The first transition animation includes a plurality of animation frames, and the first transition animation includes a close-up image of the main control virtual character and a close-up image of the second battle character.

In some embodiments, the main control virtual character explores in the world scene. After turn-based battle is activated, for example, the main control virtual character meets the second battle character, the first transition animation presents the close-up image of the second battle character, and then the first transition animation presents the close-up image of the main control virtual character. The main control virtual character throws a virtual prop, to release the first battle character from the virtual prop. In this case, an image of the turn-based battle scene is entered. The image of the turn-based battle scene includes the first battle character and the second battle character, and the first battle character and the second battle character enter turn-based battle.

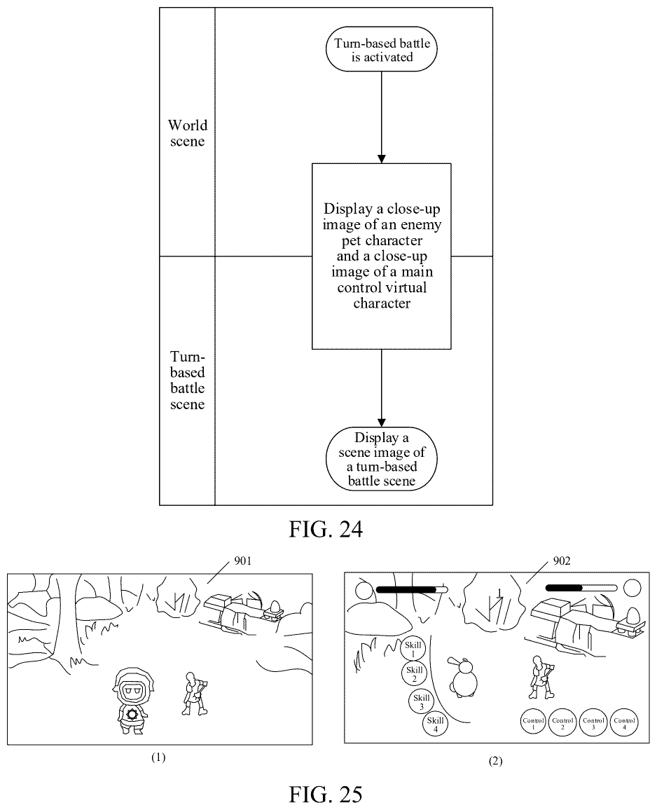

In some examples, a display process of a scene image may include a process (a switch-in process) of switching the world scene to the turn-based battle scene. As shown in FIG. 24, the switch-in process includes: in response to that turn-based battle is activated, a first transition animation of the second battle character and a first transition animation of the main control virtual character are sequentially presented. In response to that presentation of the first transition animation of the main control virtual character is completed, the turn-based battle scene is displayed based on the world scene, to indicate that the main control virtual character performs turn-based battle in the turn-based battle scene.

In the switch-in process, after the main control virtual character encounters the second battle character in the world scene, virtual scene switching is completed through close-up of the virtual object, and no black screen or white screen processing is performed. In some examples, close-up of a virtual object may be implemented by controlling a change of a distance between a virtual camera and the virtual object.

In some examples, because the turn-based battle scene is a scene selected from the world scene, the turn-based battle scene and the world scene are the same scene, and a landscape difference may be almost neglected. For example, the world scene is shown as a virtual scene 901 in (1) in FIG. 25, and the turn-based battle scene is shown as a virtual scene 902 in (2) in FIG. 25. A difference between the world scene and the turn-based battle scene mainly lies in a visual field range, and there is almost no landscape difference.

In the process of switching between the world scene and the turn-based battle scene provided in this embodiment of this disclosure, the turn-based battle scene may not need to be re-loaded. Instead, an appropriate scene is directly selected from the world scenes as the turn-based battle scene. Through artistic presentation (for example, presentation of an animation) and camera skills, a scene of a main control virtual character can be quickly switched when there is always an entity (for example, the main control virtual character and the second battle character) in an image, to avoid a black screen or a white screen. In addition, the turn-based battle scene is made to be similar to the world scene as much as possible based on a selection algorithm of the turn-based battle scene, thereby achieving “seamless” smooth experience. Based on the display method provided in this embodiment of this disclosure, scene switching does not interrupt immersive experience of a player performing exploration in the world scene and performing turn-based battle in the turn-based battle scene, and the entire scene switching process is “integral” rather than split from the eye of the player, thereby improving sense of immersion of the player and improving fun of the game.

In some embodiments, in response to that the scene switching condition is satisfied, the terminal device obtains the first transition animation that is locally stored, or the terminal device obtains the first transition animation from a background server, and presents the first transition animation.

Switching Sequence 2: Switching from a “Turn-Based Battle Scene” to a “World Scene”:

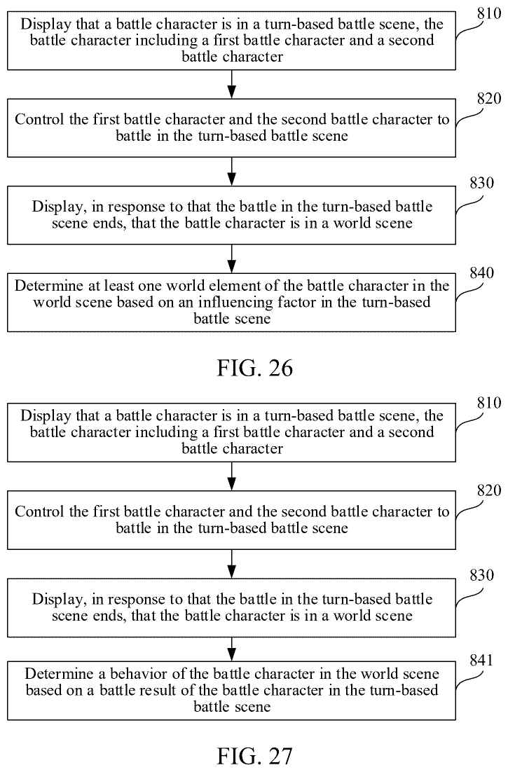

FIG. 26 is a flowchart of a virtual scene switching method according to an embodiment of this disclosure. The method may be performed by a terminal device and includes:
Operation 810: Display that a battle character is in a turn-based battle scene. The battle character includes a first battle character and a second battle character, and the first battle character is a battle character owned by a main control virtual character. In one example, battle characters are displayed in a turn-based battle scene, where the battle characters include a first battle character and a second battle character, and the first battle character is subordinate to a main control virtual character.

The turn-based battle scene is obtained through rendering based on a battle map. The battle map is usually a large map of an open virtual world. The battle map includes a plurality of land parcels. Each land parcel is polygonal.

In some embodiments, the main control virtual character has at least one first battle character. The first battle character is a battle character that is successfully captured by the main control virtual character. The main control virtual character is a virtual character controlled by a current player. The first battle character successfully captured may be controlled by the current player, or may be controlled by AI, or the current player may specify a battle strategy and then the first battle character is controlled by AI based on the battle strategy. This is not limited in this disclosure.

In this embodiment, it is assumed that in an initial case, the main control virtual character and the battle character are in the turn-based battle scene.
Operation 820: Control the first battle character and the second battle character to battle in the turn-based battle scene.

The first battle character is a battle character owned by the main control virtual character, and the second battle character is a battle character owned by an enemy virtual character, or the second battle character is a battle character controlled by AI, or the second battle character is a wild battle character. In an embodiment, the first battle character and the second battle character are in an enemy relationship.

In some embodiments, controlling the first battle character and the second battle character to battle in the turn-based battle scene is controlling the first battle character and the second battle character to battle in the turn-based battle scene.
Operation 830: Display, in response to that the battle in the turn-based battle scene ends, that the battle character is in a world scene. In one example, based on an end of the battle in the turn-based battle scene, at least one of the battle characters is displayed, by processing circuitry, in a world scene.

In the turn-based battle scene, the first battle character and the second battle character battle with each other. When the battle may end because one battle character is defeated or a victory condition is met, the game responds to a battle end event. After responding to the battle end event, the game is switched so that the battle character is in the world scene.

In response to an end of the battle in the turn-based battle scene, the turn-based battle scene is switched to the world scene, and that the virtual character is located in the world scene is displayed. In some embodiments, the turn-based battle scene is directly switched to the world scene. In some embodiments, in a switching process of switching from the turn-based battle scene to the world scene, a transition animation is inserted, to make the player feel less abrupt in switching from the turn-based battle scene to the world scene.

The world scene is obtained through rendering based on a world map. In various examples, a map area of the world map is larger than a map area of the battle map. In some embodiments, the world map is a map independent of the battle map and different from the battle map. In some embodiments, the world map is a parent map based on the battle map, such that a turn-based battle scene displayed before switching is the same as a world scene displayed after switching, or a similarity degree is higher than a preset condition.
Operation 840: Determine at least one world element of the battle characters in the world scene based on an influencing factor in the turn-based battle scene. In one example, the influencing factor corresponds to a battle result. In one example, the at least one world attribute of the battle characters corresponds to a behavior of at least one of the battle characters. In one example, the one of the battle characters is displayed in the world scene based on the determined world attribute.

After the world scene is switched to, at least one world element of the battle characters in the world scene is determined based on at least one influencing factor in the turn-based battle scene.

In some embodiments, to maintain consistency between the world scene and the turn-based battle scene, the following three improvements are provided. The three improvements are divided into three branches, and the three branches are respectively introduced below:

### Branch 1:

determining a behavior of the battle character in the world scene based on a battle result in the turn-based battle scene.

### Branch 2:

determining an out-of-battle environment of the battle character in the world scene based on an in-battle environment of the battle character in the turn-based battle scene.

### Branch 3:

during switching from the turn-based battle scene to the world scene, adding a transition animation for naturally connecting the two scenes, so that a player feels less abrupt when switching from the turn-based battle scene to the world scene.

In conclusion, in the method of this embodiment, the at least one world element of the battle character in the world scene is determined based on the influencing factor in the turn-based battle scene. Therefore, a difference between the world scene and the turn-based battle scene can be downplayed, interplay between the world scene and the turn-based battle scene can be increased, and consistency between the world scene and the turn-based battle scene can be improved, so that a player feels less abrupt or no longer feels abrupt in a scene switching process.

The three branches are respectively described below.
Branch 1:

In FIG. 27, the operation 840 may include the following sub-operation 841:
Operation 841: Determine a behavior of the battle character in the world scene based on a battle result in the turn-based battle scene.

This includes the following two cases:
Case 1: controlling the behavior of the battle character in the world scene based on a victory behavior mode in a case that the battle result of the battle character in the turn-based battle scene is victory.

The battle character includes at least one of the first battle character and the second battle character.

The victory behavior mode refers to that after a battle character obtains victory, the game system determines a behavior of the battle character in the world scene according to a specified rule or specified logic.

In an embodiment, the victory behavior mode may include the following content: a battle character may obtain a reward and grow up. For example, the battle character may obtain an experience point, a gold coin, a prop, or another reward after victory, to help grow and improve the capability of the battle character. A battle character obtains an exploration and discovery opportunity. The battle character obtains an additional exploration or discovery opportunity after victory, for example, unlocks a new map region, a hidden task, or a secret road.

When a battle result of a battle character in the turn-based battle scene is victory, this includes that a battle result of the first battle character in the turn-based battle scene is victory or a battle result of the second battle character in the turn-based battle scene is victory.

In a possible implementation, the battle result of the first battle character in the turn-based battle scene is victory. In switching from the turn-based scene to the world scene, the main control virtual character may select to continue capturing the second battle character, or the main control virtual character may select to continue exploring in the world scene, for example, unlock a new map region.

In a possible implementation, the battle result of the second battle character in the turn-based battle scene is victory. In switching from the turn-based scene to the world scene, the second battle character may select to hide, to avoid being captured by the main control virtual character, or the second battle character selects to attack the first battle character again.

In an embodiment, the terminal device obtains that the battle result of the first battle character in the turn-based battle scene is victory, maps to a first victory behavior mode in a preconfigured first behavior mode table, and controls, based on the first victory behavior mode, the first battle character to perform an action.

In another embodiment, the terminal device obtains that the battle result of the second battle character in the turn-based battle scene is victory, maps to a second victory behavior mode in a preconfigured second behavior mode table, and controls, based on the second victory behavior mode, the second battle character to perform an action.
Case 2: controlling the behavior of the battle character in the world scene based on a failure behavior mode in a case that the battle result of the battle character in the turn-based battle scene is failure.

The failure behavior mode refers to that after a battle character fails, the game system determines a behavior of the battle character in the world scene according to a specified rule or specified logic.

In an embodiment, the failure behavior mode may include the following content: the battle character is punished. The battle character may be punished after failure, for example, loses some experience points, gold coins, or props, or is impacted in other negative forms. The battle character may challenge again. After the battle character fails, there is a chance to challenge an enemy battle character again to attempt to win victory. The battle character may learn from the failure and improve a skill or a strategy.

When a battle result of a battle character in the turn-based battle scene is failure, this includes that a battle result of the first battle character in the turn-based battle scene is failure or a battle result of the second battle character in the turn-based battle scene is failure.

In a possible implementation, the battle result of the first battle character in the turn-based battle scene is failure. In switching from the turn-based scene to the world scene, the first battle character is punished, for example, loses experience points or gold coins, or the first battle character selects to escape to avoid attack by the second battle character.

In a possible implementation, the battle result of the second battle character in the turn-based battle scene is failure. In switching from the turn-based scene to the world scene, the second battle character selects to escape, to avoid being captured by the main control virtual character.

In an embodiment, the terminal device obtains that the battle result of the first battle character in the turn-based battle scene is failure, maps to a first failure behavior mode in a first behavior mode table, and controls, based on the first failure behavior mode, the first battle character to perform an action.

In another embodiment, the terminal device obtains that the battle result of the second battle character in the turn-based battle scene is failure, maps to a second failure behavior mode in a second behavior mode table, and controls, based on the second failure behavior mode, the second battle character to perform an action.

The following describes that the battle character determines state switching of the battle character in the world scene based on a battle result.

Based on the above method, the controlling the behavior of the second battle character in the world scene based on a victory behavior mode in a case that the battle result of the second battle character in the turn-based battle scene is victory includes at least one of the following:
controlling, in a case that the battle result of the battle character in the turn-based battle scene is victory and the battle character is in a hidden state in the turn-based battle scene, the battle character to remain in the hidden state in the world scene;
controlling, in a case that the battle result of the battle character in the turn-based battle scene is victory and a hidden state of the battle character is discovered in the turn-based battle scene, the battle character to re-enter the hidden state in the world scene;
controlling, in a case that the battle result of the battle character in the turn-based battle scene is victory and the battle character is woken up from a sleep state in the turn-based battle scene, the battle character to re-enter the sleep state in the world scene; and
controlling, in a case that the battle result of the battle character in the turn-based battle scene is victory and the battle character is in an exploration state before the turn-based battle scene is entered, the battle character to re-enter the exploration state in the world scene.

For example, the battle character is the second battle character.

In one example, in a case that the battle result of the second battle character in the turn-based battle scene is victory and the second battle character is in a hidden state in the turn-based battle scene, the second battle character is controlled to remain in the hidden state in the world scene.

The hidden state means that the second battle character may hide itself in the game in a specific manner, so that the second battle character is not easily discovered or perceived in the world scene.

In an embodiment, the hidden state includes at least one of states such as an invisible state, a disguise state, a lurking state, and a deluding state.

Invisible state: the second battle character may enter the invisible state by using a special skill or prop, so that the second battle character becomes transparent or invisible in the world scene.

Disguise state: the second battle character may disguise as the first battle character or disguise as an object in a surrounding environment, to hide a real identity to delude the main control virtual character.

Lurking state: the second battle character may select to hide at a place without actively performing an action or attacking, to avoid being discovered by the first battle character or drawing attention from the first battle character.

Deluding state: the second battle character may use a deluding skill or prop, so that the main control virtual character or the first battle character cannot accurately determine a location or an action of the second battle character in the world scene.

For example, the second battle character is a battle character of the ghost type. When the battle result of the second battle character in the turn-based battle scene is victory, and the second battle character is in the invisible state in the turn-based battle scene, the second battle character still remains in the invisible state in switching from the turn-based battle scene to the world scene. For another example, the second battle character is a battle character of the plant type. When the battle result of the second battle character in the turn-based battle scene is victory, and the second battle character is in the disguise state in the turn-based battle scene, the second battle character becomes a plant in the world scene and continues to remain in the hidden state in switching from the turn-based battle scene to the world scene.

In one example, in a case that the battle result of the second battle character in the turn-based battle scene is victory and a hidden state of the second battle character is discovered in the turn-based battle scene, the second battle character is controlled to re-enter the hidden state in the world scene.

For example, the second battle character is a battle character of the wind type. When the battle result of the second battle character in the turn-based battle scene is victory, and a hidden state of the second battle character is discovered in the turn-based battle scene, the second battle character may use a special skill of the wind type to re-enter the invisible state in switching from the turn-based battle scene to the world scene.

In one example, in a case that the battle result of the second battle character in the turn-based battle scene is victory and the second battle character is woken up from a sleep state in the turn-based battle scene, the second battle character is controlled to re-enter the sleep state in the world scene.

The sleep state refers to that the second battle character is in a resting state, and the second battle character in the sleep state can neither perform an action nor participate in a battle. When the second battle character is in the sleep state, the second battle character cannot actively perform an action or attack, and instead can only be woken up by another virtual character to restore a normal battle state.

A wakeup state means that the second battle character is woken up from the sleep state. In this case, the second battle character may perform an action or participate in a battle.

For example, the second battle character is a battle character of the animal type. The second battle character is in the sleep state before entering the turn-based battle scene. The second battle character enters the turn-based battle scene after being woken up by the first battle character. When the battle result of the second battle character in the turn-based battle scene is victory, the second battle character may re-enter the sleep state in switching from the turn-based battle scene to the world scene.

In one example, in a case that the battle result of the second battle character in the turn-based battle scene is victory and the second battle character is in an exploration state before the turn-based battle scene is entered, the second battle character is controlled to re-enter the exploration state in the world scene.

The exploration state is a state in which the second battle character explores and searches for a new place, task, or resource in the world scene. In the exploration state, the second battle character may freely move, interact with another virtual character, find a hidden object or place, or the like.

Based on the above method, the controlling the behavior of the battle character in the world scene based on a failure behavior mode in a case that the battle result of the battle character in the turn-based battle scene is failure includes:
controlling, in a case that the battle result of the battle character in the turn-based battle scene is failure and the battle character is in an escape state in the turn-based battle scene, the battle character to remain in the escape state in the world scene.

For description purpose, the battle character is the second battle character.

The escape state is a state in which the second battle character selects to leave the battle scene or avoids battle with the first battle character.

In an embodiment, the escape state may be triggered in different cases in a battle as follows: The second battle character may select to actively escape, that is, the second battle character actively selects to leave the battle scene, to avoid battle with the first battle character again. The second battle character may passively escape. The second battle character may be forced to escape when being seriously hurt or in other unfavorable cases in the turn-based battle scene, including an excessively low life value, an abnormal state, and the like of the second battle character.
Branch 2:

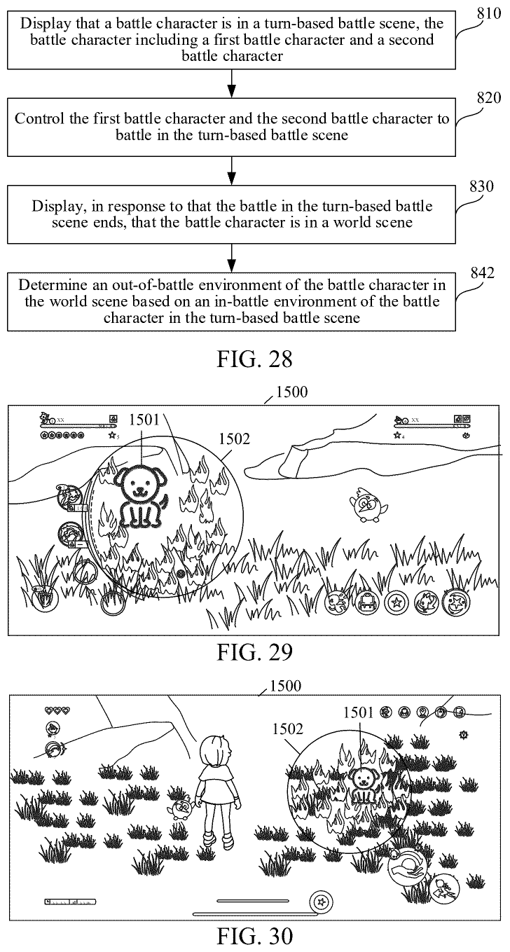

In FIG. 28, the operation 840 may include the following sub-operation 842:
Operation 842: Determine an out-of-battle environment of the battle character in the world scene based on an in-battle environment of the battle character in the turn-based battle scene.

In an embodiment, after the turn-based battle ends, the user interface is further switched from display of the battle map to display of the world map, that is, switched from an in-battle environment in the turn-based battle scene to an out-of-battle environment in the world scene.

After returning to the out-of-battle environment, some maps of the world map display battle traces. In some examples, due to fierce fighting of two parties in the turn-based battle, the grassland in the in-battle environment is ignited, and after returning to the out-of-battle environment, the grassland in the out-of-battle environment is also ignited. If the fire has been extinguished in the in-battle environment, burning residue is displayed in the out-of-battle environment.

In some examples, halo affects a terrain attribute in the in-battle environment. When an initial type of the terrain attribute is a grass type, the type of the terrain attribute is changed to the fire type under impact of halo of the fire type, that is, an image of grass burning on a land parcel is rendered and displayed. Alternatively, when the initial type of the terrain attribute is a water type, the type of the terrain attribute is changed to an ice type under impact of halo of the ice type, that is, an image of water freezing on the land parcel is rendered and displayed. Alternatively, when the initial type of the terrain attribute is a soil type, the type of the terrain attribute is changed to the grass type under impact of halo of the grass type, that is, an image of grass growing on the land parcel is rendered and displayed. This is not limited in this embodiment of this disclosure.

For example, in FIG. 29 and FIG. 30, in a turn-based battle scene 1500, a battle character 1501 of a fire attribute applies a spherical fire halo 1502 with a radius of 4 meters to a location of the battle character during attack. The spherical fire halo 1502 changes a land parcel within the spherical fire halo 1502 from the grass type to the fire type, that is, the grassland within the spherical fire halo 1502 is ignited. In an embodiment, when the turn-based battle ends, if the spherical fire halo 1502 is the remaining halo, the spherical fire halo 1502 is also rendered and displayed in a location of the virtual character 1501 in a scene control process, and that the grassland within the spherical fire halo 1502 is ignited is also rendered and displayed.

In this embodiment of this disclosure, active displacement may be generated when the battle character is an attacker. Passive displacement may be generated when the battle character is attacked. When attacked by a skill, the battle character is repelled in a displacement process. As the location of the battle character changes, an environment of the battle character (including a land parcel environment and a weather environment of the battle character) may also change, thereby affecting subsequent turn-based battle of the battle character.

In an embodiment, the terminal device detects weather data, time data, and terrain data in the turn-based battle scene in real time, synchronously updates weather data in the world scene to the weather data in the turn-based battle scene, synchronously updates time data in the world scene to the time data in the turn-based battle scene, and synchronously updates terrain data in the world scene to the terrain data in the turn-based battle scene.
Branch 3: during switching from the turn-based battle scene to the world scene, adding a transition animation for naturally connecting the two scenes, so that a player feels less abrupt when switching from the turn-based battle scene to the world scene.

In an embodiment, smooth transition between images is performed by playing a transition animation.

A second transition animation of the first battle character is presented before switching from the turn-based battle scene back to the world scene, that is, before a virtual scene of the first battle character is switched from the turn-based battle scene back to the world scene, so that the attention of a player can be attracted to the animation, and attention of the player to a virtual scene switching process is reduced, thereby helping reduce visual abruptness of the player caused by virtual scene switching, improving interaction experience of the player, and improving a human-computer interaction rate.

In response to that the turn-based battle ends, a second transition animation of the main control virtual character is displayed. There are a plurality of second transition animations of the main control virtual character, some of the second transition animations are presented before the turn-based battle scene is switched back to the world scene, and the remaining second transition animations are presented after the turn-based battle scene is switched back to the world scene. The world scene is displayed in response to that presentation of the second transition animation of the main control virtual character is completed, to indicate that the main control virtual character returns to the world scene to perform an exploration activity.

The second transition animation is used for reducing abruptness in switching from the turn-based battle scene to the world scene. The second transition animation includes a plurality of animation frames, and the second transition animation includes a close-up image of the main control virtual character.

In some embodiments, after the turn-based battle ends, the second transition animation displays a close-up image in which the main control virtual character places the first battle character in a virtual prop. When the battle result of the main control virtual character is victory, the second transition animation displays a close-up image in which the main control virtual character celebrates. When the battle result of the main control virtual character is failure, the second transition animation displays a close-up image in which the main control virtual character escapes, or the second transition animation displays a close-up image in which the main control virtual character continues to explore in the world scene.

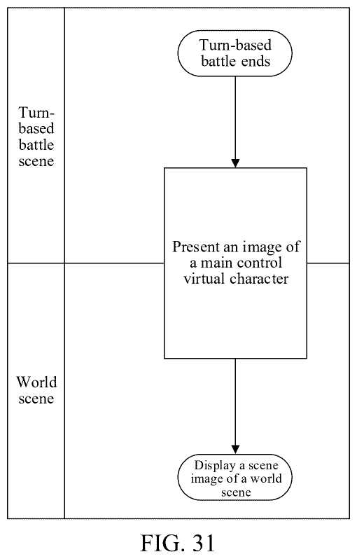

In some examples, a display process of a scene image may include a process (a switch-out process) of switching the turn-based battle scene back to the world scene. A switch-out process may be shown in FIG. 31. The switch-out process includes: in response to an end of the turn-based battle, displaying the second transition animation of the main control virtual character. The world scene is displayed in response to that presentation of the second transition animation of the main control virtual character is completed, to indicate that the main control virtual character returns to the world scene to perform an exploration activity.

In some embodiments, in response to that the battle ends, the terminal device obtains the second transition animation that is locally stored, or the terminal device obtains the second transition animation from a background server, and presents the second transition animation.

In the switch-out process, after the turn-based battle ends, the same animation is used to complete scene switching during image switching.

In the process of switching between the world scene and the turn-based battle scene provided in this embodiment of this disclosure, the turn-based battle scene may not need to be re-loaded. Instead, an appropriate scene is directly selected from the world scenes as the turn-based battle scene. Through artistic presentation (for example, presentation of an animation) and camera skills, a scene of a main control virtual character can be quickly switched when there is always an entity (for example, the main control virtual character and the second battle character) in an image, to avoid a black screen or a white screen. In addition, the turn-based battle scene is made to be similar to the world scene as much as possible based on a selection algorithm of the turn-based battle scene, thereby achieving “seamless” smooth experience. Based on the display method provided in this embodiment of this disclosure, scene switching does not interrupt immersive experience of a player performing exploration in the world scene and performing turn-based battle in the turn-based battle scene, and the entire scene switching process is “integral” rather than split from the eye of the player, thereby improving sense of immersion of the player and improving fun of the game.

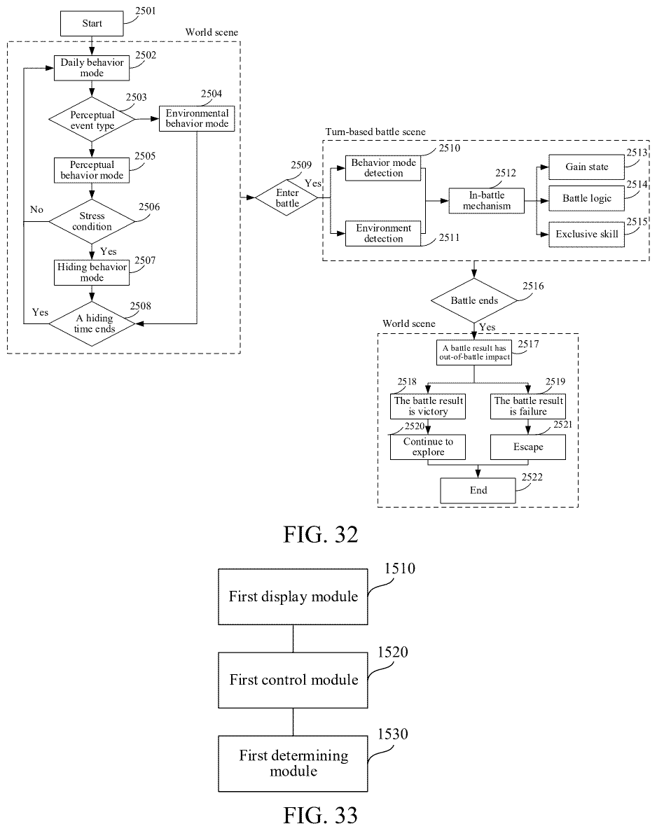

FIG. 32 is a flowchart of a virtual scene switching method according to an embodiment of this disclosure. The method may be executed by the terminal or the client on the terminal in the system shown in FIG. 4. The method includes:
Operation 2501: Start.
Operation 2502: A battle character is in a daily behavior mode.

When the battle character perceives no perception event in the world scene, the battle character is in the daily behavior mode, such as walking, patrolling, foraging, sleeping, and drinking water.
Operation 2503: Trigger a perception event and determine a perception event type.

After the perception event is triggered, the battle character executes a behavior mode corresponding to the perception event.

In some embodiments, the perception event type includes a perception event triggered by an environment element. The perception event triggered by the environment element is a perception event triggered by a factor other than the main control virtual character and the first battle character.

In some embodiments, the perception event type includes a perception event triggered after the battle character perceives an enemy virtual character in the world scene. In this case, the battle character enters a perceptual behavior mode.
Operation 2504: Enter an environmental behavior mode when the perception event is triggered by an environment element.

The environmental behavior mode includes at least one of a hiding behavior mode, a disguise behavior mode, a sleep behavior mode, an escape behavior mode, a fierce battle mode, an alert behavior mode, and the like.

For example, the environmental behavior mode is a hiding behavior mode. After entering the hiding behavior mode, the battle character performs an activity according to a behavior mode of hiding the battle character.
Operation 2505: Enter a perceptual behavior mode when the perception event is triggered by an enemy virtual character.

The perceptual behavior mode is a behavior mode executed after the battle character perceives, in the world scene, a perception event triggered by an enemy virtual character. The perceptual behavior mode includes at least one of a hiding behavior mode, a disguise behavior mode, a sleep behavior mode, an escape behavior mode, a fierce battle mode, an alert behavior mode, and the like.

In this embodiment, it is assumed that the perceptual behavior mode in operation 2505 is the alert behavior mode.
Operation 2506: Determine whether the battle character meets a stress condition.

When the stress condition is satisfied, the alert behavior mode is switched to the hiding behavior mode.
Operation 2507: Enter the hiding behavior mode.

When the stress condition is satisfied, the battle character performs a stress response, and when the stress response is a hidden response, the battle character enters the hiding behavior mode.

In a possible implementation, the perceptual behavior mode is a perceptual behavior mode triggered by a stress response, and the stress response is a behavior response after a battle character perceives an enemy virtual character. The stress response includes at least one of hiding, alert, escape, surprise, confusion, anger, and the like.
Operation 2508: Determine whether a hidden event ends.

After the battle character enters the hiding behavior mode for a preset duration, or the battle character perceives that the danger disappears (in this case, the battle character changes from perceiving an enemy virtual character to perceiving no enemy virtual character), the battle character enters the daily behavior mode. If the battle character enters the hiding behavior mode for less than the preset duration, or the battle character does not perceive that the danger disappears, the battle character maintains the stress response and continues to hide.
Operation 2509: Determine whether the battle character enters a turn-based battle scene.

When a determining result is yes, operation 2510 is performed; or when the determining result is no, at least one of operations 2502 to 2508 is performed.
Operation S2510: Perform behavior mode detection.

In switching to the turn-based battle scene, behavior mode detection is performed on the battle character, and the battle character remains in a behavior mode in a world scene.
Operation S2511: Perform environment detection.

In the turn-based battle scene, the detecting an environment element includes detecting at least one environment element of a time period, a weather type, and a terrain attribute.
Operation S2512: Determine an in-battle mechanism of the battle character in the turn-based battle scene.

The turn-based battle scene has at least one of three in-battle mechanisms: a gain state, battle logic, and an exclusive skill.

A battle capability of the battle character during the battle in the turn-based battle scene is determined based on the behavior mode and the environment element. According to different embodiments, at least one of the following operation S2513 to operation S2515 may be performed.
Operation S2513: Add a gain state corresponding to the behavior mode to the battle character.

The gain state includes a positive gain state and a negative gain state. The positive gain state refers to an advantageous effect exerted on the battle character, and may improve the battle capability of the battle character. The negative gain state refers to an adverse effect exerted on the battle character, and may weaken the battle capability of the battle character.
Operation 2514: Change battle logic of the battle character to battle logic corresponding to the behavior mode.

The battle logic is control logic that controls a battle character to take action in a battle of a game. The battle logic is logic used by AI to control a battle character during a battle. A battle character has different battle logic, for example, an offensive type, a defensive type, an escape type, and a sneak attack type. The battle character may adjust battle logic of the battle character according to a current status and an influencing factor. In some embodiments, the second battle character is completely controlled by the AI control logic. Therefore, the AI control logic may change the battle logic of the second battle character according to the behavior mode of the second battle character.
Operation 2515: Control the battle character to use, during the battle, an exclusive skill corresponding to the behavior mode.

The exclusive skill is a set of skills corresponding to a current behavior mode of the battle character. Alternatively, the exclusive skill is a skill allowed only in a current behavior mode. The exclusive skill can better utilize a feature and an advantage of the battle character. In an embodiment, different behavior modes of the battle character may correspond to different exclusive skills.
Operation S2516: Determine whether the turn-based battle scene ends.

When a determining result is yes, operation 2517 is performed; or when the determining result is no, at least one of operations 2510 to 2515 is performed.
Operation S2517: An in-battle battle result impacts an out-of-battle result.

A battle result of the battle character in the turn-based battle scene impacts a behavior of the battle character in the world scene. The battle result includes a case in which the battle character wins victory in the turn-based battle scene and a case in which the battle character fails in the turn-based battle scene.
Operation S2518: The battle result is victory.
Operation S2519: The battle result is failure.
Operation S2520: When the battle result is victory, the battle character continues to explore.

In a possible implementation, when the battle result is victory, the battle character may keep exploring in the world scene.
Operation 2521: When the battle result is failure, the battle character escapes.

In a possible implementation, when the battle result is failure, the battle character may select to escape in the world scene.
Operation 2522: End.

In conclusion, in the method of this embodiment, the battle element of the battle character in the turn-based battle scene is determined based on the influencing factor in the world scene. Therefore, a difference between the world scene and the turn-based battle scene can be downplayed, interplay between the world scene and the turn-based battle scene can be increased, and consistency between the world scene and the turn-based battle scene can be improved, so that a player feels less abrupt or no longer feels abrupt in a scene switching process.

FIG. 33 is a schematic structural diagram of a virtual scene switching apparatus according to an embodiment of this disclosure. The apparatus can be implemented as all or part of a computer device through software, hardware, or a combination of both. The apparatus includes:
a first display module 1510, configured to display that a main control virtual character is located in a world scene, the main control virtual character having at least one first battle character;
a first control module 1520, configured to control the main control virtual character to move to a first region in the world scene, the first region including a second battle character;
the first display module 1510 being further configured to display, in response to that a scene switching condition is satisfied, that a battle character is in a turn-based battle scene, the battle character including at least one of the first battle character and the second battle character; and
a first determining module 1530, configured to determine a battle element of the battle character in the turn-based battle scene based on an influencing factor in the world scene.

In some embodiments, the first determining module 1530 further includes a first determining submodule.

In one embodiment, the first display module 1510 is configured to display that the main control virtual character is located in the world scene, the main control virtual character having at least one first battle character;
the first control module 1520 is configured to control the main control virtual character to move to the first region in the world scene, the first region including the second battle character;
the first display module 1510 is further configured to display, in response to that the scene switching condition is satisfied, that the battle character is in the turn-based battle scene, the battle character including at least one of the first battle character and the second battle character; and
the first determining submodule is configured to determine a battle capability of the battle character during a battle in the turn-based battle scene based on a behavior mode of the battle character in the world scene.

In one embodiment, the behavior mode includes at least one of the following: a daily behavior mode; an environmental behavior mode; a perceptual behavior mode; a group behavior mode; and a sneak attack behavior mode. In some examples, the daily behavior mode is a behavior mode executed when the battle character perceives no perception event in the world scene; the environmental behavior mode is a behavior mode executed when the battle character perceives, in the world scene, a perception event triggered by an environment element; the perceptual behavior mode is a behavior mode executed after the battle character perceives, in the world scene, a perception event triggered by an enemy virtual character; the group behavior mode is a behavior mode in which the plurality of battle characters execute behaviors according to a team strategy or a tribe strategy; and the sneak attack behavior mode is a behavior mode for ambush.

In some embodiments, the first determining submodule includes a first determining unit.

In one embodiment, the first determining unit is configured to determine, in a case that the environmental behavior mode is a first type environmental behavior mode triggered by a time period, the battle capability of the battle character during the battle in the turn-based battle scene according to the first environmental behavior mode; the first determining unit is configured to determine, in a case that the environmental behavior mode is a second type environmental behavior mode triggered by a weather type, the battle capability of the battle character during the battle in the turn-based battle scene according to the second environmental behavior mode; and the first determining unit is configured to determine, in a case that the environmental behavior mode is a third type environmental behavior mode triggered by a terrain attribute, the battle capability of the battle character during the battle in the turn-based battle scene according to the third type environmental behavior mode.

In some embodiments, the first determining unit is further configured to: determine, in a case that the first type environmental behavior mode is a hiding behavior mode triggered by a first time period and a battle time belongs to the first time period, the battle capability of the battle character during the battle in the turn-based battle scene according to the hiding behavior mode; and determine, in a case that the first type environmental behavior mode is the hiding behavior mode triggered by the first time period and the battle time does not belong to the first time period, the battle capability of the battle character during the battle in the turn-based battle scene according to the daily behavior mode or an applicable type environmental behavior mode corresponding to the battle time; where the battle time changes along with a system time in the world scene.

In some embodiments, the first determining unit is further configured to: determine, in a case that the second type environmental behavior mode is a hiding behavior mode triggered by a first weather type and a current weather type belongs to the first weather type, the battle capability of the battle character during the battle in the turn-based battle scene according to the hiding behavior mode; and determine, in a case that the second type environmental behavior mode is the hiding behavior mode triggered by the first weather type and the current weather type does not belong to the first weather type, the battle capability of the battle character during the battle in the turn-based battle scene according to the daily behavior mode or an applicable type environmental behavior mode corresponding to the current weather type; where the current weather type changes along with a system time in the world scene, or the current weather type is triggered by a skill of the battle character to change.

In some embodiments, the first determining unit is further configured to: determine, in a case that the third type environmental behavior mode is a hiding behavior mode triggered by a first terrain attribute and a location of the battle character belongs to the first terrain attribute, the battle capability of the battle character during the battle in the turn-based battle scene according to the hiding behavior mode; and determine, in a case that the third type environmental behavior mode is the hiding behavior mode triggered by the first terrain attribute and the location of the battle character does not belong to the first terrain attribute, the battle capability of the battle character during the battle in the turn-based battle scene according to the daily behavior mode or an applicable type environmental behavior mode corresponding to a terrain attribute of the location of the battle character; where the location of the battle character dynamically changes during the battle in the turn-based battle scene.

In some embodiments, the first determining submodule further includes a first determining unit.

In one embodiment, the first determining unit is configured to determine, in a case that the perceptual behavior mode is a first type perceptual behavior mode triggered by a restraining relationship between battle characters of different attributes, the battle capability of the battle character during the battle in the turn-based battle scene according to the first type perceptual behavior mode; and the first determining unit is configured to determine, in a case that the perceptual behavior mode is a second type perceptual behavior mode triggered by a stress response, the battle capability of the battle character during the battle in the turn-based battle scene according to the second type perceptual behavior mode; where the stress response is a behavior response of the battle character after the battle character perceives an enemy virtual character.

In some embodiments, the first determining unit is further configured to: determine, in a case that the first type perceptual behavior mode is a hiding behavior mode triggered by the restraining relationship between the battle characters of the different attributes, the battle capability of the battle character during the battle in the turn-based battle scene according to the hiding behavior mode; and determine, in a case that the enemy battle character is switched, the battle capability of the battle character during the battle in the turn-based battle scene according to the daily behavior mode or a perceptual behavior mode corresponding to the enemy battle character.

In some embodiments, the first determining unit is further configured to: determine, in a case that the second type perceptual behavior mode is a hiding behavior mode triggered by the stress response, the battle capability of the battle character during the battle in the turn-based battle scene according to the hiding behavior mode; and determine, in a case that a duration of the stress response reaches a first duration for switching, the battle capability of the battle character during the battle in the turn-based battle scene according to the daily behavior mode.

In some embodiments, the first determining unit is further configured to: add, to the battle character, a positive gain state or a negative gain state corresponding to the behavior mode; change battle logic of the battle character to battle logic corresponding to the behavior mode; and control the battle character to use, during the battle, an exclusive skill corresponding to the behavior mode.

In one embodiment, the environmental behavior mode and/or the perceptual behavior mode includes various types of behavior modes, including at least one of the following behavior modes: a hiding behavior mode; a disguise behavior mode; a sleep behavior mode; an escape behavior mode; a fierce battle mode; and an alert behavior mode.

In one example, the first control module 1520 is configured to control the battle character to switch between at least two behavior modes.

In some embodiments, the first control module 1520 further includes a first control submodule.

In one example, the first control submodule is configured to switch from the daily behavior mode to the environmental behavior mode in a case that the battle character perceives, in the world scene, the perception event triggered by the environment element; the first control submodule is configured to switch from the environmental behavior mode to the daily behavior mode in a case that the environment element disappears or a duration after the disappearing reaches a first duration; the first control submodule is configured to switch from the environmental behavior mode to the daily behavior mode in a case that a duration of the environmental behavior mode reaches a second duration; the first control submodule is configured to switch from the daily behavior mode to the perceptual behavior mode in a case that the battle character perceives the enemy virtual character in the world scene; the first control submodule is configured to switch from the perceptual behavior mode to the daily behavior mode in a case that the perception event disappears or a duration after the disappearing reaches a third duration; the first control submodule is configured to switch from the perceptual behavior mode to the daily behavior mode in a case that a duration of the perceptual behavior mode reaches a fourth duration; the first control submodule is configured to switch from the daily behavior mode to the group behavior mode in a case that the battle character is in a team or a tribe; the first control submodule is configured to switch from the group behavior mode to the daily behavior mode in a case that the battle character leaves the team or the tribe; the first control submodule is configured to switch from the daily behavior mode to the sneak attack behavior mode in a case that the battle character receives a lurking command or a lurking triggering event; the first control submodule is configured to switch from the sneak attack behavior mode to the daily behavior mode in a case that a duration of the sneak attack behavior mode reaches a fifth duration; and the first control submodule is configured to switch from the sneak attack behavior mode to the daily behavior mode in a case that the battle character is discovered during lurking and sneak attack.

In one example, the first control submodule is further configured to: control, in a case that a perception event occurs within a perception range with the battle character as the center, the battle character to perceive the perception event according to a perception probability; where the perception range includes at least one of an auditory perception range and a visual perception range, and the perception probability is related to an angle and/or a distance of the perception event relative to the battle character.

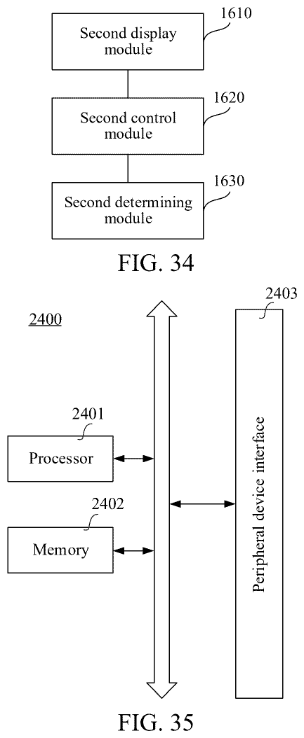

FIG. 34 is a schematic structural diagram of a virtual scene switching apparatus according to an embodiment of this disclosure. The apparatus can be implemented as all or part of a computer device through software, hardware, or a combination of both. The apparatus includes: a second display module 1610, configured to display that a battle character is in a turn-based battle scene, the battle character including a first battle character and a second battle character, and the first battle character being a battle character owned by a main control virtual character; a second control module 1620, configured to control the first battle character and the second battle character to battle in the turn-based battle scene; the second display module 1610 being further configured to display, in response to that the battle in the turn-based battle scene ends, that the battle character is in a world scene; and a second determining module 1630, configured to determine at least one world element of the battle characters in the world scene based on an influencing factor in the turn-based battle scene.

In some embodiments, the second determining module 1630 further includes a second determining submodule.

In one embodiment, the second display module 1610 is configured to display that battle characters are in the turn-based battle scene, the battle characters including the first battle character and the second battle character, and the first battle character being the battle character owned by the main control virtual character; the second control module 1620 is configured to control the first battle character and the second battle character to battle in the turn-based battle scene; the second display module 1610 being further configured to display, in response to that the battle in the turn-based battle scene ends, that the battle character is in the world scene; and the second determining submodule is configured to determine a behavior of the battle character in the world scene based on a battle result in the turn-based battle scene.

In some embodiments, the second control module 1620 includes a second control submodule.

In one embodiment, the second control submodule is configured to control the behavior of the battle character in the world scene based on a victory behavior mode in a case that the battle result of the battle character in the turn-based battle scene is victory; or the second control submodule is configured to control the behavior of the battle character in the world scene based on a failure behavior mode in a case that the battle result of the battle character in the turn-based battle scene is failure.

In one embodiment, the second control submodule is further configured to: control, in a case that the battle result of the battle character in the turn-based battle scene is victory and the battle character is in a hidden state in the turn-based battle scene, the battle character to remain in the hidden state in the world scene; control, in a case that the battle result of the battle character in the turn-based battle scene is victory and a hidden state of the battle character is discovered in the turn-based battle scene, the battle character to re-enter the hidden state in the world scene; control, in a case that the battle result of the battle character in the turn-based battle scene is victory and the battle character is woken up from a sleep state in the turn-based battle scene, the battle character to re-enter the sleep state in the world scene; and control, in a case that the battle result of the battle character in the turn-based battle scene is victory and the battle character is in an exploration state before the turn-based battle scene is entered, the battle character to re-enter the exploration state in the world scene.

In one embodiment, the second control submodule is further configured to: control, in a case that the battle result of the battle character in the turn-based battle scene is failure and the battle character is in an escape state in the turn-based battle scene, the battle character to remain in the escape state in the world scene.

FIG. 35 is a structural block diagram of a computer device 2400 according to an embodiment of this disclosure. The computer device 2400 may be a portable mobile terminal, for example, a smart phone, a tablet computer, a Moving Picture Experts Group Audio Layer III (MP3) player, or a Moving Picture Experts Group Audio Layer IV (MP4) player. The computer device 2400 may also be called a user device, a portable terminal, or other names.

In some examples, the computer device 2400 includes processing circuitry (for example, a processor 2401) and a memory 2402.

The processor 2401 may include one or more processing cores, for example, a 4-core processor or an 8-core processor. The processor 2401 may be implemented in at least one hardware form of a digital signal processor (DSP), a field-programmable gate array (FPGA), and a programmable logic array (PLA). The processor 2401 may also include a main processor and a coprocessor. The main processor is a processor configured to process data in an awake state, and is also referred to as a central processing unit (CPU). The coprocessor is a processor with low power consumption configured to process data in a standby state. In some embodiments, the processor 2401 may be integrated with a graphics processing unit (GPU). The GPU is configured to render and draw content that may be displayed on a display screen. In some embodiments, the processor 2401 may further include an artificial intelligence (AI) processor. The AI processor is configured to process computing operations related to machine learning.

The memory 2402 may include one or more non-transitory computer-readable storage mediums. The non-transitory computer-readable storage medium may be visible and non-transient. The memory 2402 may further include a high-speed random access memory and a nonvolatile memory, for example, one or more magnetic disk storage devices or flash storage devices. In some embodiments, the non-transient computer-readable storage medium in the memory 2402 is configured to store at least one instruction, and the at least one instruction being configured to be executed by the processor 2401 to implement the virtual scene switching method provided in the embodiments of this disclosure.

In some embodiments, the computer device 2400 may include a peripheral device interface 2403 and at least one peripheral device. Specifically, the peripheral device includes at least one of a radio frequency circuit, a touch display screen, a camera, an audio circuit, and a power supply. A person skilled in the art may understand that the structure shown in FIG. 35 constitutes no limitation on the computer device 2400, and the computer device may include more or fewer components than those shown in the figure, or some components may be combined, or a different component deployment may be used.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

An embodiment of this disclosure further provides a computer device, including processing circuitry (for example, a processor) and a memory (for example, a non-transitory computer-readable storage medium), the memory having at least one computer program stored therein, and the at least one computer program being loaded and executed by the processor to implement the virtual scene switching method according to the foregoing method embodiments.

An embodiment of this disclosure further provides a non-transitory computer-readable storage medium, having at least one computer program stored therein, the at least one computer program being loaded and executed by a processor to implement the virtual scene switching method according to the foregoing method embodiments.

An embodiment of this disclosure further provides a computer program product, including a computer program, the computer program being stored in a computer-readable storage medium, and a processor of a computer device reading the computer program from the computer-readable storage medium and executing the computer program, to cause the computer device to perform the virtual scene switching method according to the foregoing method embodiments.

The foregoing descriptions are merely non-limiting examples of implementations. Any modification, equivalent replacement, improvement, and the like made within the spirit and scope of this disclosure shall fall within the scope of this disclosure.

What is claimed is:

1. A virtual scene switching method, comprising:
displaying a main control virtual character in a world scene, the main control virtual character having a first battle character subordinate to the main control virtual character;
controlling the main control virtual character to move to a first region in the world scene, a second battle character being in the first region;
displaying, based on a scene switching condition being satisfied, one or more battle characters in a turn-based battle scene, the one or more battle characters including at least one of the first battle character or the second battle character;
determining, by processing circuitry, a battle attribute of one of the one or more battle characters in the turn-based battle scene based on (i) a behavior mode of the one of the one or more battle characters in the world scene or (ii) an influencing factor in the world scene; and
controlling, by the processing circuitry, the one of the one or more battle characters to engage in the turn-based battle scene based on the battle attribute of the one of the one or more battle characters.

2. The method according to claim 1, wherein
the battle attribute of the one of the one or more battle characters is determined based on the behavior mode of the one of the one or more battle characters;
the behavior mode of the one of the one or more battle characters is a daily behavior mode when the one of the one or more battle characters perceives no perception event in the world scene,
the behavior mode of the one of the one or more battle characters is an environmental behavior mode when the one of the one or more battle characters perceives, in the world scene, a first perception event triggered by an environment element,
the behavior mode of the one of the one or more battle characters is a perceptual behavior mode after the one of the one or more battle characters perceives, in the world scene, a second perception event triggered by an enemy virtual character,
the behavior mode of the one of the one or more battle characters is a group behavior mode according to a strategy of a group of battle characters to which the one of the one or more battle characters belongs, and
the behavior mode of the one of the one or more battle characters is a sneak attack behavior mode when the one of the one or more battle characters executes an ambush.

3. The method according to claim 2, wherein
the battle attribute of one of the one or more battle characters corresponds to a battle capability of the one of the one or more battle characters, and
the determining the battle attribute of the one of the one or more battle characters comprises at least one of:
determining, based on the environmental behavior mode being a first type environmental behavior mode triggered by a time period, the battle capability of the one of the one or more battle characters during the battle in the turn-based battle scene according to the first type environmental behavior mode;
determining, based on the environmental behavior mode being a second type environmental behavior mode triggered by a weather type, the battle capability of the one of the one or more battle characters during the battle in the turn-based battle scene according to the second type environmental behavior mode; or
determining, based on the environmental behavior mode being a third type environmental behavior mode triggered by a terrain attribute, the battle capability of the one of the one or more battle characters during the battle in the turn-based battle scene according to the third type environmental behavior mode.

4. The method according to claim 3, wherein
the determining the battle capability of the one of the one or more battle characters according to the first type environmental behavior mode comprises:
determining, based on the first type environmental behavior mode being a hiding behavior mode triggered by a first time period and a battle time belonging to the first time period, the battle capability of the one of the one or more battle characters during the battle in the turn-based battle scene according to the hiding behavior mode, and
the method further comprises:
determining, based on the first type environmental behavior mode being the hiding behavior mode triggered by the first time period and the battle time not belonging to the first time period, the battle capability of the one of the one or more battle characters during the battle in the turn-based battle scene according to the daily behavior mode or an applicable type environmental behavior mode corresponding to the battle time.

5. The method according to claim 3, wherein
the determining the battle capability of the one of the one or more battle characters according to the second type environmental behavior mode comprises:
determining, based on the second type environmental behavior mode being a hiding behavior mode triggered by a first weather type and a current weather type belonging to the first weather type, the battle capability of the one of the one or more battle characters during the battle in the turn-based battle scene according to the hiding behavior mode, and
the method further comprises:
determining, based on the second type environmental behavior mode being the hiding behavior mode triggered by the first weather type and the current weather type not belonging to the first weather type, the battle capability of the one of the one or more battle characters during the battle in the turn-based battle scene according to the daily behavior mode or an applicable type environmental behavior mode corresponding to the current weather type.

6. The method according to claim 3, wherein
the determining the battle capability of the one of the one or more battle characters according to the third type environmental behavior mode comprises:
determining, based on the third type environmental behavior mode being a hiding behavior mode triggered by a first terrain attribute and a location of the one of the one or more battle characters belonging to the first terrain attribute, the battle capability of the one of the one or more battle characters during the battle in the turn-based battle scene according to the hiding behavior mode,
the method further comprises:
determining, based on the third type environmental behavior mode being the hiding behavior mode triggered by the first terrain attribute and the location of the one of the one or more battle characters not belonging to the first terrain attribute, the battle capability of the one of the one or more battle characters during the battle in the turn-based battle scene according to the daily behavior mode or an applicable type environmental behavior mode corresponding to a terrain attribute of the location of the one of the one or more battle characters, and
the location of the one of the one or more battle characters dynamically changes during the battle in the turn-based battle scene.

7. The method according to claim 2, wherein
the battle attribute of one of the one or more battle characters corresponds to a battle capability of the one of the one or more battle characters,
the determining the battle attribute of the one of the one or more battle characters comprises at least one of:
determining, based on the perceptual behavior mode being a first type perceptual behavior mode triggered by a restraining relationship between battle characters of different attributes, the battle capability of the one of the one or more battle characters during the battle in the turn-based battle scene according to the first type perceptual behavior mode; or
determining, based on the perceptual behavior mode being a second type perceptual behavior mode triggered by a stress response, the battle capability of the one of the one or more battle characters during the battle in the turn-based battle scene according to the second type perceptual behavior mode, and
the stress response corresponds to a behavior response of the one of the one or more battle characters after the one of the one or more battle characters perceives an enemy battle character.

8. The method according to claim 7, wherein
the determining the battle capability of the one of the one or more battle characters according to the first type perceptual behavior mode comprises:
determining, based on the first type perceptual behavior mode being a hiding behavior mode triggered by the restraining relationship between the battle characters of the different attributes, the battle capability of the one of the one or more battle characters during the battle in the turn-based battle scene according to the hiding behavior mode, and
the method further comprises:
determining, based on the enemy battle character being switched, the battle capability of the one of the one or more battle characters during the battle in the turn-based battle scene according to the daily behavior mode or applicable type perceptual behavior mode corresponding to the enemy battle character.

9. The method according to claim 7, wherein
the determining the battle capability of the one of the one or more battle characters according to the second type perceptual behavior mode comprises:
determining, based on the second type perceptual behavior mode being a hiding behavior mode triggered by the stress response, the battle capability of the one of the one or more battle characters during the battle in the turn-based battle scene according to the hiding behavior mode, and
the method further comprises:
determining, based on a duration of the stress response reaching a first switching duration, the battle capability of the one of the one or more battle characters during the battle in the turn-based battle scene according to the daily behavior mode.

10. The method according to claim 3, wherein the determining the battle attribute of the one of the one or more battle characters comprises at least one of:
adding, to the one of the one or more battle characters, a positive gain state or a negative gain state corresponding to the behavior mode;
setting the one of the one or more battle characters based on a battle logic corresponding to the behavior mode; or
controlling the one of the one or more battle characters to apply, during the battle, an exclusive skill corresponding to the behavior mode.

11. The method according to claim 2, wherein the environmental behavior mode or the perceptual behavior mode comprises:
a hiding behavior mode;
a disguise behavior mode;
a sleep behavior mode;
an escape behavior mode;
a fierce battle mode; or
an alert behavior mode.

12. The method according to claim 2, further comprising at least one of:
controlling the one of the one or more battle characters to switch from being in the daily behavior mode to the environmental behavior mode based on the one of the one or more battle characters perceiving, in the world scene, the perception event triggered by the environment element;
controlling the one of the one or more battle characters to switch from being in the environmental behavior mode to the daily behavior mode based on the environment element disappearing or a duration after the disappearing reaching a first duration;
controlling the one of the one or more battle characters to switch from being in the environmental behavior mode to the daily behavior mode based on a duration of the environmental behavior mode reaching a second duration;
controlling the one of the one or more battle characters to switch from being in the daily behavior mode to the perceptual behavior mode based on the one of the one or more battle characters perceiving the enemy virtual character in the world scene;
controlling the one of the one or more battle characters to switch from being in the perceptual behavior mode to the daily behavior mode based on the perception event disappearing or a duration after the disappearing reaching a third duration;
controlling the one of the one or more battle characters to switch from being in the perceptual behavior mode to the daily behavior mode based on a duration of the perceptual behavior mode reaching a fourth duration;
controlling the one of the one or more battle characters to switch from being in the daily behavior mode to the group behavior mode based on the one of the one or more battle characters being in a group;
controlling the one of the one or more battle characters to switch from being in the group behavior mode to the daily behavior mode based on the one of the one or more battle characters leaving the group;
controlling the one of the one or more battle characters to switch from being in the daily behavior mode to the sneak attack behavior mode based on the one of the one or more battle characters receiving a lurking command or a lurking triggering event;
controlling the one of the one or more battle characters to switch from being in the sneak attack behavior mode to the daily behavior mode based on a duration of the sneak attack behavior mode reaching a fifth duration; or
controlling the one of the one or more battle characters to switch from being in the sneak attack behavior mode to the daily behavior mode based on the one of the one or more battle characters being discovered during execution of the ambush.

13. The method according to claim 12, further comprising:
controlling, based on a perception event occurring within a perception range with the one of the one or more battle characters as a center, the one of the one or more battle characters to perceive the perception event according to a perception probability,
wherein
the perception range includes at least one of an auditory perception range or a visual perception range, and
the perception probability is related to an angle or a distance of the perception event relative to the one of the one or more battle characters.

14. A virtual scene switching method, comprising:
displaying battle characters in a turn-based battle scene, the battle characters including a first battle character and a second battle character, and the first battle character being subordinate to a main control virtual character;
controlling the first battle character and the second battle character to battle in the turn-based battle scene;
displaying, by processing circuitry based on an end of the battle in the turn-based battle scene, at least one of the battle characters in a world scene; and
determining, by the processing circuitry, a world attribute of the one of the battle characters in the world scene based on an influencing factor in the turn-based battle scene,
wherein the one of the battle characters is displayed in the world scene based on the determined world attribute.

15. The method according to claim 14, wherein
the world attribute of the one of the battle characters corresponds to a behavior of the one of the battle characters, and
the determining the world attribute of the one of the battle characters in the world scene includes:
controlling the behavior of the one of the battle characters in the world scene based on a victory behavior mode when the influencing factor indicates that a battle result of the one of the battle characters is victory; and
controlling the behavior of the one of the battle characters in the world scene based on a failure behavior mode when the influencing factor indicates that the battle result of the one of the battle characters is failure.

16. The method according to claim 15, wherein the controlling the behavior of the one of the battle characters in the world scene based on the victory behavior mode comprises at least one of:
controlling, based on the one of the battle characters being in a hidden state in the turn-based battle scene, the one of the battle characters to remain in the hidden state in the world scene;
controlling, based on the one of the battle characters being in a hidden state of the one of the battle characters and being discovered in the turn-based battle scene, the one of the battle characters to re-enter the hidden state in the world scene;
controlling, based on the one of the battle characters being woken up from a sleep state in the turn-based battle scene, the one of the battle characters to re-enter the sleep state in the world scene; or
controlling, based on the one of the battle characters being in an exploration state before entering the turn-based battle scene, the one of the battle characters to re-enter the exploration state in the world scene.

17. The method according to claim 15, wherein the controlling the behavior of the one of the battle characters in the world scene based on the failure behavior mode comprises:
controlling, based on the one of the battle characters being in an escape state in the turn-based battle scene, the one of the battle characters to remain in the escape state in the world scene.

18. A terminal device, comprising:
processing circuitry configured to:
display a main control virtual character in a world scene, the main control virtual character having a first battle character subordinate to the main control virtual character;
control the main control virtual character to move to a first region in the world scene, a second battle character being in the first region;
display, based on a scene switching condition being satisfied, one or more battle characters in a turn-based battle scene, the one or more battle characters including at least one of the first battle character or the second battle character;
determine a battle attribute of one of the one or more battle characters in the turn-based battle scene based on (i) a behavior mode of the one of the one or more battle characters in the world scene or (ii) an influencing factor in the world scene; and
control the one of the one or more battle characters to engage in the turn-based battle scene based on the battle attribute of the one of the one or more battle characters.

19. The terminal device according to claim 18, wherein
the battle attribute of one of the one or more battle characters corresponds to a battle capability of the one of the one or more battle characters, and
the processing circuitry, to determine the battle attribute of the one of the one or more battle characters, is configured to:
determine, based on the one of the one or more battle characters being in a first type environmental behavior mode triggered by a time period, the battle capability of the one of the one or more battle characters during the battle in the turn-based battle scene according to the first type environmental behavior mode;
determine, based on the one of the one or more battle characters being in a second type environmental behavior mode triggered by a weather type, the battle capability of the one of the one or more battle characters during the battle in the turn-based battle scene according to the second type environmental behavior mode; or
determine, based on the one of the one or more battle characters being in a third type environmental behavior mode triggered by a terrain attribute, the battle capability of the one of the one or more battle characters during the battle in the turn-based battle scene according to the third type environmental behavior mode.

20. The terminal device according to claim 19, wherein
the battle attribute of one of the one or more battle characters corresponds to a battle capability of the one of the one or more battle characters,
the processing circuitry, to determine the battle attribute of the one of the one or more battle characters, is configured to:
determine, based on the one of the one or more battle characters being in a first type perceptual behavior mode triggered by a restraining relationship between battle characters of different attributes, the battle capability of the one of the one or more battle characters during the battle in the turn-based battle scene according to the first type perceptual behavior mode; and
determine, based on the one of the one or more battle characters being in a second type perceptual behavior mode triggered by a stress response, the battle capability of the one of the one or more battle characters during the battle in the turn-based battle scene according to the second type perceptual behavior mode, and
the stress response corresponds to a behavior response of the one of the one or more battle characters after the one of the one or more battle characters perceives an enemy battle character.
